(19) United States
(12) Patent Application Publication
(10) Pub. No.: US 2022/0225453 A1
(43) Pub. Date: Jul. 14, 2022

(54) METHOD AND APPARATUS FOR PERFORMING DUAL CONNECTIVITY IN WIRELESS COMMUNICATION SYSTEM

(71) Applicant: Samsung Electronics Co., Ltd., Suwon-si (KR)

(72) Inventors: Donggun KIM, Suwon-si (KR); Soenghun KIM, Suwon-si (KR)

(21) Appl. No.: 17/573,450

(22) Filed: Jan. 11, 2022

(30) Foreign Application Priority Data
Jan. 12, 2021 (KR) 10-2021-0004170

(51) Int. Cl. H04W 76/16; H04W 76/19; H04W 76/20; H04W 76/30; H04W 28/06

(52) U.S. Cl. CPC H04W 76/16; H04W 76/19; H04W 28/06; H04W 76/30; H04W 76/20

(57) ABSTRACT

Provided is a method performed by a user equipment (UE), the method including: receiving a radio resource control (RRC) message including configuration information of a secondary cell group (SCG) for the UE configured with a master cell group (MCG) and the SCG; identifying an indication for SCG deactivation from the configuration information of the SCG; and in case that the SCG is deactivated based on the identified indication, triggering a packet data convergence protocol (PDCP) entity associated with a signaling radio bearer 3 (SRB 3) to discard a service data unit (SDU).

### CROSS-REFERENCE TO RELATED APPLICATION

This application is based on and claims priority under 35 U.S.C. § 119 to Korean Patent Application No. 10-2021-0004170, filed on Jan. 12, 2021, in the Korean Intellectual Property Office, the disclosure of which is incorporated by reference herein in its entirety.

### BACKGROUND

### 1. Field

The disclosure relates to a technology of performing dual connectivity in a wireless communication system, and more particularly, to a method and apparatus for efficiently controlling a state of a secondary node when dual connectivity is performed.

### 2. Description of the Related Art

Considering the development of wireless communication from generation to generation, the technologies have been developed mainly for services targeting humans, such as voice calls, multimedia services, data services, and the like. Following the commercialization of 5^{th} generation (5G) communication systems, it is expected that connected devices being exponentially growing will be connected to communication networks. Examples of things connected to networks may include vehicles, robots, drones, home appliances, displays, smart sensors connected to various infrastructures, construction machines, factory equipment, and the like. Mobile devices are expected to evolve in various form-factors such as augmented reality glasses, virtual reality headsets, hologram devices, and the like. In order to provide various services by connecting hundreds of billions of devices and things in the 6^{th} generation (6G) era, there have been ongoing efforts to develop enhanced 6G communication systems. For these reasons, 6G communication systems are referred to as beyond-5G systems.

6G communication systems, which are expected to be commercialized around 2030, will have a peak data rate of tera (i.e., 1,000 giga)-level bps and radio latency less than 100 μsec. That is, the 6G communication systems will be 50 times as fast as 5G communication systems and have a 1/10 radio latency thereof.

In order to achieve such a high data rate and ultra-low latency, it has been considered to implement the 6G communication systems in a terahertz band (for example, 95 GHz to 3 THz bands). It is expected that, due to more severe path loss and atmospheric absorption in the terahertz bands than those in mmWave bands introduced in 5G, technologies capable of securing the signal transmission distance, that is, coverage, will become more important. It is necessary to develop, as major technologies for securing the coverage, radio frequency (RF) elements, antennas, novel waveforms having better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, in order to improve the coverage of terahertz-band signals, there has been ongoing discussion on new technologies such as metamaterial-based lenses and antennas, a high-dimensional spatial multiplexing technology using orbital angular momentum (OAM), reconfigurable intelligent surface (RIS), and the like.

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for using satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; use of artificial intelligence (AI) in wireless communication for improvement of overall network operation by using AI in a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in the 6G communication systems, developing mechanisms for implementing a hardware-based security environment and safe use of data, and developing technologies for maintaining privacy, attempts to strengthen the connectivity between devices, optimize the network, promote softwareization of network entities, and increase the openness of wireless communications are continuing.

It is expected that research and development of the 6G communication systems in hyper-connectivity, including person to machine (P2M) as well as machine to machine (M2M), will allow the next hyper-connected experience. In more detail, it is expected that services such as truly immersive extended reality (XR), high-fidelity mobile hologram, and digital replica could be provided through the 6G communication systems. In addition, services such as remote surgery for security and reliability enhancement, industrial automation, and emergency response will be provided through the 6G communication system, such that the technologies could be applied in various fields such as industry, medical care, automobiles, home appliances, and the like.

### SUMMARY

A next-generation wireless communication system may use carrier aggregation or dual connectivity so as to provide a user equipment (UE) with a service with a high data rate and low latency. In this regard, there is a demand for a method for preventing a processing delay that may occur when carrier aggregation or dual connectivity is configured and activated for a UE connected to a network or is deactivated after carrier aggregation or dual connectivity is used. In particular, if a plurality of cells maintain activated with respect to a UE so as to use carrier aggregation or dual connectivity, the UE has to perform Physical Dedicated Control Channel (PDCCH) monitoring on each of the cells, such that power consumption of the UE may be significantly increased. On the other hand, if the plurality of cells maintain deactivated to decrease power consumption of the UE, when carrier aggregation or dual connectivity is used, latency occurs when activating the plurality of cells, such that a delay may occur in data transmission and reception. A cell in the above description or in the disclosure may indicate a primary cell (Pcell) or a secondary cell (SCell) (e.g., an SCell configured in a master cell group (MCG)), a primary secondary cell (PSCell) (e.g., a PCell configured in a secondary cell group (SCG)), or an SCell (e.g., an SCell configured in an SCG).

Additional aspects will be set forth in part in the description which follows and, in part, will be apparent from the description, or may be learned by practice of the presented embodiments of the disclosure.

According to an embodiment of the disclosure, a method performed by a user equipment (UE) may include: receiving a radio resource control (RRC) message including configuration information of a secondary cell group (SCG) for the UE configured with a master cell group (MCG) and the SCG; identifying an indication for SCG deactivation from the configuration information of the SCG; and in case that the SCG is deactivated based on the identified indication, triggering a packet data convergence protocol (PDCP) entity associated with a signaling radio bearer 3 (SRB 3) to discard a service data unit (SDU).

The method may further include, in case that the SCG is deactivated based on the identified indication, re-establishing a radio link control (RLC) entity associated with the SRB 3.

In case that the SCG is deactivated based on the identified indication, configuration for the SCG may be maintained and transmission to the SCG may be suspended.

The method may further include: based on the identified indication for the SCG deactivation, setting a value of ul-data split threshold for a split bearer to an infinite value and a primary path to an RLC entity of the MCG.

According to an embodiment of the disclosure, a method performed by a master node (MN) may include: determining secondary cell group (SCG) deactivation of a user equipment (UE) configured with a master cell group (MCG) and the SCG; and based on the determination of the SCG deactivation, transmitting a radio resource control (RRC) message including configuration information of the SCG to the UE, wherein the configuration information of the SCG may include an indication for the SCG deactivation and in case that the SCG is deactivated based on the identified indication, a packet data convergence protocol (PDCP) entity associated with a signaling radio bearer 3 (SRB 3) of the UE may be triggered to discard a service data unit (SDU).

In case that the SCG is deactivated based on the identified indication, a radio link control (RLC) entity associated with the SRB 3 may be re-established.

Based on the identified indication for the SCG deactivation, a value of ul-data split threshold for a split bearer of the UE may be set to an infinite value and a primary path may be set to an RLC entity of the MCG.

According to an embodiment of the disclosure, a user equipment (UE) may include: a transceiver; and a processor coupled with the transceiver and configured to: receive a radio resource control (RRC) message including configuration information of a secondary cell group (SCG) for the UE configured with a master cell group (MCG) and the SCG, identify an indication for SCG deactivation from the configuration information of the SCG, and in case that the SCG is deactivated based on the identified indication, trigger a packet data convergence protocol (PDCP) entity associated with a signaling radio bearer 3 (SRB 3) to discard a service data unit (SDU).

According to an embodiment of the disclosure, a master node (MN) may include: a transceiver; and a processor coupled with the transceiver and configured to: determine secondary cell group (SCG) deactivation of a user equipment (UE) configured with a master cell group (MCG) and the SCG, and based on the determination of the SCG deactivation, transmit a radio resource control (RRC) message including configuration information of the SCG, to the UE, wherein the configuration information of the SCG may include an indication for the SCG deactivation and in case that the SCG is deactivated based on the identified indication, a packet data convergence protocol (PDCP) entity related with a signaling radio bearer 3 (SRB 3) of the UE may be triggered to discard a service data unit (SDU).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a diagram of an architecture of a long term evolution (LTE) system to which the disclosure is applicable;

FIG. 1B illustrates a diagram of a radio protocol architecture of an LTE system to which the disclosure is applicable;

FIG. 1C illustrates a diagram of an architecture of a next-generation wireless communication system to which the disclosure is applicable;

FIG. 1D illustrates a diagram of a radio protocol architecture of a next-generation wireless communication system to which the disclosure is applicable;

FIG. 1E illustrates a diagram of a procedure of providing a service to a user equipment (UE) by efficiently using a very wide frequency bandwidth in a next-generation mobile communication system, according to an embodiment of the disclosure;

FIG. 1F illustrates a procedure by which a UE transitions from a radio resource control (RRC) idle mode to an RRC connected mode in a next-generation wireless communication system of the disclosure, in which a method of configuring a plurality of bandwidth parts (BWPs) and configuring a default BWP or a first active BWP or a dormant BWP will now be proposed, according to an embodiment of the disclosure;

FIG. 1G illustrates a diagram of Embodiment 1 in which an embodiment of the disclosure is extended and applied to an RRC inactive mode UE;

FIG. 1H illustrates a diagram of media access control (MAC) control information indicating state transition to an active state (or resumed state) or a dormant state (or suspended state) or an inactive state for a cell or a cell of a cell group or a cell group, according to an embodiment of the disclosure;

FIG. 1I illustrates a flowchart of a signaling procedure of configuring or releasing dual connectivity, or activating or resuming or suspending or deactivating a secondary cell group (SCG) configured with dual connectivity, in a next-generation mobile communication system, according to an embodiment of the disclosure;

FIG. 1J illustrates a flowchart of a second signaling procedure of configuring or releasing dual connectivity, or configuring or releasing or activating or resuming or suspending or deactivating an SCG configured with dual connectivity, according to an embodiment of the disclosure;

FIG. 1K illustrates a flowchart of a third signaling procedure of configuring or releasing dual connectivity, or configuring or releasing or activating or resuming or suspending or deactivating an SCG configured with dual connectivity, according to an embodiment of the disclosure;

FIG. 1L illustrates a diagram of an operation of a UE according to an embodiment of the disclosure;

FIG. 1M illustrates a block diagram of a configuration of a UE to which an embodiment of the disclosure is applicable; and

FIG. 1N illustrates a block diagram of a base station (BS) in a wireless communication system to which an embodiment of the disclosure is applicable.

### DETAILED DESCRIPTION

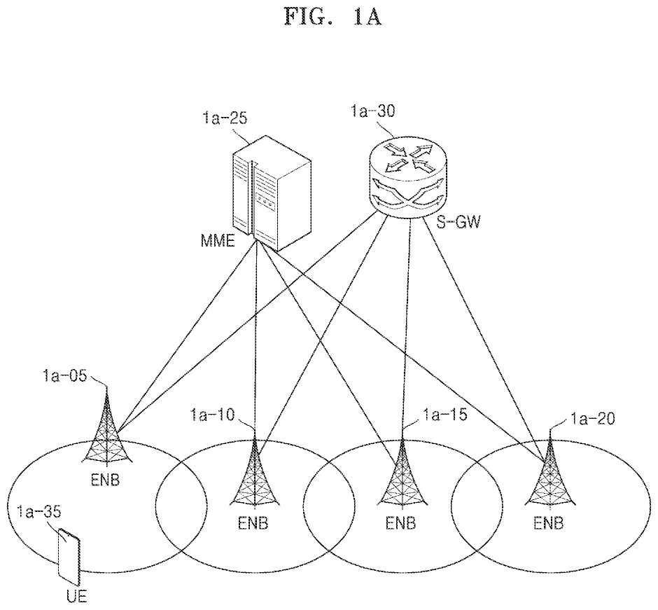

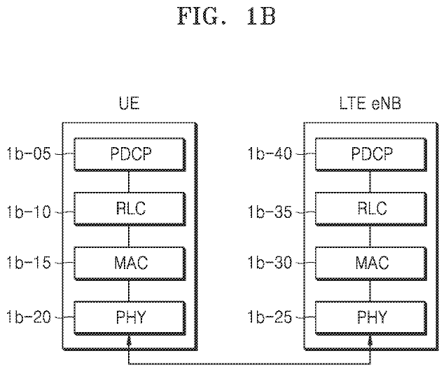

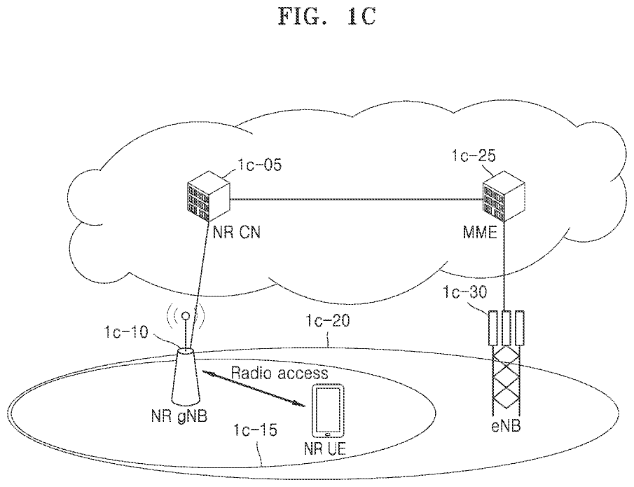

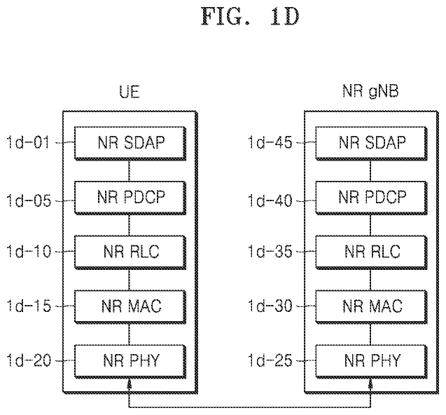

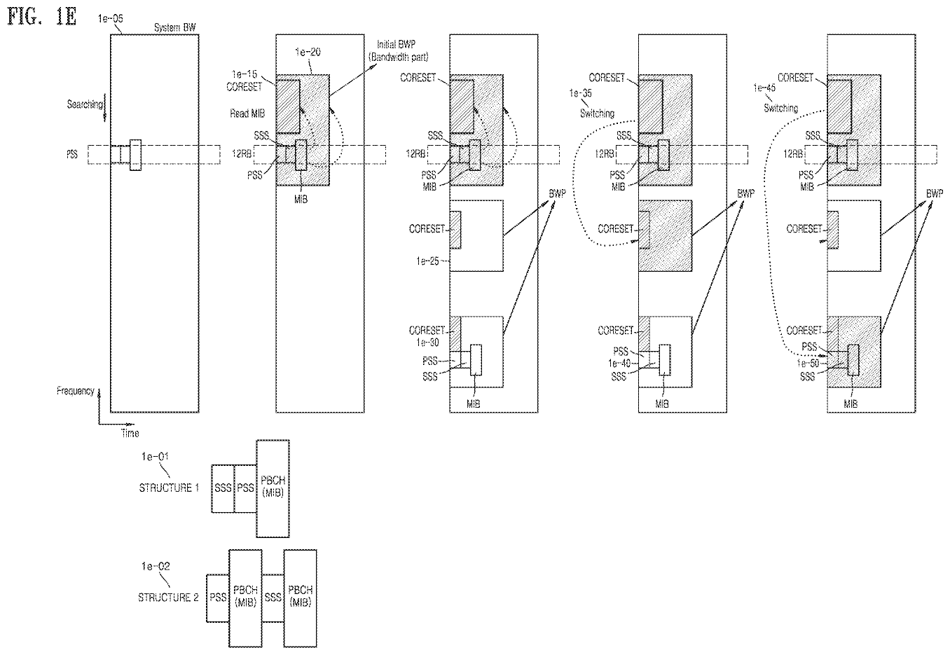

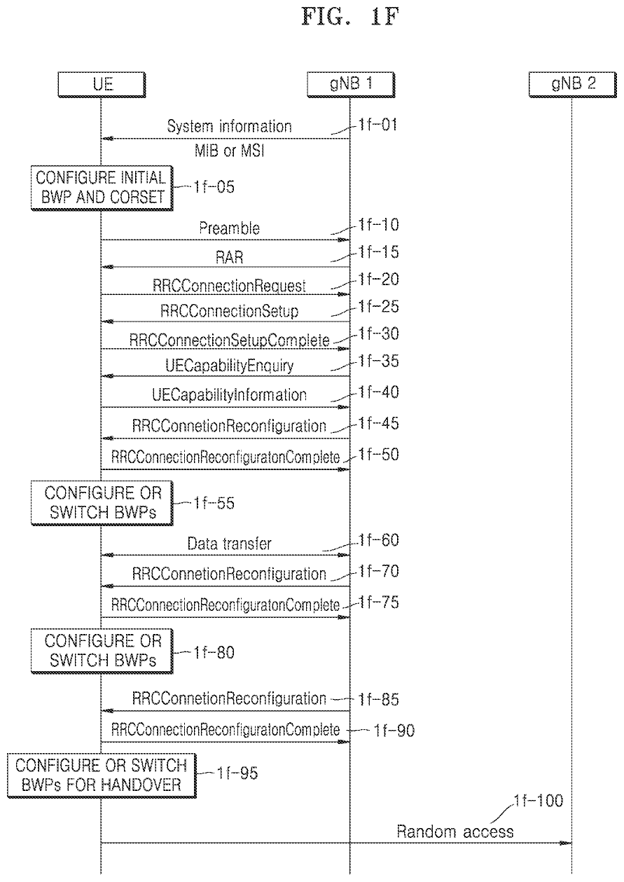

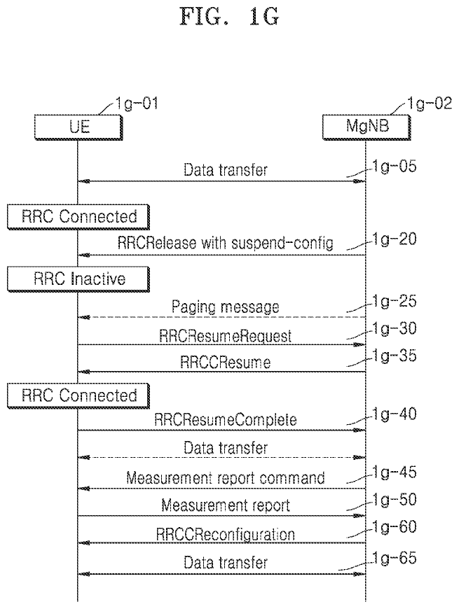

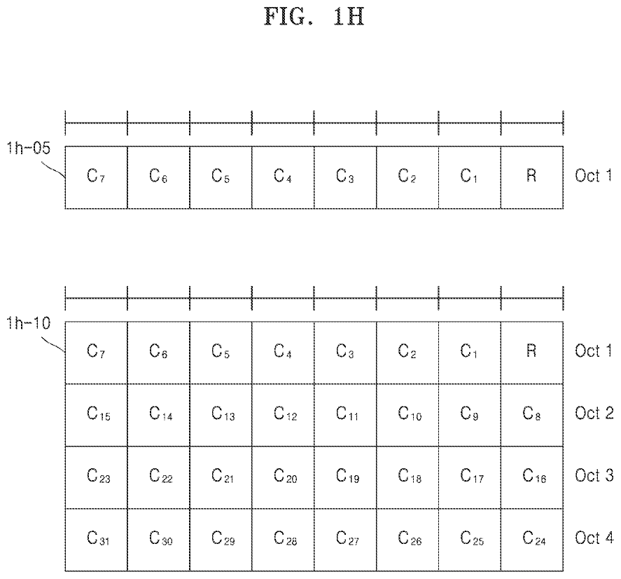

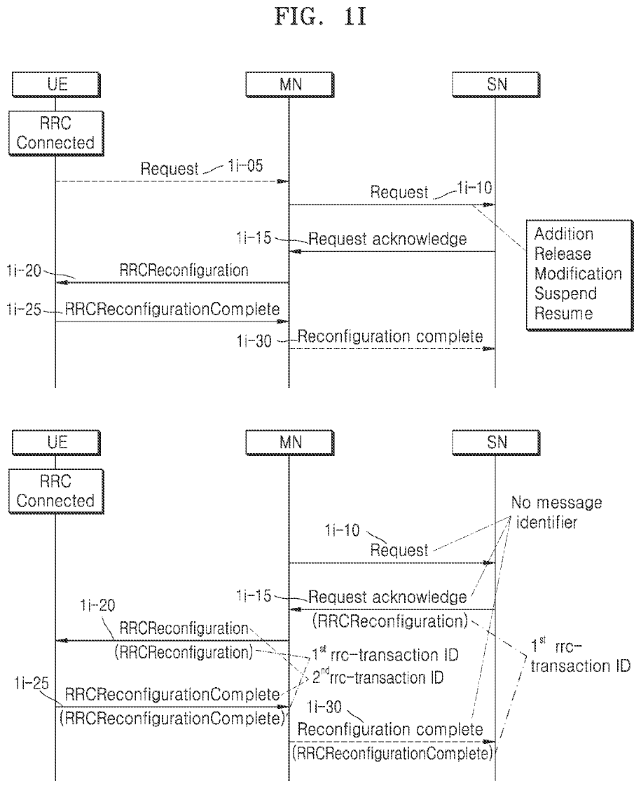

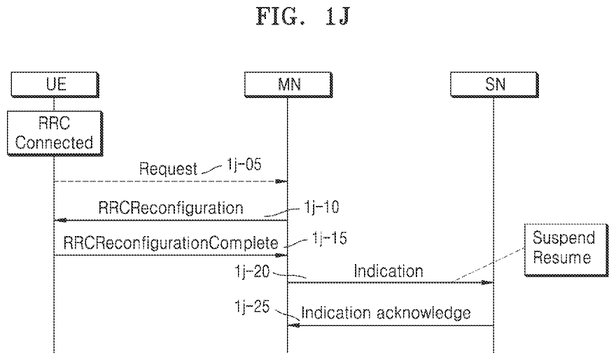

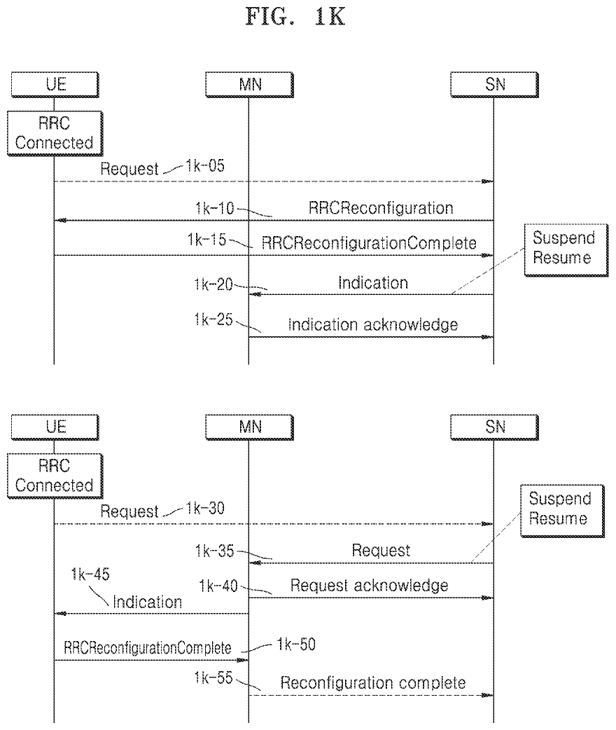

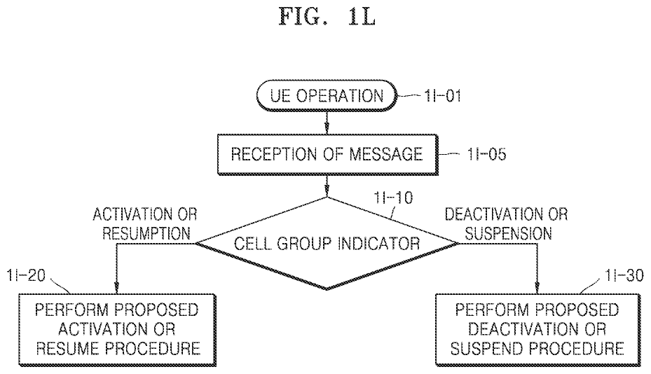

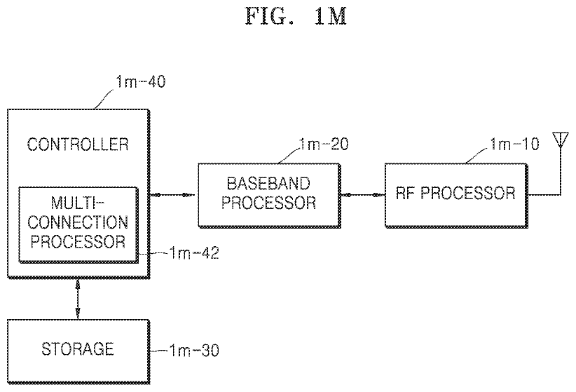

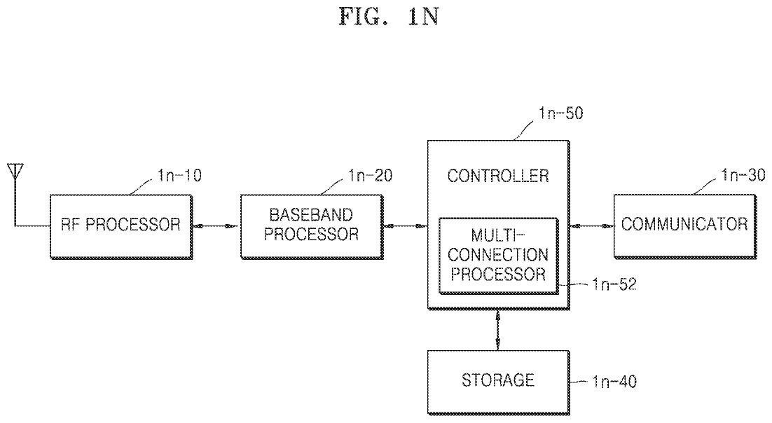

FIGS. 1A through 1N, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, operational principles of the disclosure will be described in detail with reference to accompanying drawings. In the descriptions of the disclosure, detailed explanations of the related art are omitted when it is deemed that they may unnecessarily obscure the essence of the disclosure. The terms used in the specification are defined in consideration of functions used in the disclosure, and can be changed according to the intent or commonly used methods of users or operators. Accordingly, definitions of the terms are understood based on the entire descriptions of the present specification.

Throughout the disclosure, the expression “at least one of a, b or c” indicates only a, only b, only c, both a and b, both a and c, both b and c, all of a, b, and c, or variations thereof.

Examples of a terminal may include a user equipment (UE), a mobile station (MS), a cellular phone, a smartphone, a computer, a multimedia system capable of performing a communication function, or the like.

In the disclosure, a controller may also be referred to as a processor.

Throughout the specification, a layer (or a layer apparatus) may also be referred to as an entity.

In the descriptions of the disclosure, detailed explanations of the related art are omitted when it is deemed that they may unnecessarily obscure the essence of the disclosure. Hereinafter, embodiments of the disclosure will be described in detail with reference to accompanying drawings.

Hereinafter, terms identifying an access node, terms indicating network entities, terms indicating messages, terms indicating an interface between network entities, and terms indicating various pieces of identification information, as used in the following description, are exemplified for convenience of explanation. Accordingly, the disclosure is not limited to terms to be described below, and other terms indicating objects having equal technical meanings may be used.

For convenience of descriptions, the disclosure uses terms and names defined in the 3^{rd} Generation Partnership Project (3GPP) long term evolution (LTE) standards. However, the disclosure is not limited to these terms and names, and may be equally applied to communication systems conforming to other standards. In the disclosure, an evolved node B (eNB) may be interchangeably used with a next-generation node B (gNB) for convenience of descriptions. That is, a base station (BS) described by an eNB may represent a gNB.

FIG. 1A illustrates a diagram of an architecture of a LTE system to which the disclosure is applicable.

Referring to FIG. 1A, a radio access network of the LTE system may include a plurality of next-generation BSs (e.g., eNBs, nodes B, or BSs) 1a-05, 1a-10, 1a-15, and 1a-20, a mobility management entity (MME) 1a-25, and a serving-gateway (S-GW) 1a-30. A UE (or a terminal) 1a-35 may access an external network via the eNB 1a-05, 1a-10, 1a-15, or 1a-20 and the S-GW 1a-30

In FIG. 1A, the eNB 1a-05, 1a-10, 1a-15, or 1a-20 may correspond to a legacy node B of a universal mobile telecommunications system (UMTS). The eNB 1a-05, 1a-10, 1a-15, or 1a-20 may be connected to the UE 1a-35 through wireless channels and perform complex functions compared to the legacy node B. In the LTE system, all user traffic data including real-time services such as voice over Internet protocol (VoIP) may be serviced through shared channels, and therefore, an entity for performing scheduling by collating status information of UEs, the state information including buffer state information, available transmit power state information, and channel state information, may be required and the eNB 1a-05, 1a-10, 1a-15, or 1a-20 may operate as such an entity. One eNB may generally control a plurality of cells. For example, the LTE system may use a radio access technology such as orthogonal frequency division multiplexing (OFDM) at a bandwidth of 20 MHz so as to achieve a data rate of 100 Mbps. The LTE system may also use adaptive modulation & coding (AMC) to determine a modulation scheme and a channel coding rate in accordance with a channel state of the UE 1a-35. The S-GW 1a-30 is an entity for providing data bearers and may generate or remove the data bearers under the control by the MME 1a-25. The MME 1a-25 is an entity for performing a mobility management function and various control functions on the UE 1a-35 and may be connected to the plurality of eNBs 1a-05, 1a-10, 1a-15, and 1a-20.

FIG. 1B illustrates a diagram of a radio protocol architecture of an LTE system to which the disclosure is applicable.

Referring to FIG. 1B, the radio protocol architecture of the LTE system may include packet data convergence protocol (PDCP) layers 1b-05 and 1b-40, radio link control (RLC) layers 1b-10 and 1b-35, media access control (MAC) layers 1b-15 and 1b-30, and physical (PHY) layers 1b-20 and 1b-25 respectively for a UE and a LTE eNB The PDCP layer 1b-05 or 1b-40 is in charge of, for example, Internet protocol (IP) header compression/decompression. Main functions of the PDCP layer 1b-05 or 1b-40 are summarized as shown below.
Header compression and decompression: robust header compression (ROHC) only.
Transfer of user data.
In-sequence delivery of upper layer packet data units (PDUs) at PDCP re-establishment procedure for RLC acknowledged mode (AM).
For split bearers in dual connectivity (DC) (only support for RLC AM): PDCP PDU routing for transmission and PDCP PDU reordering for reception.
Duplicate detection of lower layer service data units (SDUs) at PDCP re-establishment procedure for RLC AM.
Retransmission of PDCP SDUs at handover and, for split bearers in DC, of PDCP PDUs at PDCP data-recovery procedure, for RLC AM.
Ciphering and deciphering.
Timer-based SDU discard in uplink.

The RLC layer 1b-10 or 1b-35 performs, for example, an automatic repeat request (ARQ) operation by reconfiguring PDCP PDUs to appropriate sizes. Main functions of the RLC layer 1b-10 or 1b-35 may be summarized as shown below.
Transfer of upper layer PDUs.
Error correction through ARQ (only for AM data transfer).
Concatenation, segmentation and reassembly of RLC SDUs (only for unacknowledged mode (UM) and AM data transfer).
Re-segmentation of RLC data PDUs (only for AM data transfer).
Reordering of RLC data PDUs (only for UM and AM data transfer).
Duplicate detection (only for UM and AM data transfer).
Protocol error detection (only for AM data transfer).
RLC SDU discard (only for UM and AM data transfer).
RLC re-establishment.

The MAC layer 1b-15 or 1b-30 may be connected to a plurality of RLC layers configured for one UE, and may multiplex RLC PDUs into a MAC PDU and demultiplex the RLC PDUs from the MAC PDU. Main functions of the MAC layer 1b-15 or 1b-30 are summarized as shown below.
Mapping between logical channels and transport channels.
Multiplexing/demultiplexing of MAC SDUs belonging to one or different logical channels into/from transport blocks (TBs) delivered to/from the physical layer on transport channels.
Scheduling information reporting.
Error correction through hybrid ARQ (HARQ).
Priority handling between logical channels of one UE.
Priority handling between UEs by means of dynamic scheduling.
Multimedia broadcast/multicast service (MBMS) service identification.
Transport format selection.
Padding.

The PHY layer 1b-20 or 1b-25 may channel-code and modulate upper layer data into OFDM symbols and transmit the OFDM symbols through a wireless channel, or may demodulate OFDM symbols received through a wireless channel and channel-decode and deliver the OFDM symbols to an upper layer.

FIG. 1C illustrates a diagram of an architecture of a next-generation wireless communication system to which the disclosure is applicable.

Referring to FIG. 1C, a radio access network of the next-generation wireless communication system (e.g., an NR or 5G system) includes a next-generation BS (e.g., a new radio node B (NR gNB or NR BS) 1c-10 and a new radio core network (NR CN) 1c-05. An NR UE (or NR terminal) 1c-15 may access an external network via the NR gNB 1c-10 and the NR CN 1c-05.

In FIG. 1C, the NR gNB 1c-10 may correspond to an eNB of a legacy LTE system. The NR gNB 1c-10 may be connected to the NR UE 1c-15 through wireless channels and may provide superior services compared to an existing node B. In the NR or 5G system, all user traffic data may be serviced through shared channels, and therefore, an entity for performing scheduling by collating, for example, buffer state information of UEs, available transmit power state information, and channel state information may be required and the NR gNB 1c-10 may operate as such an entity. One NR gNB 1c-10 may control a plurality of cells. In the NR or 5G system, a bandwidth greater than the maximum bandwidth of the legacy LTE system may be applied to achieve an ultrahigh data rate, and a beamforming technology may be additionally associated with OFDM as a radio access technology. Also, AMC may also be used to determine a modulation scheme and a channel coding rate in accordance with a channel state of the NR UE 1c-15. The NR CN 1c-05 may perform functions such as mobility support, bearer establishment, and quality of service (QoS) configuration. The NR CN 1c-05 is an entity for performing a mobility management function and various control functions on the NR UE 1c-15 and may be connected to a plurality of base stations. Also, the NR or 5G system may cooperate with the legacy LTE system, and the NR CN 1c-05 may be connected to an MME 1c-25 through a network interface. The MME 1c-25 may be connected to a legacy eNB 1c-30.

FIG. 1D illustrates a diagram of a radio protocol architecture of a next-generation wireless communication system to which the disclosure is applicable.

Referring to FIG. 1D, the radio protocol architecture of the next-generation wireless communication system may include NR service data adaptation protocol (SDAP) layers 1d-01 and 1d-45, NR PDCP layers 1d-05 and 1d-40, NR RLC layers 1d-10 and 1d-35, NR MAC layers 1d-15 and 1d-30, and NR PHY layers 1d-20 and 1d-25 respectively for a UE and an NR gNB.

Main functions of the NR SDAP layer 1d-01 or 1d-45 may include some of the following.
Transfer of user plane data.
Mapping between a QoS flow and a data radio bearer (DRB) for both downlink (DL) and uplink (UL).
Marking QoS flow identification (ID) in both DL and UL packets.
Reflective QoS flow to DRB mapping for the UL SDAP PDUs.

With regard to the NR SDAP layer 1d-01 or 1d-45, information about whether to use a header of the NR SDAP layer 1d-01 or to use functions of the NR SDAP layer 1d-01 may be configured for the UE by using a radio resource control (RRC) message per PDCP layer, per bearer, or per logical channel, and when the SDAP header is configured, a 1-bit non access stratum (NAS) reflective QoS indicator and a 1-bit access stratum (AS) reflective QoS indicator of the SDAP header may be used to direct the UE to update or reconfigure UL and DL QoS flow and data bearer mapping information. The SDAP header may include QoS flow ID information indicating QoS. QoS information may be used as data processing priority information or scheduling information for appropriately supporting a service.

Main functions of the NR PDCP layer 1d-05 or 1d-40 may include some of the following.
Header compression and decompression: ROHC only.
Transfer of user data.
In-sequence delivery of upper layer PDUs.
Out-of-sequence delivery of upper layer PDUs.
PDCP PDU reordering for reception.
Duplicate detection of lower layer SDUs.
Retransmission of PDCP SDUs.
Ciphering and deciphering.
Timer-based SDU discard in uplink.

In the aforementioned descriptions, the reordering function of the NR PDCP layer 1d-05 or 1d-40 may indicate a function of reordering PDCP PDUs received from a lower layer, on a PDCP sequence number (SN) basis, and may include a function of delivering the reordered data to an upper layer in order or out of order, a function of recording missing PDCP PDUs by reordering the received PDCP PDUs, a function of reporting status information of the missing PDCP PDUs to a transmitter, or a function of requesting to retransmit the missing PDCP PDUs.

Main functions of the NR RLC layer 1d-10 or 1d-35 may include at least some of the following.
Transfer of upper layer PDUs.
In-sequence delivery of upper layer PDUs.
Out-of-sequence delivery of upper layer PDUs.
Error correction through ARQ.
Concatenation, segmentation and reassembly of RLC SDUs.
Re-segmentation of RLC data PDUs.
Reordering of RLC data PDUs.
Duplicate detection.
Protocol error detection.
RLC SDU discard.
RLC re-establishment.

In the above description, the in-sequence delivery function of the NR RLC layer 1d-10 or 1d-35 may indicate a function of delivering RLC SDUs received from a lower layer, to an upper layer in order. When a plurality of RLC SDUs segmented from one RLC SDU are received, the in-sequence delivery function of the NR RLC layer 1d-10 or 1d-35 may include a function of reassembling the RLC SDUs and delivering the reassembled RLC SDU, may include at least one of a function of reordering received RLC PDUs on an RLC SN or PDCP SN basis, a function of recording missing RLC PDUs by reordering the received RLC PDUs, a function of reporting status information of the missing RLC PDUs to a transmitter, or a function of requesting to retransmit the missing RLC PDUs, may include a function of delivering only RLC SDUs prior to a missing RLC SDU, to an upper layer in order when the missing RLC SDU exists, may include a function of delivering all RLC SDUs received before a timer starts, to an upper layer in order when a certain timer expires, even when a missing RLC SDU exists, and may include a function of delivering all RLC SDUs received up to a current time, to an upper layer in order when a certain timer expires, even when a missing RLC SDU exists. The NR RLC layer 1d-10 or 1d-35 may process the RLC PDUs in order of reception and may deliver the RLC PDUs to the NR PDCP layer 1d-05 or 1d-40 regardless of SNs (out-of-sequence delivery), and when a segment is received, the NR RLC layer 1d-10 or 1d-35 may reassemble the segment with other segments stored in a buffer or subsequently received, into a whole RLC PDU and may deliver the RLC PDU to the NR PDCP layer 1d-05 or 1d-40. The NR RLC layer 1d-10 or 1d-35 may not have a concatenation function, and the concatenation function may be performed by the NR MAC layer 1d-15 and 1d-30 or be replaced with a multiplexing function of the NR MAC layer 1d-15 and 1d-30.

In the above description, the out-of-sequence delivery function of the NR RLC layer 1d-10 or 1d-35 may refer to a function of directly delivering RLC SDUs received from a lower layer, to an upper layer out of order, may include a function of reassembling a plurality of RLC SDUs segmented from one RLC SDU and delivering the reassembled RLC SDU when the segmented RLC SDUs are received, and may include a function of recording missing RLC PDUs by storing RLC SNs or PDCP SNs of received RLC PDUs and reordering the received RLC PDUs.

The NR MAC layer 1d-15 and 1d-30 may be connected to a plurality of NR RLC layers configured for one UE, and main functions of the NR MAC layer 1d-15 and 1d-30 may include some of the following functions.
Mapping between logical channels and transport channels.
Multiplexing/demultiplexing of MAC SDUs.
Scheduling information reporting.
Error correction through HARQ.
Priority handling between logical channels of one UE.
Priority handling between UEs by means of dynamic scheduling.
MBMS service identification.
Transport format selection.
Padding.

An NR PHY layer 1d-20 and 1d-25 may channel-code and modulate upper layer data into OFDM symbols and transmit the OFDM symbols through a wireless channel, or may demodulate OFDM symbols received through a wireless channel and channel-decode and deliver the OFDM symbols to an upper layer.

Because a next-generation wireless communication system can use very high band frequencies, frequency bandwidths may also be very wide. However, in view of UE implementation, supporting all of the very wide bandwidths requires high complexity of implementation and incurs high costs. Accordingly, the next-generation wireless communication system may introduce the concept of a bandwidth part (BWP), and may configure a plurality of BWPs for one cell (e.g., an Spcell or a secondary cell (SCell)), and data may be transmitted and received in one or more BWPs of the one cell according to an indication by a BS.

The disclosure provides a state transitioning method or a BWP switching method and a specific operation thereof, based on a state of an Scell and a plurality of BWPs configured for the Scell when a dormant BWP proposed in the disclosure is introduced. Also, the disclosure provides a method of managing a dormant mode in units of BWPs (BWP-level) and performing state transition or a BWP switching method, and provides a specific operation of a BWP according to a state of each SCell, or a state or mode of each BWP (e.g., active, inactive mode, or dormant).

According to an embodiment of the disclosure, a plurality of BWPs may be configured for one cell (e.g., an Spcell, a Pcell, a Pscell or an Scell) with respect to each DL or each UL, and through BWP switching, an active BWP (active DL or UL BWP), a dormant BWP (dormant UL BWP or dormant DL BWP), or an inactive BWP (inactive or deactivated DL/UL BWP) may be configured and operated. That is, a data rate may be increased in a way similar to a CA technology by transitioning a DL or UL BWP for the one cell to an activate state, power consumption may be reduced by allowing a UE not to perform PDCCH monitoring on the cell by transitioning or switching a DL BWP to a dormant BWP, and fast activation of a cell or a BWP may be supported by allowing the UE to perform channel measurement on a DL BWP and report a result of the channel measurement. Also, power consumption of a UE may be reduced by transitioning a DL (or UL) BWP for the one cell to an inactive state. In the above descriptions, the BS may configure and indicate a BWP state transition indication or a BWP switching indication for each cell by a radio resource control (RRC) message, a MAC control element (MAC CE), or downlink control information (DCI) of a PDCCH. The dormant BWP may also be extended and applied to dual connectivity, for example, to a PSCell of an SCG.

As another method, the dormant BWP may be extended to the concept of cell group suspension or cell group deactivation, and thus, the BS may indicate cell group suspension or deactivation to one cell group (e.g., an SCG) of a UE for which dual connectivity is configured, such that, with respect to the indicated cell group, the UE may suspend data transmission or reception, may suspend PDCCH monitoring, or may intermittently perform PDCCH monitoring with a very long period, thereby reducing power consumption of the UE. Also, when the UE receives the indication of cell group suspension or deactivation, the UE may perform a channel measurement procedure in the cell group for which cell group suspension or deactivation is indicated, and may report a channel measurement result to a network (e.g., to a MCG or an SCG), thereby supporting fast activation of dual connectivity. In the above descriptions, the cell group for which cell group suspension or deactivation is indicated, the UE may perform the channel measurement procedure, or may maintain and store cell group configuration information about the cell group without discarding or releasing the cell group configuration information, or may recover the cell group configuration information according to a cell group activation or resumption indication by a network. For example, the UE may changelessly store or maintain the cell group configuration information (e.g., configuration information or bearer configuration information of each PDCP, RLC, or MAC layer) or configuration information of each cell, which is configured for the UE. If the UE receives a cell group resume or activation indication with respect to the cell group for which cell group suspension or deactivation is indicated, the UE may resume, recover, or re-apply the cell group configuration information, and may resume a bearer or may re-start data transmission or reception or may re-start PDCCH monitoring or may perform channel measurement reporting or may periodically reactivate configured transport resources.

The BS may include and configure first channel measurement configuration information (e.g., configuration information about a channel state information reference signal (CSI-RS) or a synchronization signal block (SSB) or a radio resource/reference signal (RS)) for fast cell group activation, in the cell group configuration information or pre-configured cell group configuration information or a message indicating cell group activation or resumption (e.g., an RRC message or RRCReconfiguration). According to another method, the BS may include and pre-configure first channel measurement configuration information (e.g., configuration information about a CSI-RS or an SSB or an RS) for fast cell group activation, in a message indicating cell group deactivation or suspension or release. In order for the BS to many or frequently transmit a channel measurement signal to allow a cell to fast perform channel measurement to fast activate the cell group, the first channel measurement configuration information may include, in configuration information of the cell (e.g., a PCell or a PSCell or an SCell) of the cell group, configuration information about a period of a frequent channel measurement signal (e.g., radio resource) or information about a transport resource being transmitted (a frequency or time transport resource in which the frequent channel measurement signal is transmitted) or a duration or a count (the number of times the frequent channel measurement signal is transmitted) or a timer value (a time in which the frequent channel measurement signal is transmitted) or time duration (duration (e.g., a time unit (a slot or a subframe or a symbol) in which the frequent channel measurement signal is transmitted) or a transport resource, a period, a duration or timing for reporting measurement result of the UE. In the above descriptions, by using the first channel measurement configuration information, the BS may not only configure a short reporting period (or transport resource) for the UE to report a channel measurement result but may also configure a transport resource for channel measurement so that the BS can transmit frequently or many channel measurement signals (or transport resources) to support fast channel measurement or many signal measurements.

Also, the cell group configuration information or pre-configured cell group configuration information or a message indicating cell group activation or resumption (e.g., an RRC message or RRCReconfiguration) may include second channel measurement configuration information (e.g., configuration information about a CSI-RS or an SSB or a radio resource/reference signal (RS)) for measuring a signal of a cell (a PSCell or a PCell or an SCell) of a cell group. Alternatively, the cell group configuration information or the pre-configured cell group configuration information or a message indicating cell group deactivation or suspension or release may previously include the second channel measurement configuration information (e.g., configuration information about a CSI-RS or an SSB or a radio resource/reference signal (RS)) for measuring a signal of the cell (a PSCell or a PCell or an SCell) of the cell group. The second channel measurement configuration information may include general channel measurement configuration information such as a transport resource or a period or time duration or a count of a channel measurement signal, or a transport resource or a period or time duration for channel measurement reporting.

In the disclosure, a UE may measure a channel and may report a measurement result to a BS by applying first channel measurement configuration information or second channel measurement configuration information according to the following conditions.
1> When the UE receives a message (e.g., PDCCH indicator or MAC control information or RRC message) indicating to activate (or to resume) a cell (PCell or PSCell or SCell) or a cell group.
   2> When first channel measurement configuration information is configured for the UE.
      3> The UE may identify that the BS is to frequently transmit many channel measurement signals according to the first channel measurement configuration information, and may measure, according to the first channel measurement configuration information, many or frequent channel measurement signals temporarily (e.g., up to time duration (e.g., subframe or slot or symbol) configured for the first channel measurement configuration information or during predefined (or predetermined) time duration or during a certain period of time (e.g., while a timer is running) or until a first condition is satisfied). Also, according to a period or a transport resource configured in the first channel measurement configuration information, the UE may report a channel measurement result up to a time duration configured in the first channel measurement configuration information (e.g., subframe or slot or symbol), or during a predefined (or predetermined) time duration or during a certain period of time (e.g., while a timer is running) or until a first condition is satisfied). Accordingly, because the UE may rapidly measure a frequent channel measurement signal and may rapidly report a result, the UE may rapidly activate (or resume) the cell (PCell, SCell, or PSCell) or may rapidly receive an indication of scheduling information. When second channel measurement configuration information is configured for the UE after a time duration configured in the first channel measurement configuration information (e.g., subframe or slot or symbol), or after a predefined (or predetermined) time duration or after a certain period of time (e.g., when a timer expires) or after a first condition is satisfied, the UE may stop or release application of the first channel measurement configuration information and may measure a channel measurement signal according to the second channel measurement configuration information. For example, the UE may fall back from the first channel measurement configuration information to the second channel measurement information or may apply the second channel information instead of the first channel measurement configuration information. Also, the UE may report the channel measurement result according to a period or a transport resource configured in the second channel measurement configuration information. When the second channel measurement configuration information is not configured, the UE may not perform channel measurement.
   2> Otherwise (When the first channel measurement configuration information is not configured for the UE).
      3> When the second channel measurement configuration information is configured for the UE, the UE may measure a channel measurement signal according to the second channel measurement configuration information. Also, the UE may report a channel measurement result according to a period or a transport resource configured in the second channel measurement configuration information. When the second channel measurement configuration information is not configured, the UE may not perform channel measurement.

In the disclosure, the first channel measurement configuration information may be extended, configured, and used when the cell group (e.g., PSCell) is activated or is resumed or when the SCell is activated or when RRC connection is resumed in an RRC inactive mode.

In the disclosure, the first condition may be one of the following conditions. Hereinafter, in the disclosure, when a cell is activated or when a cell group is activated or is resumed or when an RRC inactive mode UE resumes connection in an RRC connection resume procedure, efficient conditions under which the BS does not need to transmit unnecessarily many transport resources or frequently transport resources are proposed as a first condition. For example, the UE or the BS may apply the first channel measurement configuration information, and may perform a channel measurement procedure or a channel measurement reporting procedure until one of the following conditions is satisfied.
In a case where the UE successfully completes a random access procedure in the cell (e.g., PCell or SCell or PSCell) or the cell (e.g., PSCell or SCell) of the cell group or a case where the UE successfully completes a random access procedure and is allocated a first UL transport resource or a case where a UL transport resource is first indicated to the UE1, the UE may determine that the first condition is satisfied.
   For example, in more detail, when the UE performs a contention-free random access (CFRA) procedure (e.g., when a pre-designated preamble or a UE cell identifier (e.g., cell radio network temporary identifier (C-RNTI)) is allocated).
      In a case where the UE transmits the pre-designated preamble to the cell and receives a random access response (RAR) message or a case where the UE receives an indication of the PDCCH in response to the RAR, it may be determined that the random access procedure is successfully completed and thus the UE may determine that the first condition is satisfied. In another method, when a UL transport resource is first received after RAR reception, the UE may determine that the first condition is satisfied.
   When the UE performs a contention-based random access (CBRA) procedure (e.g., when a pre-designated preamble or a UE cell identifier (e.g., C-RNTI) is not allocated).
      In a case where the UE transmits a preamble (e.g., arbitrary preamble) to the cell, receives an RAR message, transmits a message 3 (e.g., handover completion message) by using an UL transport resource allocated, included, or indicated in the RAR message, and receives a contention resolution MAC CE indicating that contention has been resolved via a message 4 from the BS or a case where the UE receives a UL transport resource via the PDCCH corresponding to the C-RNTI of the UE, it may be determined that the random access procedure to a target BS is successfully completed and thus the UE may determine that the first condition is satisfied. In another method, in a case where the size of the UL transport resource allocated in the RAR message is sufficient and thus, the message 3 can be transmitted and the UE can additionally transmit UL data, the UE may determine that the UL transport resource is first received and the first condition is satisfied. That is, when the UE receives the RAR, the UE may determine that the UL transport resource is first received and may determine that the first condition is satisfied.

1> When a 2-step random access procedure is configured or indicated for the UE and thus, the UE performs the procedure.

1> Alternatively, when the 2-step random access procedure is not configured or indicated but the UE supports the 2-step random access procedure in UE capability, the 2-step random access procedure is supported in system information of the cell, and information for the 2-step random access procedure is broadcast in the system information (e.g., 2-step random access resource or threshold value for determining whether to or not to perform 2-step random access), the UE receives the system information and when the strength of a signal is better or greater than the threshold value broadcast in the system information and thus the UE performs the 2-step random access procedure on the cell.
2> When the 2-step random access procedure is successfully completed, the UE may determine that the first condition is satisfied.
2> The 2-step random access procedure may be performed by using one of a CBRA method or a CFRA method.
   3> When the UE performs the CBRA-based 2-step random access procedure,
      4> the UE may transmit a preamble in a transport resource for 2-step random access (e.g., PRACH occasion, transport resource configured via the RRC message by the BS, or transport resource broadcast in the system information), and may transmit data (e.g., MsgA MAC PDU) in a transport resource for data transmission (e.g., PUSCH occasion). The data may include the MAC control information (C-RNTI MAC CE) including the UE identifier (C-RNTI), or the RRC message (RRCReconfigurationComplete message or handover completion message).
      4> The UE may monitor the PDCCH scrambled by the UE identifier (C-RNTI) or a first identifier (MsgB-RNTI) derived by a time or a frequency at which a preamble is transmitted.
      4> When the UE receives the PDCCH scrambled by the UE identifier or is allocated a DL transport resource via the PDCCH or receives the MAC control information for timing adjustment (timing advance command MAC CE) in the DL transport resource,
         5> the UE may determine that the 2-step random access procedure is successfully completed and may determine that the first condition is satisfied.
      4> When the UE does not receive the PDCCH scrambled by the first identifier (MsgB-RNTI) or is allocated a DL transport resource via the PDCCH or receives a fallback RAR to a preamble transmitted by the UE in the DL transport resource (i.e., the fallback RAR indicating to transmit MsgA in another transport resource when the BS receives the preamble but does not receive MsgA),
         5> the UE may transmit data (MsgA MAC PDU) in a transport resource indicated in the fallback RAR.
         5> The UE may monitor the PDCCH scrambled by the UE identifier (C-RNTI).
         5> When the UE receives the PDCCH scrambled by the UE identifier or is allocated a UL transport resource via the PDCCH, the UE may determine that the 2-step random access procedure is successfully completed and may determine that the first condition is satisfied.
      3> When the UE performs the CFRA-based 2-step random access procedure,
      4> the UE may transmit a preamble in a transport resource for 2-step random access (e.g., PRACH occasion or transport resource designated via the RRC message by the BS), and may transmit data (e.g., MsgA MAC PDU) in a transport resource for data transmission (e.g., PUSCH occasion). The data may include the MAC control information (C-RNTI MAC CE) including the UE identifier (C-RNTI) or the RRC message (RRCReconfigurationComplete message or handover completion message).
      4> The UE may monitor the PDCCH scrambled by the UE identifier (C-RNTI) or the first identifier (MsgB-RNTI) derived by a time or a frequency at which a preamble is transmitted.
      4> When the UE receives the PDCCH scrambled by the UE identifier or is allocated a DL transport resource via the PDCCH or receives the MAC control information for timing adjustment (timing advance command MAC CE) in the DL transport resource,
         5> the UE may determine that the 2-step random access procedure is successfully completed and may determine that the first condition is satisfied.
      4> When the UE receives the PDCCH scrambled by the first identifier (MsgB-RNTI) or is allocated a DL transport resource via the PDCCH or receives a fallback RAR to a preamble transmitted by the UE in the DL transport resource (i.e., the fallback RAR indicating to transmit MsgA in another transport resource when the BS receives the preamble but does not receive MsgA),
         5> the UE may determine that the 2-step random access procedure is successfully completed and may determine that the first condition is satisfied.
         5> The UE may transmit data (MsgA MAC PDU) in a transport resource indicated in the fallback RAR.

1> The UE may determine that the first condition is satisfied when the random access procedure starts or a preamble for the random access procedure is transmitted.

1> In another method, when the 2-step random access procedure is configured or is indicated for the UE, the UE may determine that the first condition is satisfied. For example, the UE may determine that the first condition is satisfied before the 2-step random access procedure starts.

1> In another method, when the 2-step random access procedure is configured or is indicated for the UE via the message and a transport resource (PUSCH) configured for data transmission in the 2-step random access procedure is greater than a first threshold value, or when a configuration value for timing adjustment (timing advance value) is included in the RRC message, the UE may determine that the first condition is satisfied. In the above case, the first threshold value may be configured in the RRC message (e.g., RRCReconfiguration) by the BS, may be broadcast in the system information, or may be configured in a size of data which the UE has to transmit. For example, in the above case, the UE may determine that the first condition is satisfied before the 2-step random access procedure starts. In another method, when the configuration value for timing adjustment (timing advance value) is included or the 2-step random access procedure is configured in the RRC message, the UE may not transmit a preamble and may directly transmit data in a configured transport resource (e.g., transport resource configured via the RRC message or transport resource indicated via the PDCCH of a target BS monitored by the UE). Accordingly, in the above case, before the 2-step random access procedure starts or when the data is transmitted or before the data is transmitted, the UE may determine that the first condition is satisfied. In another method, when the configuration value for timing adjustment (timing advance value) is included or the 2-step random access procedure is configured in the RRC message, the UE may not transmit a preamble, and may directly transmit data in a configured transport resource (PUSCH) (e.g., transport resource configured via the RRC message or transport resource indicated via the PDCCH of the target BS monitored by the UE). In this above case, when the configured transport resource (PUSCH) (e.g., transport resource configured in the RRC message or transport resource indicated via the PDCCH of the target BS monitored by the UE) is greater than the first threshold value, or when the configuration value for timing adjustment (timing advance value) is included in the RRC message, before the 2-step random access procedure starts or when the data is transmitted or before the data is transmitted, the BS may determine that the first condition is satisfied.

1> When the RRC inactive mode UE transmits an RRCResumeRequest message and receives an RRCResume message (or RRCSetup message) as a response thereto, the UE may determine that the first condition is satisfied.

1> Alternatively, in a case where a point of time when the UE is indicated to resume or activate the cell group, via an RRC message or MAC control information or DCI information of a PDCCH is n, up to a point of time of n+X or when the point of time of n+X is reached or when the point of time of n+X is passed (in the above case, a time unit of n or X may be a time unit such as a symbol unit or a subframe unit or a millisecond unit or a slot unit or the like, and the X may be configured in the RRC message or may be a value predefined and preset by another method.)

In the above case, when the first condition is satisfied, a higher layer (e.g., RRC layer) may indicate by using an indicator to a lower layer (e.g., PDCP layer or RLC layer or MAC layer or PHY layer), or a lower layer (e.g., PDCP layer or RLC layer or MAC layer or PHY layer) may indicate to a higher layer (e.g., RRC layer).

In the disclosure, the term ‘BWP’ may be used without being distinguished between a UL and the DL, and may refer to each of a UL BWP and a DL BWP according to the context.

In the disclosure, the term ‘link’ may be used without being distinguished between the UL and the DL, and may refer to each of the UL and the DL according to the context.

In the disclosure, the term ‘cell’ may indicate a PCell or an SCell (e.g., SCell configured in an MCG), a PSCell (e.g., PCell of an SCG), or an SCell (e.g., SCell configured in the SCG).

In the disclosure, a dormant BWP may be configured or introduced for the SCell or the PSCell of the UE that performs carrier aggregation or dual connectivity, and power consumption of the UE may be reduced by not monitoring the PDCCH in the dormant BWP, and when channel measurement is performed and reported in the dormant BWP (e.g., channel state information (CSI) or channel quality information (CQI) measurement or reporting) or beam measurement or beam tracking or beam operation is performed and thus data transmission is required, data transmission may rapidly start in a normal BWP by switching or activating to the normal BWP. In the above case, the dormant BWP may not be configured or applied to the SpCell (PCell of the MCG or PCell (or PSCell) of the SCG) or the SCell configured with a physical uplink control channel (PUCCH), in which a signal should be continuously monitored or a feedback should be transmitted or received or synchronization should be identified and maintained.

In the above case, when the UE is indicated to switch to the dormant BWP or activate the dormant BWP for the SCell of the MCG via the PCell, the UE may perform a channel measurement procedure on the dormant BWP of the SCell, and may report a measured channel measurement result in a transport resource of the PCell of the MCG (e.g., via a physical uplink control channel (PUCCH) transport resource of the PCell) or a transport resource of the SCell configured with the PUCCH of the MCG (e.g., in a PUCCH transport resource). In the above case, which cell or in which transport resource (e.g., PUCCH or physical uplink shared channel (PUSCH)) of which cell a channel measurement result of a BWP of which cell is reported may be configured in the UE via the RRC message for each cell or for each BWP.

In the above case, when the UE is indicated to switch to the dormant BWP or activate the dormant BWP for the SCell of the SCG via the PSCell, the UE may perform a channel measurement procedure on the dormant BWP of the SCell, and may report a measured channel measurement result in a transport resource of the PSCell of the SCG (e.g., in a PUCCH transport resource of the PSCell) or in a transport resource of the SCell configured with the PUCCH of the SCG (e.g., in a PUCCH transport resource). In the above case, which cell or in which transport resource (e.g., PUCCH or PUSCH) of which cell a channel measurement result for a BWP of which cell is reported may be configured in the UE via the RRC message for each cell or each BWP.

In the above case, when the UE is indicated to switch to the dormant BWP or activate the dormant BWP for the PSCell or the SCell of the SCG via the PCell or is indicated to suspend a cell group for the SCG (or PSCell) (SCG suspension or cell group suspension), the UE may perform a channel measurement result on a BWP of the PSCell or the SCell (BWP configured by the RRC message or last activated BWP) or the dormant BWP, and may report a measured channel measurement result in a transport resource of the PCell of the MCG (e.g., in a PUCCH transport resource of the PCell), or in a transport resource of the SCell configured with the PUCCH of the MCG (e.g., in a PUCCH transport resource), or in a transport resource of the PSCell of the SCG (e.g., in a PUCCH transport resource of the PSCell). In the above case, which cell or in which transport resource (e.g., PUCCH or PUSCH) of which cell a channel measurement result of a BWP of which cell is reported may be configured in the UE via the RRC message for each cell or each BWP.

The disclosure provides various embodiments of operating based on the DCI of the PDCCH, the MAC CE, or the RRC message, in order to operate the dormant BWP or cell group suspension state for the SCell (SCell of the MCG when carrier aggregation is configured or SCell of the SCG when dual connectivity is configured) or the PSCell (PCell of the SCG when dual connectivity is configured) of the UE1.

The network or the BS may configure Spcells (Pcells and PScells) and a plurality of Scells in the UE. In the above case, when the UE communicates with one BS, the Spcell may refer to the Pcell, and when the UE communicates with two BSs (master BS and secondary BS), the Spcell may indicate the Pcell of the master BS or the PScell of the secondary BS. In the above case, The Pcell or the Pscell may be a main cell used when the UE and the BS communicate with each other in respective MAC layers, and may indicate a cell that performs timing for synchronization, performs random access, transmits an HARQ ACK/NACK feedback in a PUCCH transport resource, and transmits and receives most control signals. In the above case, technology in which the BS increases transport resources and increases UL or DL data transport resources by operating a plurality of Scells along with the Spcell is referred to as carrier aggregation or dual connectivity.

When the UE is configured with the Spcell and the plurality of Scells via the RRC message, the UE may be configured with a state or mode of each cell (PCell or PSCell or SCell), or each Scell or a BWP of each SCell or cell group via the RRC message or the MAC CE or the DCI of the PDCCH. In the above case, the state or mode of the cell may be configured as an active (activated) mode or an active (activated) state, and an inactive (deactivated) mode or an inactive (deactivated) state. In the above case, when the cell is in the active mode or the active state, it may mean that the UE may transmit and receive UL or DL data to and from the BS in a BWP other than an activated BWP or an activated normal BWP or an activated dormant BWP of the cell in the active mode or in the activated cell, may monitor the PDCCH to detect an indication by the BS, may perform channel measurement on the DL of the cell of the active mode or the active state (or the BWP other than the activated BWP, or the activated normal BWP, or the activated dormant BWP of the cell) and may periodically report measurement information to the BS, and may periodically transmit a pilot signal (sounding reference signal (SRS)) to the BS so that the BS can perform UL channel measurement. Alternatively, the UE may activate the BWP to the dormant BWP or may switch the dormant BWP according to the indication by the BS for the activated cell (e.g., the PDCCH or the MAC CE or the RRC message), and when the dormant BWP is activated in the activated cell, the UE may perform channel measurement reporting and may perform a procedure of reporting a channel measurement result, without performing PDCCH monitoring in the cell.

In another method, when the cell in which the dormant BWP is activated is the SCell, the UE may not monitor the PDCCH or may not receive DL data or may perform channel measurement or measurement result reporting or may suspend a configured periodic transport resource (e.g., type 1 periodic transport resource (configured uplink grant type 1)) or may clear or initialize a configured periodic transport resource (e.g., type 2 periodic transport resource (configured uplink grant type 2)) or may not transmit a sounding reference signal (SRS) or may not transmit UL data or may not transmit the PUCCH (e.g., scheduling request (SR) or preamble for random access). However, in the above case, when the cell in which the dormant BWP is activated or cell group suspension is indicated is the PSCell, the UE may not monitor the PDCCH or may perform PDCCH monitoring with a very long period or may not receive DL data or may perform channel measurement or measurement result reporting or may suspend the configured periodic transport resource (e.g., type 1 periodic transport resource) (configured uplink grant type 1)) or may clear or initialize the configured periodic transport resource (e.g., type 2 periodic transport resource (configured uplink grant type 2)) or may transmit an SRS or may not transmit UL data or may transmit the PUCCH (e.g., SR or preamble for random access) or may perform a random access procedure.

In the above case, when the cell that is activated to the BWP other than the dormant BWP is the SCell, the UE may monitor the PDCCH or may receive DL data or may perform channel measurement or measurement result reporting or may resume the configured periodic transport resource (e.g., type 1 periodic transport resource (configured uplink grant type 1)) or may configure or activate the configured periodic transport resource (e.g., type 2 periodic transport resource (configured uplink grant type 2)) or may transmit an SRS or may transmit UL data or may transmit the PUCCH (e.g., SR or preamble for random access) or may perform a random access procedure.

In the above case, when the cell that is activated to the BWP other than the dormant BWP or in which cell group resumption (SCG resumption) is indicated is the PSCell, the UE may perform PDCCH monitoring or may receive DL data or may perform channel measurement or measurement result reporting or may resume the configured periodic transport resource (e.g., type 1 periodic transport resource (configured uplink grant type 1)) or may configure or activate the configured periodic transport resource (e.g., type 2 periodic transport resource (configured uplink grant type 2)) or may transmit an SRS or may transmit UL data or may transmit the PUCCH (e.g., SR or preamble for random access) or may perform a random access procedure.

However, when the cell is in the inactive mode or the inactive state, it may mean that because the UE is in a state in which BWPs configured in the cell are deactivated or the configured BWPs are not activated, or there is no activated BWP from among the configured BWPs, the UE may not transmit and receive data to and from the BS, does not monitor the PDCCH to detect an indication by the BS, does not perform channel measurement, does not perform measurement reporting, and does not transmit a pilot signal.

Accordingly, in order to activate the cells in the inactive mode, the BS may first configure frequency measurement configuration information for the UE via the RRC message, and the UE may perform cell or frequency measurement based on the frequency measurement configuration information. The BS may receive a cell or frequency measurement report of the UE, and then may activate the deactivated cells based on frequency/channel measurement information. Accordingly, long latency occurs when the BS activates carrier aggregation or dual connectivity and starts data transmission or reception to or from the UE.

The disclosure provides the configuration or introduction of a dormant BWP or a dormant state for a BWP of each activated cell (e.g., activated Scell or activated PSCell) to reduce power consumption of the UE and rapidly start data transmission or reception, or provides the configuration or introduction of a dormant BWP for each activated cell. Alternatively, the disclosure provides the configuration or introduction of a state of a cell group for each cell group as an active state, a dormant state, a suspended state, an inactive state, or a resumed state, when dual connectivity is configured for the UE, and provides a method of performing a cell group suspension (SCG suspension or Cell group suspension) or cell group resumption (SCG resumption or Cell group resumption) indication indicating cell group state transition.

In a BWP or a dormant BWP that is a dormant mode of the activated cell (dormant BWP in activated SCell), or when the dormant BWP is activated, the UE may not transmit and receive data to and from the BS, or may not monitor the PDCCH to detect an indication by the BS, or may not transmit a pilot signal but may perform channel measurement, and may report a measured frequency/cell/channel measurement result according to the BS configuration periodically or when an event occurs. Accordingly, because the UE does not monitor the PDCCH and does not transmit a pilot signal in the dormant BWP of the activated cell, power consumption may be reduced compared to a normal BWP of the activated cell (or BWP other than the dormant BWP) or compared to when the normal BWP of the activated cell (or BWP other than the dormant BWP) is activated, and unlike a case where the cell is deactivated, because the UE performs channel measurement reporting, the BS may rapidly activate the normal BWP of the activated cell based on a measurement report or a measurement report of the dormant BWP of the activated cell, such that rapid use of carrier aggregation is possible and thus transmission latency may be decreased.

Accordingly, in the disclosure, when the cell is in the active mode or the active state, it may mean that the UE may transmit and receive UL or DL data to and from the BS in the BWP other than the activated BWP or the activated normal BWP or the activated dormant BWP of the cell in the activated mode or in the activated cell, may monitor the PDCCH to detect an indication by the BS, may perform channel measurement on the DL of the cell of the active mode or the active state (or the BWP other than the activated BWP or the activated normal BWP or the activated dormant BWP of the cell) and may periodically report measurement information to the BS, and may periodically transmit a pilot signal (SRS) to the BS so that the BS can perform UL channel measurement. Also, in the disclosure, when the cell is in the active mode or the active state, it may mean that the UE may not transmit and receive UL or DL data to and from the BS in the activated dormant BWP of the cell in the active mode or in the activated cell or may not monitor the PDCCH to detect an indicator by the BS but may perform channel measurement on the DL of the activated dormant BWP of the cell of the active mode or the active state and may periodically report measurement information to the BS.

In the above case, when the cell in which the dormant BWP is activated or cell group suspension is indicated is the PSCell, the UE may not monitor the PDCCH or may perform PDCCH monitoring with a very long period or may not receive DL data or may perform channel measurement or measurement result reporting or may suspend the configured periodic transport resource (e.g., type 1 periodic transport resource (configured uplink grant type 1)) or may clear or initialize the configured periodic transport resource (e.g., type 2 periodic transport resource (configured uplink grant type 2)) or may transmit an SRS or may not transmit UL data or may transmit the PUCCH (e.g., SR or preamble for random access) or may perform a random access procedure.

Also, in the disclosure, a dormant BWP may indicate a state of a BWP or may be used as a logical name indicating a specific BWP. Accordingly, the dormant BWP may be activated or may be deactivated or may be switched. For example, an indication to switch a second BWP activated in a first cell to a dormant BWP or an indication to transition the first cell to hibernation or a dormant mode or an indication to activate a dormant BWP of the first cell may be interpreted as the same meaning.

Also, in the disclosure, a normal BWP may indicate BWPs other than a dormant BWP from among BWPs configured for each cell of the UE via an RRC message, and in the normal BWP, the UE may transmit and receive UL or DL data to and from the BS, may monitor the PDCCH to detect an indication by the base station, may perform channel measurement on the DL and may periodically report measurement information to the BS, and may periodically transmit a pilot signal (SRS) to the BS so that the BS can perform UL channel measurement. Also, the normal BWP may indicate a first active BWP or a default BWP or a first active BWP activated from hibernation or an initial BWP.

Also, from among BWPs configured for each cell of the UE, only one dormant BWP may be configured for the DL. In another method, from among BWPs configured for each cell of the UE, only one dormant BWP may be configured for the UL or the DL.

Also, in the disclosure, the state of the cell group may be configured as an active state or a suspended state or an inactive state. The state of the cell group may be indicated by a bitmap or an indicator of the DCI of the PDCCH or may be indicated by the MAC control information or may be indicated by an indicator of the RRC message. In the above case, when the state of the cell group is indicated as the active state, the UE may store configuration information of the cell group configured or indicated in the RRC message (e.g., RRCReconfiguration message, or RRCSetup message, or RRCResume message) and may apply the configuration information to the UE, or may recover or resume the configuration information of the cell group or may monitor the PDCCH according to the configuration of the RRC message in the configured SCell or the PCell or the PSCell of the cell group or may receive DL data or may perform channel measurement or measurement result reporting or may resume the configured periodic transport resource (e.g., type 1 periodic transport resource (configured uplink grant type 1)) or may configure or activate a configured periodic transport resource (e.g., type 2 periodic transport resource (configured uplink grant type 2)) or may transmit an SRS or may transmit UL data or may transmit the PUCCH (e.g., SR or preamble for random access) or may perform a random access procedure.

Also, in the above case, when the state of the cell group is indicated as the suspended state or the inactive state, the UE may store configuration information of the cell group configured or indicated in the RRC message (e.g., RRCReconfiguration message, or RRCSetup message, or RRCResume message), and may not discard the configuration information but may stop applying the configuration information, and may not monitor the PDCCH according to the configuration of the RRC message in the configured SCell or the PCell or the PSCell of the cell group or may perform PDCCH monitoring with a very long period or may not receive DL data or may perform channel measurement or measurement result reporting or may suspend the configured periodic transport resource (e.g., type 1 periodic transport resource (configured uplink grant type 1)) or may clear or initialize the configured periodic transport resource (e.g., type 2 periodic transport resource (configured uplink grant type 2)) or may transmit an SRS or may not transmit UL data or may transmit the PUCCH (e.g., SR or preamble for random access) or may perform a random access procedure.

Also, when the state of the cell group is indicated as the inactive state or when the release of cell group configuration information is indicated, the UE may release or discard the configuration information of the cell group configured or indicated in the RRC message (e.g., RRCReconfiguration message or RRCSetup message or RRCResume message).

FIG. 1E illustrates a diagram of a procedure of providing a service to a UE by efficiently using a very wide frequency bandwidth in a next-generation mobile communication system, according to an embodiment of the disclosure.

Referring to FIG. 1E, how a next-generation mobile communication system can efficiently use a very wide frequency bandwidth to provide services to UEs having different capabilities (or categories) and reduce power consumption will be described.

One cell served by a BS may serve a very wide frequency band as in 1e-05. However, in order to provide services to UEs having different capabilities, the BS may divide the wide frequency band into a plurality of BWPs and may manage the same as one cell.

First, a UE that is initially turned on may search an entire frequency band provided by a service provider (public land mobile network (PLMN)) in units of certain resource blocks (e.g., 12 resource blocks (RBs)). That is, the UE may start to monitor a primary synchronization sequence (PSS)/secondary synchronization sequence (SSS) in an entire system bandwidth in units of resource blocks (1e-10). When the UE detects signals of the PSS/SSS while monitoring the PSS/SSS in units of resource blocks (1e-01 or 1e-02), the UE may read and interpret (decode) the signals of the PSS/SSS to identify a boundary between a subframe and a radio transport resource frame (radio frame). Accordingly, the subframe may be distinguished in units of 1 ms, and the UE may synchronize a DL signal with the BS. In the case above, a resource block (RB) may be defined as a two-dimensional unit with a size of a certain frequency resource and a certain time resource. For example, the time resource may be defined in units of 1 ms and the frequency resource may be defined as 12 subcarriers (1 carrier×15 kHz=180 kHz). When synchronization is completed, the UE may identify control resource set (CORESET) information and initial access BWP information by identifying a master system information (MIB) or minimum system information (MSI) (1e-15 and 1e-20). The CORESET information refers to a position of a time/frequency transport resource in which a control signal is transmitted from the BS, and indicates, for example, a position of a resource in which a PDCCH is transmitted. That is, the CORESET information is information indicating where first system information (system information block 1 (SIB1)) is transmitted, and may indicate via which frequency/time resource the PDCCH is transmitted. In the above case, when the UE receives the first system information, the UE may identify information about an initial BWP. When the UE completes synchronization of a DL signal with the BS and may receive a control signal, the UE may perform a random access procedure in an initial BWP of a cell on which the UE camps, may request an RRC connection configuration, may receive an RRC message, and may perform an RRC connection configuration.

In the RRC connection configuration, a plurality of BWPs may be configured for one cell (Pcell, Pscell, Spcell, or Scell). In one cell, a plurality of BWPs may be configured for a DL, and a plurality of BWPs may be configured for a UL.

The plurality of BWPs may be indicated and configured by a BWP identifier to be used as an initial BWP or a default BWP or a first active BWP or a dormant BWP or a first active BWP activated from dormancy.

The initial BWP may be used as a cell-specific BWP existing for each cell, and may be used as a BWP in which the UE first accessing the cell can configure a connection to the cell via a random access procedure or the UE connected to the cell can perform synchronization. Also, the BS may configure, for each cell, an initial DL BWP to be used in the DL and an initial UL BWP to be used in the UL. Also, configuration information about the initial BWP may be broadcast in the first system information (system information 1 (SIB1)) indicated by the CORESET, and the BS may re-configure a connection for the accessed UE via an RRC message. Also, the initial BWP may be used by being designated as 0 of a BWP identifier in each of the UL and the DL. That is, all UEs accessing the same cell may use the equal initial BWP by designating the same as the equal BWP identifier #0. This is because, when a random access procedure is performed, the BS may transmit an RAR message in the initial BWP that may be read by all the UEs, and thus a CBRA procedure may be facilitated.

In the above case, the first active BWP may be differently configured for each UE (UE specific), and may be indicated by being designated by a BWP identifier from among a plurality of BWPs. The first active BWP may be configured for each of the DL and the UL, and a first active DL BWP and a first active UL BWP may be respectively configured as BWP identifiers. The first active BWP may be used to indicate which BWP is to be first activated and used when a plurality of BWPs are configured for one cell. For example, when a Pcell or a Pscell and a plurality of Scells are configured for the UE and a plurality of BWPs are configured for the Pcell or the Pscell or an Scell, if the Pcell or the Pscell or the Scell is activated, the UE may activate and use the first active BWP from among the plurality of BWPs configured for the Pcell or the Pscell or the Scell. That is, for the DL, the first active DL BWP may be activated and used, and for the UL, the first active UL BWP may be activated and used.

In the above case, an operation in which the UE activates the first active DL BWP (or BWP configured or indicated via the RRC message) by switching the current or activated DL BWP or in which the UE activates the first active UL BWP (or BWP configured or indicated via the RRC message) by switching the current or activated UL BWP may be performed when the UE receives an indication to activate the cell or the BWP in the inactive state via the RRC message or the MAC control information or the DCI. Also, the operation may be performed when the UE receives an indication to transition the cell or the BWP to the dormant state or an indication to activate the dormant BWP via the RRC message or the MAC control information or the DCI. This is because, when the cell or the BWP is activated, the first active DL BWP (or BWP configured or indicated via the RRC message) is to be activated by switching the current or activated DL BWP or the first active UL BWP (or BWP configured or indicated via the RRC message) is to be activated by switching the UL BWP, and thus even when channel measuring reporting is performed in the dormant state, the BS may effectively use carrier aggregation only when a frequency/channel should be measured and reported for the first active DL/UL BWP. In the above case, the default BWP may be differently configured for each UE (UE specific), and may be indicated by being designated by a BWP identifier from among a plurality of BWPs. The default BWP may be configured only for the DL. The default BWP may be used as a BWP to which an activated BWP from among a plurality of DL BWPs is to fall back after a certain time. For example, a BWP inactivity timer may be configured for each cell or each BWP via an RRC message, and the BWP inactivity timer may start or re-start when data transmission/reception occurs in the activated BWP other than the default BWP, or may start or re-start when the activated BWP is switched to another BWP. When the BWP inactivity timer expires, the UE may fall back or switch the activated DL BWP to the default bandwidth in the cell. In the above case, switching may refer to a procedure of deactivating a currently activated BWP and activating a BWP for which the switching is indicated, and the switching may be triggered via an RRC message or MAC control information (MAC CE) or L1 signaling (DCI of the PDCCH). In the above case, the switching may be triggered by an indication of the BWP to be switched or activated, and the BWP may be indicated by a BWP identifier (e.g., 0 or 1 or 2 or 3 or 4).

The reason why the default BWP is applied and used only for the DL is that the UE is indicated by the BS to fall back to the default BWP after a certain time for each cell (e.g., DCI of the PDCCH), and thus BS scheduling is facilitated. For example, when the BS configures the default BWP of UEs accessing one cell as the initial BWP, the BS may continuously perform a scheduling indication only in the initial BWP after a certain time. When the default BWP is not configured in the RRC message, the initial BWP may be considered as the default BWP and the UE may fall back to the initial BWP when the BWP inactivity timer expires.

In another method, in order to increase an implementation degree of freedom of the BS, a default BWP may also be defined and configured for the UL and may be used like the default BWP of the DL.

In the above case, the dormant BWP refers to a BWP that is in a dormant mode of an activated cell or a dormant BWP (dormant BWP in activated SCell) or when the dormant BWP is activated, the UE may not transmit and receive data to and from the BS or may not monitor the PDCCH to indicate an indication by the BS or may not transmit a pilot signal but may perform channel measurement and may report a measured frequency/cell/channel measurement result according to the BS configuration periodically or when an event occurs. Accordingly, because the UE does not monitor the PDCCH and does not transmit a pilot signal in the dormant BWP of the activated cell, power consumption may be reduced compared to a normal BWP of the activated cell (or BWP other than the dormant BWP) or compared to when the normal BWP of the activated cell (or BWP other than the dormant BWP) is activated, and unlike when the cell is deactivated, because the UE performs channel measurement reporting, the BS may rapidly activate the normal BWP of the activated cell based on a measurement report or a measurement report of the dormant BWP of the activated cell, such that rapid use of carrier aggregation is possible and thus transmission latency may be decreased.

When the UE operates a BWP of one activated cell as a dormant BWP or when an activated BWP in an activated cell is a dormant BWP or when it is switched to a dormant BWP in a cell or when the BS indicates the UE to switch the BWP of the activated cell from the dormant BWP to the normal BWP (or BWP other than the dormant BWP) via the DCI of the PDCCH or the MAC CE or the RRC message or when the BS indicates to switch or transition the active BWP from the dormant BWP to the normal BWP or when the BS indicates to switch or transition or activate the active BWP from the dormant BWP to the normal BWP (e.g., first active BWP activated from dormancy), the first active BWP switched and activated from the dormant state or from the dormant BWP (or first active non-dormant BWP or BWP configured or indicated via the RRC message) may be a BWP to be activated by switching the current or activated BWP of the activated cell by the UE according to the indication or a BWP to be activated from the dormant state configured in the RRC message.

FIG. 1F illustrates a procedure by which a UE transitions from an RRC idle mode to an RRC connected mode in a next-generation wireless communication system of the disclosure, in which a method of configuring a plurality of BWPs and configuring a default BWP or a first active BWP or a dormant BWP will now be proposed.

One cell served by a BS may serve a very wide frequency band. First, the UE may search an entire frequency band provided by a service provider (PLMN) in units of certain resource blocks (e.g., 12 resource blocks (RBs)). That is, the UE may start to monitor a PSS/SSS in an entire system bandwidth in units of resource blocks. When the UE detects signals of the PSS/SSS while monitoring the PSS/SSS in units of resource blocks, the UE may read and interpret (decode) the signals of the PSS/SSS to identify a boundary between a subframe and a radio transport resource frame (radio frame). When synchronization is completed, the UE may read system information of a cell on which the UE currently camps. That is, the UE may identify CORESET information by identifying a MIB or MSI and may identify initial BWP information by reading the system information (1f-01 and 1f-05). In the above case, the CORESET information refers to a position of a time/frequency transport resource in which a control signal is transmitted from the BS, and may indicate, for example, a position of a resource in which a PDCCH is transmitted.

When the UE completes synchronization of a DL signal with the BS and is able to receive a control signal, the UE may perform a random access procedure in an initial BWP, may receive an RAR, may request an RRC connection configuration, may receive an RRC message, and thus, may perform an RRC connection configuration (1f-10, if-15, 1f-20, 1f-25, and 1f-30).

In the above case, when a basic RRC connection configuration is completed, the BS may transmit an RRC message asking a capability of the UE so as to identify a UE capability (UECapabilityEnquiry) (1f-35). In another method, the BS may ask an MME or an access and mobility management function (AMF) about a capability of the UE so as to identify a UE capability. This is because, if the UE previously accessed the BS, the MME or the AMF may have stored capability information of the UE. When the BS does not store desired UE capability information, the BS may request the UE for a UE capability. In the above case, when the UE reports a UE capability, the UE may report, to the BS, as a UE capability, whether the UE supports a dormant BWP for an SCell of each cell group (MCG or SCG) or whether the UE supports Embodiment 1, Embodiment 2, Embodiment 3, or Embodiment 4 of the disclosure or whether the UE supports a dormant BWP for a PSCell of each cell group or whether the UE supports a cell group suspension or resume procedure for a PSCell of each cell group or the number of supported cell groups. Also, in the above case, the UE may report, to the BS, as a UE capability via an RRCResume message in an RRC connection resume procedure, whether the UE is able to store and recover configuration information of the SCell of the MCG or the SCell of the SCG or the PSCell of the SCG or whether the UE is able to discard the configuration information or whether the UE is able to re-configure part of the configuration information or whether the UE is able to activate the configuration information.

The reason why the BS transmits an RRC message to the UE so as to identify a capability of the UE is to identify a capability of the UE, for example, how much frequency band the UE is able to monitor or a region of the frequency band that may be monitored by the UE. After the BS identifies the capability of the UE, the BS may configure an appropriate BWP for the UE. When the UE receives the RRC message asking the capability of the UE, the UE may indicate, as a response thereto, a range of a bandwidth supported by the UE or to which extent the bandwidth is supported in the current system bandwidth by an offset from a reference center frequency, or to directly indicate a start point and an end point of the supported frequency bandwidth, or to indicate the same by the center frequency and the bandwidth (1f-40).

In the above case, the BWP may be configured via an RRCSetup message or an RRCResume message of the RRC connection configuration (1f-25) or an RRCReconfiguration message (1f-45 and 1f-70), and the RRC message may include configuration information of a PCell or a Pscell or a plurality of cells, and a plurality of BWPs may be configured for each cell (PCell or Pscell or Scell). When the plurality of BWPs are configured for each cell, a plurality of BWPs to be used in the DL of each cell may be configured, and in a case of a frequency division duplex (FDD) system, a plurality of BWPs to be used in the UL of each cell may be configured separately from DL BWPs. In a case of a time division duplex (TDD) system, a plurality of BWPs to be commonly used in the DL and the UL of each cell may be configured.

Information for configuring a BWP of each cell (PCell or Pscell or Scell) may include some of a plurality of pieces of information below.
DL BWP configuration information of the cell.
   Initial DL BWP configuration information.
   A plurality of pieces BWP configuration information and BWP identifiers (IDs) respectively corresponding to BWPs.
   Initial state configuration information of the cell or DL BWP (e.g., active state or dormant state or inactive state).
   BWP identifier indicating first active DL BWP.
   BWP identifier indicating default BWP.
   Configuration information for PDCCH monitoring for each BWP. For example, CORESET information or search space resource information or PDCCH transport resource, period, subframe number information, or the like.
   BWP identifier indicating dormant BWP.
   BWP identifier indicating first active BWP activated from dormancy.
   BWP inactivity timer configuration and timer value.
UL BWP configuration information of cell.
   Initial UL BWP configuration information.
   A plurality of pieces of BWP configuration information and BWP IDs respectively corresponding to BWPs.
   Initial state configuration information of the cell or DL BWP (e.g., active state or dormant state or inactive state).
   BWP identifier indicating first active UL BWP.
Configuration information about transport resource for performing channel measurement and reporting a measurement result in dormant BWP or BWP other than dormant BWP (e.g., PUCCH transport resource information of PCell or PUCCH SCell or PSCell).

In the above case, the configured initial BWP or default BWP or first active BWP may be used for the following purposes, and may operate as below according to the purposes.

The initial BWP may be used as a cell-specific BWP existing for each cell, and may be used as a BWP in which the UE first accessing the cell can configure a connection to the cell via a random access procedure or the UE connected to the cell can perform synchronization. Also, the BS may configure, for reach cell, an initial DL BWP to be used in the DL and an initial UL BWP to be used in the UL. Also, configuration information about the initial BWP may be broadcast in the first system information (system information 1 (SIB1)) indicated by the CORESET, and the BS may re-configure a connection for the accessed UE via an RRC message. Also, the initial BWP may be used by being designated as 0 of a BWP identifier in each of the UL and the DL. That is, all UEs accessing the same cell may use the equal initial BWP by designating the same as the equal BWP identifier #0. This is because, when a random access procedure is performed, the BS may transmit an RAR message in the initial BWP that may be read by all the UEs, and thus a CBRA procedure may be facilitated.

In the above case, the first active BWP may be differently configured for each UE (UE specific), and may be indicated by being designated by a BWP identifier from among a plurality of BWPs. The first active BWP may be configured for each of the DL and the UL, and a first active DL BWP and a first active UL BWP may be respectively configured as BWP identifiers. The first active BWP may be used to indicate which BWP is to be first activated and used when a plurality of BWPs are configured for one cell. For example, when a Pcell or a Pscell and a plurality of Scells are configured for the UE and a plurality of BWPs are configured for the Pcell or the Pscell or an Scell, if the Pcell or the Pscell or the Scell is activated, the UE may activate and use the first active BWP from among the plurality of BWPs configured for the Pcell or the Pscell or the Scell. That is, for the DL, the first active DL BWP may be activated and used, and for the UL, the first active UL BWP may be activated and used.

An operation in which the UE activates the first active DL BWP (or BWP configured or indicated via the RRC message) by switching the current or activated DL BWP or in which the UE activates the first active UL BWP (or BWP configured or indicated via the RRC message) by switching the current or activated UL BWP may be performed when the UE receives an indication to activate a cell or a BWP of an activated cell in an inactive state or a dormant state or an indication to switch from an inactive or dormant BWP to a normal BWP or an indication to activate an inactive or dormant BWP via the RRC message or the MAC control information or the DCI of the PDCCH. Also, when the UE receives an indication to transition an activated cell or BWP to a dormant state or an indication to switch to a dormant BWP or an indication to activate a dormant BWP via the RRC message or the MAC control information or the DCI of the PDCCH, the UE may switch or activate the BWP to the dormant BWP or may hibernate the BWP.

In the above case, switching to the dormancy or the dormant BWP or activation of the dormant BWP may refer to performing, in the dormant state, an operation proposed in the disclosure. That is, without performing PDCCH monitoring, the UE may perform an operation of measuring a channel on a DL BWP (or dormant BWP) and reporting a result to the BS. In another method, when the activated cell or BWP is activated or switched to the normal BWP, because the first active DL BWP is to be activated by switching the DL BWP and the first active UL BWP is to be activated by switching the UL BWP, the dormant BWP may be configured as the first active DL or UL BWP or the default BWP. In the above case, the default BWP may be differently configured for each UE (UE specific), and may be indicated by being designated by a BWP identifier from among a plurality of BWPs. The default BWP may be configured only for the DL. The default BWP may be used as a BWP to which an activated BWP from among a plurality of DL BWPs is to fall back after a certain time. For example, a BWP inactivity timer may be configured for each cell or each BWP through an RRC message, and may start or re-start when data transmission and reception occurs in the activated BWP other than the default BWP or may start or re-start when the activated BWP is switched to another BWP. When the BWP inactivity timer expires, the UE may fall back or switch the activated DL BWP to the default bandwidth in the cell. In the above case, switching may refer to a procedure of deactivating a currently activated BWP and activating a BWP for which the switching is indicated, and the switching may be triggered via an RRC message or MAC control information (MAC CE) or L1 signaling (DCI of the PDCCH). In the above case, switching may be triggered in response to an indication of the BWP to be switched or activated, and the BWP may be indicated by a BWP identifier (e.g., 0 or 1 or 2 or 3 or 4).

The reason why the default BWP is applied and used only for the DL is that the UE is indicated by the BS to fall back to the default BWP after a certain time for each cell (e.g., DCI of the PDCCH), and thus BS scheduling is facilitated. For example, when the BS configures the default BWP of UEs accessing one cell as the initial BWP, the BS may continuously perform a scheduling indication only in the initial BWP after a certain time. When the default BWP is not configured in the RRC message, the initial BWP may be considered as the default BWP and thus the UE may fall back to the initial BWP when the BWP inactivity timer expires.

In another method, in order to increase an implementation degree of freedom of the BS, a default BWP may also be defined and configured for the UL and may be used like the default BWP of the DL.

In the above case, the dormant BWP refers to a BWP that is in a dormant mode of an activated cell or a dormant BWP (dormant BWP in activated SCell) or when the dormant BWP is activated, the UE may not transmit and receive data to and from the BS or may not monitor the PDCCH to detect an indication by the BS or may not transmit a pilot signal but may perform channel measurement and may report a measured frequency/cell/channel measurement result according to the BS configuration periodically or when an event occurs. Accordingly, because the UE does not monitor the PDCCH and does not transmit a pilot signal in the dormant BWP of the activated cell, power consumption may be reduced compared to a normal BWP of the activated cell (or BWP other than the dormant BWP) or compared to when the normal BWP of the activated cell (or BWP other than the dormant BWP) is activated, and unlike when the cell is deactivated, because the UE performs channel measurement reporting, the BS may rapidly activate the normal BWP of the activated cell based on a measurement report or a measurement report of the dormant BWP of the activated cell, such that rapid use of carrier aggregation is possible and thus transmission latency may be decreased.

When the UE operates a BWP of one activated cell as a dormant BWP or when an activated BWP in an activated cell is a dormant BWP or when it is switched to a dormant BWP in a cell or when the BS indicates to switch the BWP of the activated cell from the dormant BWP to the normal BWP (or BWP other than the dormant BWP) via the DCI of the PDCCH or the MAC CE or the RRC message or when the BS indicates to switch or transition the active BWP from the dormant BWP to the normal BWP or when the BS indicates to switch, transition, or activate the active BWP from the dormant BWP to the normal BWP (e.g., first active BWP activated from dormancy), the first active BWP activated from dormancy (or first active non-dormant BWP) may be a BWP to be switched from the BWP of the activated cell by the UE according to the indication or a first active BWP activated from dormancy configured in the RRC message.

In the disclosure, when a first BWP is switched to a second BWP, it may be interpreted that the second BWP is activated, or the activated first BWP is deactivated and the second BWP is activated.

Also, in the above case, in the RRCSetup message or the RRCResume message of the RRC connection configuration (1f-25) or the RRCReconfiguration message (1f-45), a state transition timer may be configured so that the UE itself may perform state transition even without receiving an indication from the BS via the RRC message or the MAC control information or the DCI of the PDCCH. For example, the UE may configure a cell deactivation timer (ScellDeactivationTimer) for each cell, and when the cell deactivation timer expires, the UE may transition a state of the cell to the inactive state. Alternatively, the UE may configure a DL (or UL) BWP hibernation timer (DLBWPHibernationTimer or ULBWPHibernationTimer) for each cell or each BWP of each cell or may configure a cell hibernation timer (ScellHibernationTimer) for each cell, and when the cell hibernation timer or the DL (or UL) BWP hibernation timer expires, the UE may transition or switch the cell or the DL (or UL) BWP to the dormant state or the dormant BWP. For example, when the cell hibernation timer or the DL (or UL) BWP hibernation timer expires, the UE may transition or switch the activated cell or DL (UL) BWP to the dormant state or the dormant BWP, and may allow the deactivated or hibernated cell or DL (or UL) BWP not to be transitioned to the dormant state or the dormant BWP. Also, the UE may start the BWP hibernation timer when receiving an indication to switch or activate the BWP via the RRC message or the MAC CE or the DCI of the PDCCH, or may stop when receiving an indication to switch to the dormant BWP or an indication to hibernate or an indication to activate the dormant BWP via the RRC message or the MAC CE or the DCI of the PDCCH. Also, the UE may configure, for each cell or DL (or UL) BWP, a dormant cell deactivation timer (dormantScellDeactivationTimer) or a dormant state or DL (or UL) dormant BWP deactivation timer (dormantDLDeactivationTimer or dormantULDeactivationTimer), and thus, may transition the dormant cell or DL (or UL) dormant BWP to the inactive state. When the dormant cell deactivation timer or the dormant state or DL (or UL) dormant BWP deactivation timer expires, the UE may transition only the dormant cell or DL (or UL) dormant BWP to the inactive state, and may not transition the active or inactive cell or DL (or UL) BWP to the inactive state. Also, the UE may start the dormant BWP hibernation timer when receiving an indication to switch the dormant BWP or an indication to hibernate or an indication to activate the dormant BWP via the RRC message or the MAC CE or the DCI of the PDCCH, or may stop when receiving an indication to deactivate or activate the BWP or the cell or an indication to activate the normal BWP (e.g., BWP other than the dormant BWP configured by the RRC) via the RRC message or the MAC CE or the DCI of the PDCCH. When the cell deactivation timer (ScellDeactivationTimer) (or DL (or UL) BWP hibernation timer) and the cell hibernation timer (ScellHibernationTimer) (or DL (or UL) dormant BWP deactivation timer) are configured together, the cell hibernation timer (ScellHibernationTimer) (or DL (or UL) dormant BWP hibernation timer) may be prioritized That is, when the cell hibernation timer (ScellHibernationTimer) (or DL (or UL) BWP hibernation timer) is configured, even when the cell deactivation timer (ScellDeactivationTimer) (or DL (or UL) dormant BWP deactivation timer) expires, the cell or DL (or UL) BWP may not be deactivated. In other words, when the cell hibernation timer (or DL (or UL) BWP hibernation timer) is configured, the cell or DL (or UL) BWP may be first transitioned from the active state to the dormant state or switched to the dormant BWP due to the expiration of the timer, and the dormant cell or the cell or BWP transitioned to the dormant state due to the expiration of the BWP deactivation timer may be stepwise transitioned back to the inactive state. Accordingly, when the cell hibernation timer or the BWP hibernation timer is configured, the cell deactivation timer or the dormant BWP deactivation timer may not affect the cell or DL (or UL) BWP state transition, and even when the cell deactivation timer or the dormant BWP deactivation timer expires, when the cell hibernation timer or the BWP hibernation timer is configured, the cell or DL (or UL) BWP may not be directly transitioned to the inactive state.

When the cell deactivation timer (or DL (or UL) BWP hibernation timer) is not configured in the RRC message, the UE may consider that the cell deactivation timer (or DL (or UL) BWP hibernation timer) is set to an infinite value.

In the RRCSetup message of the RRC connection configuration or the RRCResume message (1f-25) or the RRCReconfiguration message (1f-45, 1f-70, and 1f-85), frequency measurement configuration information and frequency measurement gap configuration information may be configured, and a frequency measurement object information may be included. In the RRCSetup message of the RRC connection configuration or the RRCResume message (1f-25) or the RRCReconfiguration message (1f-45), a function for reducing power consumption of the UE (power saving mode) may be configured, and also, along with the function for reducing power consumption, configuration information such as discontinuous reception (DRX) cycle or offset or on-duration period (duration in which the terminal should monitor the PDCCH) or time information or short time period information or time information indicating when to monitor or detect the PDCCH from the BS before the on-duration period in the DRX cycle may be configured. When the function for reducing power consumption of the UE is configured in the RRC message, the UE may configure a DRX cycle, and may detect a wake-up signal (WUS) in duration configured to monitor the PDCCH of the BS before the on-duration period, and the BS may indicate to the UE whether to skip (or not to perform) or perform PDCCH monitoring in an immediately next on-duration period via the DCI of the PDCCH of the WUS. The UE should always monitor the PDCCH in the on-duration period, and, however, when the BS indicates the UE not to perform PDCCH monitoring in the on-duration period by using the WUS, power consumption of the UE may be reduced.

When the RRC connection configuration is completed, the UE may configure a plurality of BWPs according to an indication configured in the RRC message. In order to reduce power consumption, one or a small number of BWPs from among the configured plurality of BWPs may be activated. For example, the BS may indicate one BWP to be activated. The BS may indicate activation of the BWP via an RRC message or MAC control information (MAC CE) or L1 signaling (PHY layer control signaling such as DCI of the PDCCH), to indicate switching from an initial access BWP to a new BWP. In another method, new bitmap information may be defined in the DCI of the PDCCH, and whether to activate the normal BWP (or BWP other than the dormant BWP) or activate the dormant BWP or deactivate the BWP may be indicated by the new bitmap information. In another method, whether to activate the normal BWP (e.g., first active BWP to be activated from dormancy) or activate the dormant BWP or switch to the dormant BWP or perform BWP switching may be indicated by the bitmap. Because there may be many newly connected users in the initial access BWP, it may be more advantageous to allocate a new BWP and separately manage the connected users in terms of scheduling. This is because the initial access BWP is not configured for each UE, but may be commonly shared and used by all the UEs. In order to reduce signaling overhead, the default BWP may be dynamically indicated via the MAC control information or the L1 signaling or the system information.

In the RRC message (the RRCSetup message or the RRCResume (1f-25) or the RRCReconfiguration message (1f-70)), configuration information for a cell group may be included. The configuration information for the cell group may include some of a plurality of pieces information below, and may indicate, for the cell group, a state or procedure or configuration information application or release for each cell group.
Cell group identifier indicating cell group (e.g., cell group identifier or index).
Indicator indicating state of cell group (e.g., active state or suspended state or inactive state).
Indicator indicating state of cell group (e.g., indicator to suspend (or deactivate) cell group (e.g., cellgroup (SCG) suspension indicator) or indicator to resume cell group (e.g., Cellgroup (SCG) resumption indicator)).
Indicator (e.g., PDCP reestablishment indicator or PDCP data recovery indicator or indicator triggering new procedure or RLC reestablishment indicator or MAC layer reset indicator or MAC layer partial reset indicator) triggering procedure of corresponding protocol layer (e.g., SDAP layer or PDCP layer or RLC layer or MAC layer) according to indicator indicating state of cell group.
When an indicator to suspend (or deactivate) the state of the cell group is included, second DRX configuration information (e.g., monitoring interval or active period (on-duration) length or period or offset) may be configured to perform PDCCH monitoring with a very long period in the PSCell of the cell group. For example, when the UE receives an indicator to suspend the cell group, the UE may perform PDCCH monitoring with a very long period by applying the second DRX configuration information, thereby reducing power consumption of the UE. In another method, when the UE receives an indicator to suspend the cell group, the UE may activate or switch the DL BWP to the dormant BWP of the PSCell of the cell group by applying BWP configuration information of the PSCell of the cell group, and may perform a UE operation in the cell in which the dormant BWP is activated according to the disclosure. Also, when the UE receives an indicator to suspend the cell group, the UE may deactivate all SCells configured in the cell group. In another method, when the UE receives an indicator to suspend the cell group, the UE may activate or switch the DL BWP to the dormant BWP for the SCell in which the dormant BWP is configured from among SCells configured in the cell group, and may perform a UE operation in the cell in which the dormant BWP is activated according to the disclosure, or may deactivate the SCell in which the dormant BWP is not configured. In another method, when the UE receives an indicator to suspend the cell group in the RRC message, the UE may perform activation, deactivation, hibernation, or dormant BWP activation on each SCell according to an indicator or configuration information for each SCell of the cell group included in the RRC message, or, alternatively, before or after the UE receives an indictor to suspend the cell group, the UE may perform activation or deactivation or hibernation or dormant BWP activation on each SCell of the cell group via the indicator (e.g., bitmap) of the PDCCH or the MAC control information or the RRC message.
Configuration information about transport resource for performing channel measurement and reporting a measurement result in dormant BWP or BWP other than dormant BWP (e.g., PUCCH transport resource information of PCell or PUCCH SCell or PSCell).
When an indicator to resume (or activate) the state of the cell group is included, first DRX configuration information (e.g., monitoring duration or active period (on-duration) length or period or offset) may be configured to re-perform PDCCH monitoring in the PSCell of the cell group. Alternatively, the UE may recover and apply the first DRX configuration information that is stored for the cell group. For example, when the UE receives an indicator to resume the cell group, the UE may perform PDCCH monitoring by applying the first DRX configuration information that is received from the RRC message or that is stored to resume data transmission or reception. In another method, when the UE receives an indicator to resume the cell group, the UE may activate or switch the DL BWP of the PSCell of the cell group to the BWP other than the dormant BWP (e.g., BWP configured in the RRC message) by applying BWP configuration information of the PSCell of the cell group, and may perform a UE operation in the cell in which the normal BWP (BWP other than the dormant BWP) is activated according to the disclosure. Alternatively, when the UE receives an indicator to resume the cell group, the UE may trigger a random access procedure in the PSCell of the cell group by applying random access configuration information that is received from the RRC message or that is stored (random access transport resource information for preamble transmission (time or frequency transport resource) or designated preamble information). In another method, when the UE receives an indicator to resume the cell group, if random access configuration information (random access transport resource information for preamble transmission (time or frequency transport resource) or designated preamble information) is included in the RRC message, the UE may trigger a random access procedure (e.g., CFRA procedure) in the PSCell of the cell group by applying the random access configuration information, and when random access configuration information (random access transport resource information for preamble transmission (time or frequency transport resource) or designated preamble information) is not included in the RRC message indicating to resume or activate the cell group, the UE may trigger a random access procedure (e.g., CBRA procedure) in the PSCell of the cell group, or may trigger a random access procedure based on system information (CBRA or 2-step random access). When there is random access configuration information (random access transport resource information for preamble transmission (time or frequency transport resource) or designated preamble information) that is stored in the UE before an indicator to resume the cell group is received, the UE may release or discard the random access configuration information. In another method, the UE may perform PDCCH monitoring in the indicated or configured cell group or cell, and may trigger and perform a random access procedure according to an indication indicated in the PDCCH.
When an indicator to resume (or activate) the state of the cell group is included or when the UE receives an indicator to resume the cell group, the UE may activate all SCells configured in the cell group. In another method, when the UE receives an indicator to resume the cell group, the UE may activate or switch the DL BWP to the BWP other than the dormant BWP (e.g., BWP configured in the RRC message or the first active BWP) for the SCell in which the dormant BWP is configured from among SCells configured in the cell group, and may perform a terminal operation in the cell in which the BWP other than the dormant BWP is activated according to the disclosure or may activate the SCell in which the dormant BWP is not configured. In another method, when the UE receives an indicator to resume the cell group in the RRC message, the UE may perform activation or deactivation or hibernation or dormant BWP activation on each SCell according to an indicator or configuration information for each SCell of the cell group included in the RRC message, and alternatively, before or after the UE receives an indicator to resume the cell group, the UE may perform activation or deactivation or hibernation or dormant BWP activation on each SCell of the cell group via the indicator (e.g., bitmap) of the PDCCH or the MAC control information or the RRC message.
Indicator adding cell group configuration.
Indicator releasing cell group configuration.
Security configuration information (security key information or security information for cell group or additional information (e.g., sk-counter)).
Indicator indicating handover or cell group addition or cell group modification (e.g., ReconfigurationWithSync indicator or mobilitycontrolInfo indicator).
First channel measurement configuration information or second channel measurement configuration information for rapid activation of cell group or cell.
It is proposed that, when the RRC message (e.g., RRCReconfiguration message) includes an indicator for suspending the cell group, an indicator indicating handover or cell group addition or cell group modification (e.g., ReconfigurationWithSync indicator or mobilitycontrolInfo indicator) may not be included, and when the RRC message includes an indicator for resuming the cell group or configuration information for configuration, an indicator indicating handover or cell group addition or cell group modification (e.g., ReconfigurationWithSync indicator or mobilitycontrolInfo indicator) may be included. This is because, when the cell group is resumed, a connection to the cell group should be re-performed, and thus synchronization should be performed or system information should be received, or a random access procedure should be performed when necessary.

In the disclosure, hereinafter, a dormant BWP in a next-generation mobile communication system is newly proposed, and a UE operation in each BWP when each BWP is transitioned or switched will now be proposed in detail.

A state transition for each bandwidth or a BWP switching procedure which is proposed in the disclosure will now be described.

In the above case, a BWP of each cell (e.g., SCell or PSCell) of each cell group of a UE may be activated to a normal BWP or may be activated to a dormant BWP or may be deactivated, and the UE may activate or deactivate the normal BWP or the dormant BWP in response to an indication according to configuration information of an RRC message or MAC control information or DCI of a PDCCH.

According to the disclosure, a state transition operation (activation or deactivation or hibernation) for each BWP of the cell or an operation of activating the normal BWP or activating the dormant BWP or activating the first active BWP activated from dormancy or deactivating the normal BWP or the dormant BWP may be performed in response to an indication or configuration in one of the following cases.
When the BWP state of the cell is configured via the RRC message, or when the BWP of each cell is configured via the RRC message and the dormant BWP is configured in the cell, or when the first active BWP is configured as the dormant BWP, the UE may start the cell by switching the cell to the dormant BWP or activating the dormant BWP and may perform an operation in the dormant BWP.
When the cell activation or deactivation or hibernation MAC CE is received.
When the MAC CE indicating to activate or deactivate the normal BWP or the first active BWP activated from dormancy or the dormant BWP is received.
When the DCI of the PDCCH indicating to activate or deactivate the normal BWP or the first active BWP activated from dormancy or the dormant BWP is received.
When a cell hibernation timer is not configured in the active cell and a configured cell deactivation timer expires.
When the BWP hibernation timer is not configured in the active BWP and a configured BWP state deactivation timer (e.g., bwpInactivityTimer) expires.

Also, a state transition operation or a dormant BWP operation method according to the disclosure may have the following characteristics.
The dormant BWP cannot be configured in the Spcell (Pcell or Pscell) (or DL BWP or UL BWP of the cell), and only the normal BWP may be configured and may always be activated. As the Spcell synchronizes and transmits and receives a primary control signal, the Spcell should always be maintained in the active state because a connection with a BS is disconnected when the BWP of the Spcell is hibernated or deactivated or is operated as the dormant BWP.
When a PUCCH is configured for the Scell or for the BWP of the Scell, the dormant state or the dormant BWP may not be configured. In this case, because there may be another cell to which a feedback such as HARQ ACK/NACK should be transmitted via the PUCCH, the active state or the normal BWP should be activated and used.
Due to such characteristics, the cell deactivation timer (ScellDeactivationTimer) or the BWP hibernation timer may not be applied to the Spcell or the BWP of the Spcell and the Scell or the BWP of the SCell for which the PUCCH is configured, and may run only for other SCells.
The cell or BWP hibernation timer (ScellHibernationTimer) may be prioritized over the cell or BWP state deactivation timer (ScellDeactivationTimer). When one value is set via the RRC message as a timer value, the same value may be applied to all the cells. In another method, the BS may set a different timer value for each SCell or each BWP by considering characteristics of each cell or characteristics of each BWP.
The cell or the BWP may basically operate in the inactive state initially when it is not indicated as active or dormant in the RRC message.

In the disclosure, a UL may indicate the UL BWP, and a DL may indicate the DL BWP. This is because only one activated or hibernated BWP may operate for each UL or each DL.

In the disclosure, hereinafter, a method of operating state transition or switching in units of BWPs (BWP level) to rapidly activate carrier aggregation or dual connectivity and reduce power consumption of a UE which is disclosed above will now be particularly proposed.

In the disclosure, the BWP may be configured for each cell in the RRCSetup message or the RRCReconfiguration message or the RRCResume message as described with reference to FIG. 1F. The RRC message may include configuration information about a PCell or a Pscell or a plurality of Scells, and a plurality of BWPs may be configured for each cell (PCell or Pscell or Scell). When the plurality of BWPs are configured for each cell in the RRC message, a plurality of BWPs to be used in the DL of each cell may be configured, and in a case of an FDD system, a plurality of BWPs to be used in the UL of each cell may be configured separately from the DL BWPs. In a case of a time division duplex (TDD) system, a plurality of BWPs to be commonly used in the DL and the UL of each cell may be configured.

According to a first method of an information configuration method for BWP configuration of each cell (PCell or Pscell or Scell), BWP configuration information may include one or more of the following information, and a new indicator may be introduced in the BWP to indicate whether each BWP is the normal BWP (e.g., BWP that may operate or may be configured in the active state or the inactive state) or the dormant BWP (e.g., BWP that may operate or may be configured in the dormant state). For example, whether each BWP is the dormant BWP may be indicated by a BWP identifier.
DL BWP configuration information of each cell.
   Initial DL BWP configuration information.
   A plurality of pieces of BWP configuration information and BWP identifier (ID) corresponding to each BWP.
   DL initial state configuration information of the cell (e.g., active state or dormant state or inactive state).
   BWP identifier indicating first active DL BWP.
   BWP identifier indicating default BWP.
   BWP identifier indicating dormant BWP or 1-bit indicator indicating dormant BWP for each BWP in BWP configuration information.
   When the first active DL BWP is configured as the dormant BWP, the first active UL BWP may also have to be configured as the dormant BWP.
   BWP inactivity timer configuration and timer value.
   BWP identifier that is first activated from dormant BWP.
UL BWP configuration information of each cell.
   Initial UL BWP configuration information.
   A plurality of pieces of BWP configuration information and BWP identifier (ID) corresponding to each BWP.
   UL initial state configuration information of the cell (e.g., active state or dormant state or inactive state).
   BWP identifier indicating first active UL BWP.
   BWP identifier indicating dormant BWP or 1-bit indicator indicating dormant BWP for each BWP in BWP configuration information.
   When the first active DL BWP is configured as the dormant BWP, the first active UL BWP may also have to be configured as the dormant BWP.
   BWP identifier that is first activated from dormant BWP.
   SRS-related configuration information may be configured by using the following methods.
Embodiment 1 of configuring SRS.
   First SRS configuration information (SRS configuration information for the BWP other than the normal BWP or the dormant BWP or the PSCell (or SCell) of the cell group for which the cell group is not suspended or the PSCell (or SCell) of the cell group for which the cell group is resumed or activated or the BWP (e.g., indicator indicating whether it is SRS configuration information for SRS transport resource or period or offset or dormant BWP)).
   Second SRS configuration information (SRS configuration information for the dormant BWP or the PSCell (or SCell) of the cell group for which the cell group is suspended or deactivated or the PSCell (or SCell) of the cell group for which the cell group is not resumed or the BWP (e.g., indicator indicating whether it is SRS configuration information for SRS transport resource or period or offset or dormant BWP)).
   In the above case, the first SRS configuration information and the second SRS configuration information may be distinguished based on an indicator indicating whether it is SRS configuration information for the dormant BWP or the PSCell (or SCell) of the cell group for which the cell group is suspended or deactivated. For example, the first SRS configuration information and the second SRS configuration information may be distinguished according to an indicator value or may be distinguished according to whether an indicator value is configured or not or may be distinguished whether there is or is not an indicator value. In another method, the first SRS configuration information and the second SRS configuration may be distinguished by differently defining their names.
   In Embodiment 1 of the disclosure, when the dormant BWP (e.g., dormant BWP identifier in DL BWP configuration information) is configured in a serving cell (PSCell or SCell) or when sell group suspension is indicated or supported or configured, the second SRS configuration information may always be configured. Alternatively, when the dormant BWP (e.g., dormant BWP identifier in the DL BWP configuration information) is configured in the serving cell (PSCell or SCell) or when cell group suspension is indicated or supported or configured, an indicator indicating whether it is the first SRS configuration information or the second SRS configuration information may be configured. For example, when the dormant BWP identifier is configured in the DL BWP configuration information or when cell group suspension is indicated or supported or configured, the second SRS configuration information may be configured in each UL BWP configuration information. For example, when the dormant BWP identifier is configured in the DL BWP configuration information or when cell group suspension is indicated or supported or configured, the second SRS configuration information may be configured in the UL BWP configuration information for the UL BWP or the UL BWP having the same BWP identifier as the DL dormant BWP. In another method, in a case of TDD or an unpaired spectrum, when a dormant BWP identifier is configured in the DL BWP configuration information, the second SRS configuration information may be configured in the UL BWP configuration information for the UL BWP or the UL BWP having the same BWP identifier as the DL dormant BWP.
   For example, in Embodiment 1 of the disclosure, when the DL BWP is switched or activated to the BWP (or normal BWP) other than the dormant BWP for the activated cell or when cell group suspension is not indicated or when the cell group is in the active state or when cell group resumption is indicated, the UE may apply the first SRS configuration information in the UL BWP of the activated cell (Scell or PSCell), and may transmit an SRS based on an SRS transport resource or a period or an offset corresponding to the first SRS configuration information. When the DL BWP is switched or activated to the dormant BWP for the activated cell or when cell group suspension is indicated or when the cell group is not in the active state (or is in the inactive or suspended state), the UE may apply the second SRS configuration information in the UL BWP of the cell (PSCell or SCell) of the suspended or deactivated cell group, and may transmit an SRS based on an SRS transport resource a period or an offset corresponding to the second SRS configuration information. For example, an SRS transport resource configured in the second SRS configuration information for the dormant BWP may be configured to be much smaller than an SRS transport resource configured in the first SRS configuration information for the normal BWP, or an SRS transport resource period configured in the second SRS configuration information may be configured to be much longer than an SRS transport resource period configured in the first SRS configuration information, such that an effect of saving power of the UE in the dormant BWP or the suspended cell group may be improved. For example, an SRS transmission period of the second SRS configuration information may be configured to be equal to or greater than 100 ms. In another method, in the above case, when the DL BWP is activated to the dormant BWP or when cell group suspension is indicated or when the cell group is not in the active state (or is in the inactive or suspended state), if the second SRS configuration information is not configured, the UE may apply the first SRS configuration information for the UL BWP, and may transmit an SRS based on an SRS transport resource or a period or an offset corresponding to the first SRS configuration information. In another method, in the above case, when the DL BWP is activated to the dormant BWP or when cell group suspension is indicated or when the cell group is not in the active state (or is in the inactive or suspended state), if the second SRS configuration information is not configured, the UE may not transmit an SRS.
Embodiment 2 of configuring SRS
   In Embodiment 2 of the disclosure, the first SRS configuration information and the second SRS configuration information may be included one SRS configuration information, and may be respectively configured as SRS configuration information for the normal BWP or the BWP other than the dormant BWP or the PSCell (or SCell) of the cell group for which the cell group is not suspended, or the PSCell (or SCell) of the cell group for which the cell group is resumed or activated, or the BWP (e.g., SRS transport resource or period or offset) and SRS configuration information for the dormant BWP or the PSCell (SCell) of the cell group for which the cell group is suspended or deactivated or the PSCell (or SCell) of the cell group for which the cell group is not resumed or the BWP (e.g., SRS transport resource or period or offset).
   The first SRS configuration information (SRS configuration information for the normal BWP or the BWP other than the dormant BWP or the PSCell (or SCell) of the cell group for which the cell group is not suspended or the PSCell (or SCell) of the cell group for which the cell group is resumed or activated or the BWP (e.g., indicator indicating whether it is SRS configuration information for SRS transport resource or period or offset or dormant BWP)).
   The second SRS configuration information (SRS configuration information for the dormant BWP or the PSCell (or SCell) for which the cell group is suspended or deactivated or the PSCell (or SCell) for which the cell group is not resumed or the BWP (e.g., indicator indicating whether it is SRS configuration information for SRS transport resource or period or offset or dormant BWP)).
   In Embodiment 2 of the disclosure, when the dormant BWP (e.g., dormant BWP identifier in the DL BWP configuration information) is configured for the serving cell (cell) or when cell group suspension is indicated or supported or configured, the second SRS configuration information may always be configured. Alternatively, when the dormant BWP (e.g., dormant BWP identifier in the DL BWP configuration information) is configured for the serving cell (cell) or when cell group suspension is indicated or supported or configured, an indicator indicating whether it is the first SRS configuration information or the second SRS configuration information may be configured. For example, when a dormant BWP identifier is configured in the DL BWP configuration information, the second SRS configuration information may have to be configured in each UL BWP configuration information. For example, when a dormant BWP identifier is configured in the DL BWP configuration information or when cell group suspension is indicated or supported or configured, the second SRS configuration information may be configured in the UL BWP configuration information for the UL BWP or the UL BWP having the same BWP identifier as the DL dormant BWP. In another method, in the case of TDD or an unpaired spectrum, when a dormant BWP identifier is configured in the DL BWP configuration information or when cell group suspension is indicated or supported or configured, the second SRS configuration information may be configured in the UL BWP configuration information for the UL BWP or the UL BWP having the same BWP identifier as the DL dormant BWP.
   For example, in Embodiment 2 of the disclosure, when the DL BWP is switched or activated to the BWP (or normal BWP) other than the dormant BWP for the activated cell or when cell group suspension is not indicated or when the cell group is in the active state is indicated, the UE may apply the first SRS configuration information in the UL BWP of the activated cell, and may transmit an SRS based on an SRS transport resource or a period or an offset corresponding to the first SRS configuration information. When the DL BWP is switched or activated to the dormant BWP for the activated cell or when cell group suspension is indicated or when the cell group is not in the active state (or is in the inactive or suspended state), the UE may apply the second SRS configuration information in the UL BWP of the activated cell, and may transmit an SRS based on an SRS transport resource or a period or an offset corresponding to the second SRS configuration information. For example, an SRS transport resource configured in the second SRS configuration information may be configured to be much smaller than an SRS transport resource configured in the first SRS configuration information or an SRS transport resource period configured in the second SRS configuration information may be configured to be much longer than an SRS transport resource period configured in the first SRS configuration information, such that an effect of saving power of the UE may be improved. For example, an SRS transmission period in the second SRS configuration information may be configured to be equal to or greater than 10 ms. In another method, when the DL BWP is activated to the dormant BWP or when cell group suspension is indicated or when the cell group is not in the active state (or is in the inactive or suspended state), if the second SRS configuration information is not configured, the UE may apply the first SRS configuration information for the UL BWP, and may transmit an SRS based on an SRS transport resource or a period or an offset corresponding to the first SRS configuration information. In another method, when the DL BWP is activated to the dormant BWP or when cell group suspension is indicated or when the cell group is not in the active state (or is in the inactive or suspended state), if the second SRS configuration information is not configured, the UE may not transmit an SRS.
Embodiment 3 of configuring SRS
   In Embodiment 3 of the disclosure, the second SRS configuration information, that is, SRS configuration for the dormant BWP or cell group suspension indication or configuration (e.g., SRS transport resource or period or offset), may be configured only for the BWP or the BWP configured as the UL dormant BWP (BWP indicated by a dormant BWP identifier) in the UL BWP configuration information. Alternatively, the first SRS configuration information, that is, SRS configuration information for the normal BWP or the BWP other than the dormant BWP (e.g., SRS transport resource or period or offset), may be configured only for the BWP configured as the BWP other than the UL dormant BWP (BWP not indicated by a dormant BWP identifier) in the UL BWP configuration information. In another method, in a case of TDD or an unpaired spectrum, when a dormant BWP identifier is configured in the DL BWP configuration information, the second SRS configuration information may be configured in the UL BWP configuration information for the UL dormant BWP (BWP indicated by a dormant BWP identifier) or the UL BWP having the same BWP identifier as the DL dormant BWP.
   For example, in Embodiment 3 of the disclosure, when the DL BWP is switched or activated to the BWP (or normal BWP) other than the dormant BWP for the activated cell, the UE may apply the first SRS configuration information in the UL BWP of the activated cell, and may transmit an SRS based on an SRS transport resource or a period or an offset corresponding to the first SRS configuration information. However, when the DL BWP is switched or activated to the dormant BWP for the activated cell, the UE may apply the second SRS configuration information in the UL BWP of the activated cell, and may transmit an SRS based on an SRS transport resource or a period or an offset corresponding to the second SRS configuration information. For example, an SRS transport resource configured in the second SRS configuration information for the dormant BWP may be configured to be much smaller than an SRS transport resource configured in the first SRS configuration information for the normal BWP, or an SRS transport resource period configured in the second SRS configuration information for the dormant BWP may be configured to be much longer than an SRS transport resource period configured in the first SRS configuration information for the normal BWP, such that an effect of saving power of the UE in the dormant BWP may be improved. For example, an SRS transmission period in the second SRS configuration information may be configured to be equal to or greater than 100 ms. In another method, when the DL BWP is activated to the dormant BWP, if the second SRS configuration information is not configured, the UE may apply the first SRS configuration information for the UL BWP, and may transmit an SRS based on an SRS transport resource or a period or an offset corresponding to the first SRS configuration information. In another method, in the above case, when the DL BWP is activated to the dormant BWP, if the second SRS configuration information is not configured, the UE may not transmit an SRS.

As another method of the information configuration method for BWP configuration of each cell (PCell or Pscell or Scell), a second method may not involve configuring configuration information (e.g., search space, PDCCH transport resource, or period) required to read the PDCCH for the BWP corresponding to the dormant BWP (in another method, a period may be configured to be very long along with other configuration information), and may involve configuring configuration information (e.g., search space, PDCCH transport resource, or period) required to read the PDCCH for the normal BWP. This is because the dormant BWP is a BWP for not reading the PDCCH to reduce power consumption of the UE and for performing channel measurement and reporting a channel measurement result to the PCell to enable rapid activation of the BWP or cell to allow rapid allocation of UL or DL transport resources. Accordingly, in the disclosure, a dormant BWP may indicate a BWP in which configuration information for PDCCH monitoring (e.g., search space, PDCCH transport resource, or period) is not configured or may refer to a BWP indicated by a dormant BWP identifier or may refer to a BWP for which configuration information for PDCCH monitoring is configured but monitoring is configured to be performed with a very long period. In another method, in the disclosure, a dormant BWP may indicate a BWP in which a PDCCH transport resource or a period is not configured in configuration information for PDCCH monitoring so as not to perform PDCCH monitoring in the cell for which the dormant BWP is configured, but search space information or cross-carrier scheduling configuration information is configured so that an indication or switching for the dormant BWP is received in another cell via cross-carrier scheduling, and because data transmission and reception is unavailable in the dormant BWP, only PDCCH configuration information (PDCCH-config) may be configured (e.g., only search space information may be configured) for the dormant BWP (or first BWP). On the other hand, because PDCCH monitoring should also be performed and data transmission and reception should also be available in the normal BWP (or second BWP) other than the dormant BWP, PDCCH configuration information (e.g., CORESET configuration information or search space configuration information or PDCCH transport resource or period) or PDSCH configuration information or PUSCH configuration information or random access-related configuration information may be further configured.

Accordingly, although the UL or DL normal BWP should be configured for each cell, the dormant BWP may or may not be configured for each cell, and the configuration thereof may depend on implementation of the BS according to purposes. Also, the first active BWP or the default BWP or the initial BWP may be configured as the dormant BWP according to the implementation of the BS.

In the dormant BWP, the UE cannot transmit and receive data to and from the BS, may not monitor the PDCCH to detect an indication by the BS, may not transmit a pilot signal but may perform channel measurement, and may report a measured frequency/cell/channel measurement result according to the BS configuration periodically or when an event occurs. Accordingly, because the UE does not monitor the PDCCH and does not transmit a pilot signal in the dormant BWP, power consumption may be reduced compared to the active mode, and unlike the inactive mode, the UE performs channel measurement reporting, and thus, the BS may rapidly activate the cell for which the dormant BWP is configured based on a measurement report of the dormant BWP to use carrier aggregation. In the disclosure, the dormant BWP may be configured in the DL BWP configuration information, and may be used only for the DL BWP.

In the disclosure, a UE operation for the dormant BWP or a UE operation with respect to the activated SCell or PSCell when the dormant BWP is activated will now be described below.
When the UE is indicated to operate or be activated with the dormant BWP for a certain serving cell (PCell, PSCell, or SCell) from the PCell or the SPCell or when the UE receives an indication to hibernate a BWP (e.g., DL BWP) of a certain serving cell (e.g., SCell) or the serving cell (e.g., SCell) or an indication to activate the dormant BWP through the DCI of the PDCCH (L1 control signal) or the MAC CE or the RRC message or when the UE receives an indication to switch the BWP (e.g., DL BWP) to the dormant BWP via the DCI of the PDCCH (L1 control signal), the MAC CE or the RRC message (when the UE receives the indication via the L1 control signal of the PDCCH, the UE may receive the indication via the PDCCH of its own cell via self-scheduling or may receive the indication via the PDCCH for the cell in the PCell via cross-carrier scheduling). Alternatively, when the BWP hibernation timer is configured and expires or when the activated BWP of the activated cell is the dormant BWP or when the activated BWP of the activated cell is not the normal BWP, the UE may perform one or more of the following operations.
   In the above case, the UL BWP or the DL BWP may be switched to the BWP (e.g., dormant BWP) configured via the RRC and the BWP may be activated or hibernated.
   The cell deactivation timer configured or running in the cell or the BWP may be stopped.
   When the BWP hibernation timer is configured in the BWP of the cell, the BWP hibernation timer may be stopped.
   The dormant BWP deactivation timer in the BWP of the cell may start or re-start.
   The BWP inactivity timer configured for the BWP of the cell may be stopped. This is to prevent an unnecessary BWP switching procedure in the cell.
   A periodic DL transport resource (DL SPS or configured downlink assignment) or a periodic UL transport resource (UL SPS or configured uplink grant type 2) configured in the BWP of the cell may be cleared. In the above case, the term ‘clear’ means that the UE stores configuration information such as period information configured in the RRC message but information about a periodic transport resource indicated or activated by L1 signaling (e.g., DCI) is removed and is no longer used. The method proposed above, that is, an operation of clearing the configured periodic DL transport resource (DL SPS or configured downlink assignment) or the configured periodic UL transport resource (UL SPS or configured uplink grant) may be performed only when the BWP is transitioned from the active state to the dormant state. This is because, when the BWP is transitioned from the inactive state to the dormant state, there is no information about periodic transport resource information indicated or activated by L1 signaling. In another method, only when the periodic DL transport resource or the periodic UL transport resource is configured or is configured and used, the periodic transport resources may be cleared.
   The periodic UL transport resource configured in the BWP of the cell (configured uplink grant type 1 configured in the RRC) may be suspended. In the above case, ‘suspend’ means that transport resource configuration information configured in the RRC message is stored in the UE but is no longer used. The method proposed above, that is, an operation of suspending the configured periodic UL transport resource (configured uplink grant type 1) may be performed only when the BWP is transitioned from the active state to the dormant state. This is because the periodic transport resource is not used when the BWP is transitioned from the inactive state to the dormant state. In another method, only when the periodic DL transport resource or the periodic UL transport resource is configured or is configured and used, the periodic transport resources may be cleared.
   All HARQ buffers configured in the UL or DL BWP may be emptied.
   The UE may not transmit an SRS for the UL BWP of the cell.
   In another method, when the first SRS configuration information (SRS configuration information for the normal BWP (BWP other than the dormant BWP) (e.g., SRS transport resource or period or offset)) or the second SRS configuration information (SRS configuration information for the dormant BWP (e.g., SRS transport resource or period or offset)) is configured in the UL BWP configuration information, the UE may transmit an SRS so as to facilitate power control or scheduling of the network or to rapidly reactivate the UL BWP of the UE. For example, when the DL BWP is switched or activated to the BWP other than the dormant BWP (or normal BWP) for the activated cell (when the activated BWP is not the dormant BWP), the UE may apply the first SRS configuration information in the UL BWP of the activated cell, and may transmit an SRS based on an SRS transport resource or a period or an offset corresponding to the first SRS configuration information. However, when the DL BWP is switched or activated to the dormant BWP (when the activated BWP is the dormant BWP) for the activated cell, the UE may apply the second SRS configuration information in the UL BWP of the activated cell, and may transmit an SRS based on an SRS transport resource or a period or an offset corresponding to the second SRS configuration information. For example, an SRS transport resource configured in the second SRS configuration information for the dormant BWP may be configured to be much smaller than an SRS transport resource configured in the first SRS configuration information for the normal BWP, or an SRS transport resource period configured in the second SRS configuration information for the dormant BWP may be configured to be much longer than an SRS transport resource period configured in the first SRS configuration information for the normal BWP, such that an effect of saving power of the UE in the dormant BWP may be improved. For example, an SRS transmission period in the second SRS configuration information may be configured to be equal to or greater than 100 ms. In another method, when the DL BWP is activated to the dormant BWP, if the second SRS configuration information is not configured, the UE may apply the first SRS configuration information to the UL BWP, and may transmit an SRS based on an SRS transport resource or a period or an offset corresponding to the first SRS configuration information. In another method, when the DL BWP is activated to the dormant BWP, if the second SRS configuration is not configured, the UE may not transmit an SRS.
   In another method, when the DL BWP is switched or activated to the DL dormant BWP (when the activated BWP is the dormant BWP) for the activated cell, the UE may switch or activate the UL BWP to the UL dormant BWP. In the above case, the UL dormant BWP may be indicated as the dormant BWP by a BWP identifier in the UL BWP configuration information configured via the RRC message (e.g., in a case of FDD or an unpaired spectrum or TDD), and in another method, the UL BWP having the same BWP identifier as the DL dormant BWP may be the dormant BWP (e.g., in the case of an unpaired spectrum or TDD). In the above case, the UE may apply the second SRS configuration information configured in the UL dormant BWP, and may transmit an SRS based on an SRS transport resource or a period or an offset corresponding to the second SRS configuration information.
   In another method, the current UL BWP or the last activated UL BWP may be changelessly activated.
   In the BWP of the cell, the UE may perform channel measurement (channel state information (CSI) or channel quality indicator (CQI) or precoding matrix indicator (PMI) or rank indicator (RI) or precoding type indicator (PTI) or CSI-reference signal indicator (CRI)) and may perform measurement reporting for the DL according to the BS configuration. For example, channel or frequency measurement reporting may be periodically performed.
   In the BWP of the cell, UL data may not be transmitted via a UL-SCH.
   In the BWP of the cell, a random access procedure may not be performed.
   In the BWP of the cell, the UE may not monitor the PDCCH.
   The UE may not monitor the PDCCH for the BWP of the cell. However, in a case of cross-scheduling, the UE may receive an indication by monitoring the PDCCH for the cell (e.g., SCell) in the scheduled cell (e.g., PCell).
   In the BWP of the cell, PUCCH or SPUCCH transmission may not be performed.
   The DL BWP may be hibernated, channel measurement may be performed and reported, and the UL BWP of the cell may be deactivated and may not be used. This is because, in the dormant cell, channel measurement is performed only for the DL BWP, and a measurement result is reported in the UL BWP of the Spcell (Pcell or Pscell) or the SCell with the PUCCH.

When switching or activation to the dormant BWP is indicated for the DL or hibernation is indicated for the BWP, a random access procedure may be performed without being cancelled. This is because, in the cell, when a random access procedure is performed, a preamble is transmitted via the UL and an RAR is received via the DL of the Pcell. Accordingly, even when the DL BWP is hibernated or switched to the dormant BWP, a problem does not occur.

In the disclosure, a UE operation when the normal BWP (active BWP) of the activated cell is activated or when the BWP other than the dormant BWP is activated will now be described below.
When an indication to activate the normal BWP (e.g., DL BWP) of the current cell (PCell or PSCell or SCell) or the normal BWP other than the dormant BWP or an indication to activate the cell is received via the DCI of the PDCCH (L1 control signal) or the MAC CE or the RRC message or when an indication to switch the BWP (e.g., DL BWP) to the active BWP (or BWP other than the dormant BWP) is received via the DCI of the PDCCH (L1 control signal) or the MAC CE or the RRC message or when the activated BWP of the currently activated cell is the normal BWP or when the activated BWP of the currently activated cell is not the dormant BWP (when the indication is received via the L1 control signal of the PDCCH, the indication may be received via the PDCCH of its own cell via self-scheduling or the indication may be received via the PDCCH for the cell in the PCell via cross-carrier scheduling), the UE may perform one or more of the following operations.
   In the above case, it may be switched or activated to the indicated UL or DL BWP. Alternatively, the UE may switch the UL or DL BWP to the designated BWP (e.g., UL or DL first active BWP) and may activate the BWP.
   In the activated BWP, the UE may transmit an SRS so that the BS can perform channel measurement for the UL. For example, the SRS may be periodically transmitted.
   In another method, when the first SRS configuration information (SRS configuration information for the normal BWP (BWP other than the dormant BWP) (e.g., SRS transport resource or period or offset)) or the second SRS configuration information (SRS configuration information for the dormant BWP (e.g., SRS transport resource or period or offset)) is configured in the UL BWP configuration information, the UE may transmit an SRS so as to facilitate power control or scheduling of the network or to rapidly deactivate the UL BWP of the UE. For example, when the DL BWP is switched or activated to the BWP other than the dormant BWP (or normal BWP) for the activated cell (when the first active BWP is not the dormant BWP), the UE may apply the first SRS configuration information to the UL BWP of the activated cell, and may transmit an SRS based on an SRS transport resource or a period or an offset corresponding to the first SRS configuration information. When the DL BWP is switched or activated to the dormant BWP for the activated cell (when the first active BWP is the dormant BWP), the UE may apply the second SRS configuration information to the UL BWP of the activated cell, and may transmit an SRS based on an SRS transport resource or a period or an offset corresponding to the second SRS configuration information. For example, an SRS transport resource configured in the second SRS configuration information for the dormant BWP may be configured to be much smaller than an SRS transport resource configured in the first SRS configuration information for the normal BWP, or an SRS transport resource period configured in the second SRS configuration information for the dormant BWP may be configured to be much longer than an SRS transport resource period configured in the first SRS configuration information for the normal BWP, such that an effect of saving power of the UE may be improved. For example, an SRS transmission period in the second SRS configuration information may be configured to be equal to or greater than 100 ms. In another method, when the DL BWP is activated to the dormant BWP, if the second SRS configuration information is not configured, the UE may apply the first SRS configuration information to the UL BWP, and may transmit an SRS based on an SRS transport resource or a period or an offset corresponding to the first SRS configuration information. In another method, when the DL BWP is activated to the dormant BWP, if the second SRS configuration information is not configured, the UE may not transmit an SRS.
   In another method, when the DL BWP is switched or activated to the BWP or the normal BWP other than the DL dormant BWP for the activated cell (when the first active BWP is not the dormant BWP), the UE may switch or activate the UL BWP to the BWP first activated from dormancy configured in the RRC. The BWP first activated from UL dormancy may be indicated as the BWP first activated from dormancy by a BWP identifier in the UL BWP configuration information configured in the RRC message (e.g., in the case of FDD, an unpaired spectrum, or TDD), and in another method, the UL BWP having the same BWP identifier as the DL dormant BWP may be the dormant BWP (e.g., in the case of an unpaired spectrum or TDD). The UE may apply the first SRS configuration information configured in the BWP first activated from dormancy, and may transmit an SRS based on an SRS transport resource or a period or an offset corresponding to the first SRS configuration information.
   In another method, the current UL BWP or the last activated UL BWP may be changelessly activated.
   In another method, when the first active DL BWP is not the dormant BWP,
      when the cell is in the inactive state before MAC control information indicating cell activation or deactivation is received or when the cell is configured in the active state in cell configuration or configuration information via the RRC message,
         the UL BWP or the DL BWP may be activated to a BWP indicated by a first active UL BWP identifier or a first active DL BWP identifier in RRC configuration information.
   In another method, when the first active DL BWP is the dormant BWP
      the BWP inactivity timer may be stopped.
      When the cell is in the inactive state before MAC control information indicating cell activation or deactivation is received or when the cell is configured in the active state in cell configuration or configuration information via the RRC message,
         the UL BWP or the DL BWP may be activated to a BWP indicated by a first active UL BWP identifier (or dormant BWP identifier) or a first active DL BWP identifier (or dormant BWP identifier) in RRC configuration information. For example, when the first active DL BWP is configured as the dormant BWP, the first active UL BWP may also be configured as the dormant BWP.
         In another method, the DL BWP may be activated to a BWP indicated by a first active DL BWP identifier (or dormant BWP identifier) in RRC configuration information. The UL BWP may be activated to a BWP indicated by a dormant BWP identifier (or first active UL BWP identifier) in RRC configuration information.
      When the PUCCH is configured in the activated BWP, the UE may perform PUCCH transmission.
      The BWP or cell deactivation timer may start or re-start. In another method, only when the BWP or cell hibernation timer is not configured, the BWP or cell deactivation timer may start or re-start. The BWP or cell hibernation timer may be configured in the RRC message, and when the BWP or cell hibernation timer expires, the BWP or cell may be hibernated. For example, the BWP or cell deactivation timer may start or re-start only in the hibernated BWP or cell.
      When there is a suspended type 1 configuration transport resource, the stored type 1 transport resource may be initialized and used as configured. In the above case, the type 1 configuration transport resource is a periodic transport resource (UL or DL) that is previously allocated via the RRC message and refers to a transport resource that may be activated and used via the RRC message.
      Power headroom report (PHR) may be triggered for the BWP.
      In the activated BWP, the UE may report a channel measurement result (CSI, CQI, PMI, RI, PTI, or CRI) according to the BS configuration for the DL.
      In the activated BWP, the PUCCH may be monitored to read an indication of the BS.
      In order to read cross-scheduling for the activated BWP, the PDCCH may be monitored.
      In the above case, the BWP inactivity timer may start or re-start. In another method, only when the BWP hibernation timer is not configured, the BWP inactivity timer may start or re-start. The BWP hibernation timer may be configured in the RRC message, and when the BWP hibernation timer expires, the UE may switch the BWP to dormancy or the dormant BWP. For example, only in the dormant BWP, the BWP inactivity timer may start or re-start.
      When the BWP hibernation timer is configured for the BWP,
         the BWP hibernation timer may start or re-start for the BWP.

In the disclosure, a UE operation when the inactive BWP (non-active BWP) or the BWP or the cell is deactivated will now be described below.
When an indication to deactivate the BWP (e.g., DL BWP) of the current cell (PCell or PSCell or SCell) or the cell is received via the DCI of the PDCCH (L1 control signal) or the MAC CE or the RRC message or when an indication to deactivate the BWP (e.g., DL BWP) or an indication to switch to the inactive BWP is received via the DCI of the PDCCH (L1 control signal) or the MAC CE or the RRC message (when the indication is received via the L1 control signal of the PDCCH, the indication may be received via the PDCCH of its own cell via self-scheduling, or the indication may be received via the PDCCH for the cell in the PCell via cross-carrier scheduling.) Alternatively, when the BWP or cell deactivation timer expires in the cell or when the activated cell is deactivated or when the BWP of the cell is deactivated, the UE may perform one or more of the following operations.
   The cell or the indicated UL or DL BWP may be deactivated.
   The UE may stop the BWP inactivity timer (e.g., inactivity timer for the DL BWP) that is configured and running in the cell or the BWP.
   A periodic DL transport resource (DL SPS or configured downlink assignment) or a periodic UL transport resource (UL SPS or configured uplink grant type 2) configured in the cell or the BWP may be cleared. In the above case, ‘clear’ means that the UE stores configuration information such as period information configured in the RRC message but information about a periodic transport resource indicated or activated by L1 signaling (e.g., DCI) is removed and is no longer used. The periodic transport resource may be referred to as a type 2 configuration transport resource. Also, an operation of clearing the periodic transport resource may be performed only when the cell is transitioned from the active state to the inactive state. This is because, when the cell is transitioned from the dormant state to the inactive state, there is no periodic transport resource in the dormant state, and thus a clearing operation is not necessary. In another method, only when the periodic DL transport resource or the periodic UL transport resource is configured, or configured and used, the periodic transport resources may be cleared.
   The periodic UL transport resource configured for the cell or the BWP (configured uplink grant type 1 configured in the RRC) may be suspended. In the above case, ‘suspend’ means that transport resource configuration information configured in the RRC message is stored in the UE but is no longer used. The periodic transport resource may be referred to as a type 1 configuration transport resource. Also, in the above case, an operation of clearing a periodic transport resource may be performed only when the cell is transitioned from the active state to the inactive state. This is because, when the cell is transitioned from the dormant state to the inactive state, there is no periodic transport resource in the dormant state, and thus a clearing operation is not necessary. In another method, only when the periodic DL transport resource or the periodic UL transport resource is configured, or configured and used, the periodic transport resources may be cleared.
   All HARQ buffers configured for the cell or the BWP are emptied.
   When there is a PUSCH transport resource configured for periodic channel measurement reporting (semi-persistent CSI reporting) for the cell or the BWP, the PUSCH transport resource is cleared.
   The UE does not transmit an SRS for the cell or the BWP.
   For the cell or the BWP, the UE does not perform channel measurement (CSI, CQI, PMI, RI, PTI, or CRI) and does not perform reporting for the DL.
   In the cell or the BWP, UL data is not transmitted via the UL-SCH.
   For the cell or the BWP, a random access procedure is not performed.
   In the cell or BWP, the UE does not monitor the PDCCH.
   The UE does not monitor the PDCCH for the cell or the BWP. Also, even in a case of cross-scheduling, the UE does not monitor the PDCCH for the cell in the scheduled cell.
   In the cell or the BWP, PUCCH or SPUCCH transmission is not performed.

In the disclosure, when an active state or an inactive state or a dormant state is operated and cell or BWP transition or switching is performed, it may be performed in units of BWPs, and when state transition or switching occurs in units of BWPs, a BWP (DL BWP or UL BWP) indicated with state transition or switching may perform state transition or switching according to a state transition or switching indication. For example, when the BWP (DL BWP or UL BWP) is transitioned from the active state to the dormant state or is switched (or activated) to the dormant BWP, the BWP may be transitioned to the dormant state, or may be switched (or activated) to the dormant BWP.

In the disclosure, ‘BWP switching’ may mean that, when BWP switching is indicated by the DCI of the PDCCH and when switching is indicated by a BWP identifier while allocating a downlink assignment, the DL BWP is switched to the BWP indicated by the BWP identifier, and when BWP switching is indicated by the DCI of the PDCCH and when switching is indicated by a BWP identifier while allocating an UL grant, the UL BWP is switched to the BWP indicated by the BWP identifier. Also, because the DCI format of the PDCCH varies between the format for downlink assignment (format1) and the format for UL grant (format0), the UE may operate according to the DCI format even when the UL and the DL are not separately described.

FIG. 1G illustrates a diagram of Embodiment 1 in which an embodiment of the disclosure is extended and applied to an RRC inactive mode UE.

In the Embodiment 1, even when a UE is transitioned to an RRC inactive mode, the UE may not release or discard but may continuously store a plurality of pieces of SCell configuration information (e.g., a plurality of pieces of configuration information described with reference to FIG. 1F) or a plurality of pieces of PSCell (or SCell) configuration information of a cell group (e.g., SCG) which are configured or stored as in FIG. 1F in an RRC connected mode. Also, when an RRC connection resume procedure is performed, an RRC inactive mode UE may determine, via an indicator of an RRCResume message or an RRCReconfiguration message transmitted by a BS or through a reconfiguration procedure, whether to discard or release, or maintain and apply, or reconfigure the SCell configuration information (e.g., configuration information described or provided in FIG. 1F) or the PSCell (or SCell) configuration information of the cell group (e.g., SCG) stored in the UE. Also, when the BS transmits, to the UE, an RRCRelease message including a configuration or an indicator to transition the UE to an RRC inactive mode, the BS may transmit, to the UE, the RRCRelease message including an indicator or configuration information indicating whether to discard or release, or maintain and apply, or reconfigure the SCell configuration information (e.g., configuration information described with reference to FIG. 1F) or the PSCell (or SCell) configuration information of the cell group (e.g., SCG) stored in the UE. Also, the UE may move in the RRC inactive mode, and when RAN notification area (RNA) updating is performed, via the RRCRelease message transmitted by the BS to the UE, the UE may receive and apply the indicator or the configuration information indicating whether to discard or release, or maintain and apply, or reconfigure the SCell configuration information (e.g., configuration information described with reference to FIG. 1F) or the PSCell (or SCell) configuration information of the cell group (e.g., SCG) stored in the UE.

In Embodiment 1 proposed in the disclosure, in the SCell configuration information (e.g., configuration information described with reference to FIG. 1F) and the PSCell (or SCell) configuration information of the cell group (e.g., SCG) of the RRC message, the BS may allow a first active BWP of DL or UL BWP configuration information of each cell to be configured as a dormant BWP, and when the UE activates each SCell, each cell group, or the PSCell of each cell group, the BS may directly operate a DL BWP or a UL BWP of each SCell, or each cell group, or the PSCell of each cell group as the dormant BWP, or may suspend or resume the cell group, thereby reducing power consumption of the UE.

In another method, in Embodiment 1 proposed in the disclosure, in the SCell configuration information (e.g., configuration information described with reference to FIG. 1F) or the PSCell (or SCell) configuration information of the cell group (e.g., SCG) of the RRC message, the BS may not configure the first active BWP of the DL or UL BWP configuration information of each cell as the dormant BWP, and when the UE activates or resumes each SCell, each cell group, or the PSCell of each cell group, the BS may always activate the DL BWP or the UL BWP of each SCell, or each cell group, or the PSCell of each cell group to the first active BWP, or may switch or activate the same to the dormant BWP according to Embodiment 1 or Embodiment 2 or Embodiment 3, or may suspend or resume the cell group, thereby reducing power consumption of the UE.

Embodiment 1 of the disclosure may be extended and applied to each SCell configuration information or PSCell configuration information of an MCG or an SCG of the UE in which dual connectivity is configured. That is, the SCell configuration information or the PSCell configuration information of the SCG may also be stored when the UE is transitioned to the RRC inactive mode, and the BS may transmit, to the UE, the RRC message (e.g., RRCResume, RRCReconfiguration, or RRCRelease) including the indicator or the configuration information indicating whether to discard or release, or maintain and apply, or reconfigure the SCell configuration information (e.g., configuration information described with reference to FIG. 1F) or the PSCell configuration information of the MCG or SCG stored in the UE, when the BS performs the RRC connection resume procedure or transitions the UE to the RRC inactive mode.

Referring to FIG. 1G, a UE 1g-01 may perform a network connection with a BS 1g-02 and may transmit and receive data (1g-05). When the BS needs to transition the UE to an RRC inactive mode for a certain reason, the BS may transmit an RRCRelease message 1g-20 to the UE and may transition the UE to the RRC inactive mode. The BS may transmit, to the UE, an RRC message (e.g., RRCRelease) including an indicator or configuration information indicating whether to discard or release, or maintain and apply, or reconfigure SCell configuration information of an MCG or an SCG (e.g., configuration information described with reference to FIG. 1F) or PSCell (or SCell) configuration information of the cell group (e.g., SCG) stored in the UE. In the above case, when the UE supports dual connectivity, the BS may determine whether to suspend and resume a master cell group bearer configuration or RRC configuration information or SCell configuration information of the MCG or SCG, and may determine whether to suspend and resume a secondary cell group bearer configuration and RRC configuration by asking a secondary cell BS whether to suspend and resume the same and receiving a response from the secondary cell BS (1g-15). In the RRCRelease message, the BS may configure a frequency list to be measured in an RRC idle mode or an RRC inactive mode by the UE, or frequency measurement configuration information, or a frequency measurement period.

When the RRC inactive mode UE receives a paging message (1g-25), needs to transmit UL data, or needs to update an RNA while moving, the UE may perform an RRC connection resume procedure.

When the UE needs to configure a connection, the UE may perform a random access procedure and may transmit an RRCResumeRequest message to the BS, and here, proposed UE operations related to the message transmission are as below (1g-30).

1. The UE identifies system information, and when the system information indicates to transmit a complete terminal connection resume identifier (I-RNTI or Full resume ID), the UE prepares to transmit the message including a stored complete terminal connection resume identifier (I-RNTI). When the system information indicates to transmit a truncated terminal connection resume identifier (truncated I-RNTI or truncated resume ID), the UE configures a truncated terminal connection resume identifier (truncated resume ID) from the stored complete terminal connection resume identifier (I-RNTI) by using a certain method and prepares to transmit the message including the truncated terminal connection resume identifier.

2. The UE recovers RRC connection configuration information and security contact information from stored UE context.

3. The UE updates a new KgNB security key corresponding to the MCG based on a current KgNB security key, a Next Hop (NH) value, and an NH change counter (NCC) value received in the RRCRelease message and stored.

4. When the UE receives an SCG-counter value (or sk-counter) in the RRCRelease message, the UE updates a new SKgNB security key corresponding to the SCG based on the KgNB security key and the SCG-counter value (or sk-counter).

5. The UE derives new security keys (K_RRCenc, K_RRC_int, K_UPint, and K_UPenc) to be used in an integrity protection and verification procedure and an encryption and decryption procedure, by using the newly updated KgNB security key.

6. When the UE receives the SCG-counter value (or sk-counter) in the RRCRelease message, the UE derives new security keys (SK_RRCenc, SK_RRC_int, SK_UPint, and SK_UPenc) to be used in an integrity protection and verification procedure and an encryption and decryption procedure, by using the newly updated SKgNB security key corresponding to the SCG.

7. The UE calculates a message authentication code for integrity (MAC-I) and prepares to transmit the message including the MAC-I.

8. The UE resumes a signaling radio bearer 1 (SRB1) (the UE should resume the SRB1 in advance because the UE will receive the RRCResume message via the SRB1 in response to the RRCReseumeRequest message to be transmitted).

9. The UE configures the RRCResumeRequest message and transmits the RRCResumeRequest message to a lower layer.

10. For all bearers except for an SRB0 corresponding to the MCG (MCG terminated RBs), an integrity protection and verification procedure may be resumed by applying the updated security keys and a previously configured algorithm, and integrity verification and protection may be applied to subsequently transmitted and received data (in order to improve the reliability and security of data subsequently transmitted and received from the SRB1 or DRBs).

11. For all the bearers except for the SRB0 corresponding to the MCG (MCG terminated RBs), an encryption and decryption procedure may be resumed by applying the updated security keys and the previously configured algorithm, and encryption and decryption may be applied to subsequently transmitted and received data (in order to improve the reliability and security of data subsequently transmitted and received from the SRB1 or DRBs).

12. When the UE receives the SCG-counter value (or sk-counter) in the RRCRelease message, the UE may resume an integrity protection and verification procedure by applying the updated security keys and the previously configured algorithm for all bearers corresponding to the SCG (SCG terminated RBs), and may apply integrity verification and protection to subsequently transmitted and received data (in order to improve the reliability and security of data subsequently transmitted and received from the DRBs).

13. When the UE receives the SCG-counter value (or sk-counter) in the RRCRelease message, the UE may resume an encryption and decryption procedure by applying the updated security keys and the previously configured algorithm for all the bearers corresponding to the SCG (SCG terminated RBs) and may apply encryption and decryption to subsequently transmitted and received data (in order to improve the reliability and security of data subsequently transmitted and received from the DRBs).

UE operations when the UE needs to configure a connection, and performs a random access procedure, transmits the RRCResumeRequest message to the BS, and then receives the RRCResume message as a response are as below (1g-35). When the RRC message includes an indicator indicating to the UE to report when there is a valid frequency measurement result in the RRC inactive mode, the UE may configure a frequency measurement result in an RRCResumeComplete message and may report the frequency measurement result. Also, the BS may transmit, to the UE, the RRC message (RRCResume) including the indicator or the configuration information indicating whether to discard or release, or maintain and apply, or reconfigure the SCell configuration information of the MCG or the SCG (e.g., configuration information described with reference to FIG. 1F) stored in the UE.

1. When receiving the message, the UE restores a PDCP state corresponding to the MCG, resets a count value, and re-establishes PDCP layers of an SRB2 and all DRBs (MCG terminated RBs) corresponding to the MCG.

2. When receiving the SCG-counter value (or sk-counter) in the message, the UE updates a new SKgNB security key corresponding to the SCG based on a KgNB security key and the SCG-counter value (sk-counter). The UE derives new security keys (SK_RRCenc, SK_RRC_int, SK_UPint, and SK_UPenc) to be used in an integrity protection and verification procedure and an encryption and decryption procedure, by using the newly updated SKgNB security keys corresponding to the SCG.

3. When the message includes MCG (maserCellgroup) configuration information.
A. The MCG configuration information included in the message is performed and applied. The MCG information may include configuration information about RLC layers belonging to the MCG, a logical channel identifier, and a bearer identifier.

4. When the message includes bearer configuration information (radioBearerConfig).
A. The bearer configuration information (radioBearerConfig) included in the message is performed and applied. The bearer configuration information (radioBearerConfig) may include configuration information about PDCP layers for each bearer, configuration information about SDAP layers, a logical channel identifier, and a bearer identifier.

5. When the message includes SCG (masterCellgroup) configuration information.
A. the SCG configuration information included in the message is performed and applied. The SCG information may include configuration information about RLC layers belonging to the SCG, a logical channel identifier, and a bearer identifier.

6. When the message includes secondary bearer configuration information (radioBearerConfig).
A. the secondary bearer configuration information (radioBearerConfig) included in the message is performed and applied. The secondary bearer configuration information (radioBearerConfig) may include configuration information about PDCP layers for each secondary bearer, configuration information about SDAP layers, a logical channel identifier, and a bearer identifier.

7. The UE resumes the SRB2 and all the DRBs (MCG terminated RBs) corresponding to the MCG.

8. When the message includes frequency measurement configuration information (measConfig).
A. the frequency measurement configuration information included in the message is performed and applied. That is, frequency measurement may be performed according to the configuration.

9. The UE is transitioned to the RRC connected mode.

10. The UE indicates a higher layer that a suspended RRC connection has been resumed.

11. Then, the UE configures and transmits the RRCResumeComplete message to a lower layer (1g-40).

When the UE has bearer configuration information and UE context information for a suspended SCG, the UE may perform frequency measurement based on the system information or the frequency configuration information configured in the RRCRelease message or the RRCResume message, and when there is a valid result, in order to indicate that there is the valid result, the UE may transmit the RRCResumeComplete message including the indicator. When the BS receives the indicator, if carrier aggregation or dual connectivity needs to be resumed, the BS may indicate to the UE to report the frequency measurement result (1g-45) and may receive the frequency measurement result, or may receive the frequency measurement result in the RRCResumeComplete message (1g-50). When the BS receives the frequency measurement result, the BS may ask the secondary cell BS whether to resume bearer information for the suspended SCG, may perform a determination by receiving a response thereto, and may transmit an RRCReconfiguration message to the UE to indicate whether to resume or release bearers for the SCG (1g-60). Also, the BS may transmit, to the UE, the RRC message (e.g., RRCReconfiguration) including the indicator or the configuration information indicating whether to discard or release, or maintain and apply, or reconfigure the SCell configuration information (e.g., configuration information described with reference to FIG. 1F) of the MCG or the SCG stored in the UE.

1> When only one cell group (e.g., SCG) configuration information is configurable for the UE (e.g., if the UE can have MCG configuration information and one SCG configuration information), the UE may apply cell group configuration information or may apply dual connectivity according to an indicator of an RRCResume message.
2> When the RRCResume message includes new cell group (e.g., SCG) configuration information without an indicator indicating to recover a cell group, the UE may release stored cell group (e.g., SCG) configuration information and may apply the cell group configuration information included in the RRCResume message and may use dual connectivity.
2> When the RRCResume message includes new cell group (e.g., SCG) configuration information with an indicator indicating to recover a cell group, the UE may recover stored cell group (e.g., SCG) configuration information and may add the cell group configuration information included in the RRCResume message to existing cell group configuration information or may reconfigure the cell group configuration information to the existing cell group configuration information (delta configuration), and may use dual connectivity, based on the added or reconfigured cell group configuration information. In the above case, when the RRCResume message includes the new cell group (e.g., SCG) configuration information with the indicator indicating to recover a cell group, but the new cell group configuration information does not have configuration information for a bearer or a protocol layer, the UE may recover the stored cell group (e.g., SCG) configuration information and may use dual connectivity, based on the recovered cell group configuration information.

1> When a plurality of pieces of cell group (e.g., SCGs) configuration information are configurable for the UE (e.g., if the UE can have MCG configuration information and a plurality of pieces of SCG configuration information), the UE may apply cell group configuration information or may apply dual connectivity according to an indicator of an RRCResume message.
2> When the RRCResume message includes new cell group (e.g., SCG) configuration information without an indicator indicating to recover a cell group, the UE may release all stored cell group (e.g., SCG) configuration information and may apply the cell group configuration information included in the RRCResume message and may use dual connectivity. In another method, the RRCResume message may include an indicator or a list or a cell group identifier for releasing a cell group, and thus, may indicate which cell group configuration information is to be released or recovered from among a plurality of pieces of stored cell group configuration information.
2> When the RRCResume message includes new cell group (e.g., SCG) configuration information with an indicator indicating to recover a cell group or includes cell group identifier information or cell group state information to be recovered (or applied or activated or resumed), the UE may recover the indicated cell group configuration information from among the plurality of pieces of stored cell group (e.g., SCG) configuration information and may add the cell group configuration information included in the RRCResume message to existing cell group configuration information or may reconfigure the cell group configuration information to the existing cell group configuration information (delta configuration), and may use dual connectivity, based on the added or reconfigured cell group configuration information. In the above case, when the RRCResume message includes the new cell group (e.g., SCG) configuration information with the indicator indicating to recover a cell group or includes cell group identifier information or cell group state information to be recovered (or applied or activated or resumed) or includes the new cell group configuration information which does not have configuration information for a bearer or a protocol layer, the new cell group configuration information does not have configuration information for a bearer or a protocol layer, the UE may recover the indicated cell group configuration information from among the plurality of pieces of stored cell group (e.g., SCG) configuration information and may use dual connectivity, based on the recovered cell group configuration information.

In Embodiment 1 of FIG. 1G of the disclosure, in the SCell configuration information (e.g., configuration information described with reference to FIG. 1F) or the PSCell (or SCell) configuration information of the cell group (e.g., SCG) of the RRC message (e.g., RRCRelease, RRCResume, or RRCReconfiguartion), the BS may allow a first active BWP of DL or UL BWP configuration information of each cell to be configured as a dormant BWP, and when the UE activates each SCell or the PSCell of each cell group (SCG), the BS may directly operate a DL BWP or a UL BWP of each SCell or the PSCell as the dormant BWP, or may suspend or resume the cell group, thereby reducing power consumption of the UE. For example, for each SCell or each PSCell, when an SCell state is configured as the active state, or a cell group state is configured as the active state, or the suspended state, or the deactivated state, or an indication to suspend or resume the cell group is configured in the SCell configuration information or the cell group configuration information of the RRC message (e.g., RRCRelease or RRCResume or RRCReconfiguartion), or when an indication to activate the SCell is received in MAC control information according the disclosure, the SCell or the PSCell may be activated, or resumed, or suspended, and the DL BWP or the UL BWP of the SCell or the PSCell may be directly activated when the SCell or the PSCell is activated, thereby reducing power consumption of the UE.

When the RRC inactive mode UE is transitioned to the RRC connected mode and recovers or applies or reconfigures the SCell configuration information or the PSCell (or SCell) configuration information of the cell group (e.g., SCG) of the disclosure, according to an embodiment of the disclosure, switching or activation between BWPs or activation or application of a dormant BWP may be performed for each activated SCell or PSCell (or SCell) of the cell group. Also, Embodiment 1 of the disclosure may be extended and applied even when handover is performed.

In the disclosure, when an indicator indicating to suspend or resume or activate or deactivate a cell group or a PSCell of the cell group is received by MAC control information of FIG. 1H, a PHY layer or a MAC layer receiving the indication may transmit the indication to a higher layer (e.g., MAC layer or RLC layer or PDCP layer or RRC layer). When the higher layer receives the indication (e.g., to suspend or resume or activate or deactivate the cell group) from the lower layer, the higher layer may perform a corresponding procedure of a protocol layer for cell group suspension or resumption or activation or deactivation. Alternatively, as in Embodiment 1 of the disclosure, when an indicator indicating to suspend or resume or activate or deactivate a cell group or a PSCell of the cell group is received via an RRC message, an RRC layer receiving the indication may transmit the indication to a lower layer (e.g., PHY layer or MAC layer or RLC layer or PDCP layer). When the lower layer receives the indication (e.g., to suspend or activate or deactivate the cell group) from the higher layer (e.g., RRC layer), the lower layer may perform a corresponding procedure of a protocol layer for cell group suspension or resumption or activation or deactivation.

Various embodiments may be configured and operated by combining or extending embodiments proposed in the disclosure.

FIG. 1H illustrates a diagram of MAC control information indicating state transition to an active state (or resumed state) or a dormant state (or suspended state) or an inactive state for a cell or a cell of a cell group or a cell group, according to an embodiment of the disclosure.

An active and inactive MAC CE according to the disclosure may have a structure of FIG. 1H according to the disclosure, and may be divided into a MAC CE structure 1h-05 having a size of 1 byte supporting 7 Scells and a MAC CE structure 1h-10 having a size of 4 bytes supporting 31 Scells. Also, it has characteristics below.
UE operations when a hibernation MAC CE is not received and only an active and inactive MAC CE is received are as below.
   Each field of the active and inactive MAC CE indicates each Scell identifier, and a value corresponding to each field indicates whether the Scell is activated or deactivated. When a value of an indicator for an Scell indicated by an Scell identifier is 1, the Scell is activated when the state of the Scell is the inactive state. However, when the state of the Scell is not the inactive state, the indicator value is ignored. When the value of the indicator for the Scell indicated by the Scell identifier is 0, the Scell is deactivated. That is, when the value of the indicator for the Scell is 0, the Scell is deactivated regardless of the state of the Scell.

Also, a new MAC CE for supporting embodiments of the disclosure and extending to various embodiments may be designed or an existing MAC CE function may be extended.

For example, MAC CEs described with reference to FIG. 1H may be applied, and the functions described with reference to FIG. 1H may be extended and applied by extending a reserved bit (R bit) in 1h-05 or 1h-10 of FIG. 1H.
For example, when the reserved bit (e.g., R field) is configured as 0 (or 1), a 1-bit indicator (e.g., C field) indicating the identifier of each cell (SCell) may be defined and used as follows. In another method, when the reserved bit (e.g., R field) is configured as 0 (or 1), it may mean an indication to deactivate or suspend the cell group (e.g., SCG). For example, the cell, the BWP, or the cell group in the inactive or suspended state may be transitioned to the inactive state or may be maintained, and the cell, the BWP, or the cell group in the active state (or resumed state) may be transitioned to the inactive state. The indicator may be indicated to a higher layer.
   When the 1-bit indicator is configured as 0 (or 1), state transition for each cell (e.g., SCell or SCell of MCG or SCG) or the BWP may be performed as follows.
      The cell or the BWP in the inactive state is transitioned to the inactive state or is maintained.
      The cell or the BWP in the active state is transitioned to the inactive state.
   When the 1-bit indicator is configured as 1, state transition for each cell (e.g., SCell or SCell of the MCG or the SCG) may be performed as below.
      The cell or the BWP in the active state is transitioned to the active state or is maintained.
      The cell or the BWP in the inactive state is transitioned to then active state.
When the reserved bit (R bit) is configured as 1 (or 1), the 1-bit indicator indicating the identifier of each cell (SCell) may be defined and used as below. In another method, a logical identifier may be newly defined, a new MAC CE may be defined and may be defined and used as below. In another method, when the reserved bit (e.g., R field) is configured as 1 (or 0), it may mean an indication to activate or resume the cell group (e.g., SCG). For example, the cell or the BWP or the cell group in the active or resumed state may be transitioned to then active state or may be maintained, and the cell or the BWP or the cell group in the inactive state (e.g., suspended state) may be transitioned to the active state. The indicator may be indicated to a higher layer.
   When the 1-bit indicator is configured as 0 (or 1), state transition for each cell (e.g., SCell or SCell of the MCG or the SCG) or the BWP may be performed as below.
      The cell or the BWP in the inactive state is transitioned to the inactive state or is maintained.
      The cell or the BWP in the active state is transitioned to the inactive state.
   When the 1-bit indicator is configured as 1, state transition for each cell (e.g., SCell or SCell of the MCG or the SCG) or the BWP may be performed as below.
      The cell or the BWP in the active state is transitioned to the active state or is maintained.
      The cell or the BWP in the inactive state is transitioned to the active state.

In the above case, for example, the function of the MAC CE may be variously extended and designed to indicate state transition or switching of a cell or a BWP, and may be applied to various embodiments of the disclosure. For example, new MAC control information may be designed, a cell group identifier, and a cell identifier, a BWP identifier, or bitmap information may be included in the MAC control information, to indicate activation (resumption) or hibernation (or suspension) or deactivation (or suspension) of a cell group or a cell or a BWP.

In the disclosure, hereinafter, a procedure of reporting a power headroom will now be described.

Embodiment 1 of reporting a power headroom is as below.

In Embodiment 1 of the disclosure, a power headroom reporting procedure may be used to provide the following information to a BS (serving gNB) that serves a UE. In the above case, a power headroom may indicate a difference between maximum transmit power (or calculated or nominal maximum transmit power) that may be transmitted by the UE in each activated serving cell (PCell or SCell or PSCell or SPCell) and power measured for UL data transmission (UL-SCH) or SRS transmission, or may indicate a difference between maximum transmit power that may be transmitted by the UE and power measured for PUCCH transmission and UL data transmission in an SPCell (PCell or PSCell) of another MAC layer (e.g., LTE MAC or E-UTRA MAC). The power headroom may be reported to the BS by configuring a power headroom value in MAC control information by using the power headroom reporting procedure and transmitting the MAC control information through a UL transport resource.
A type 1 power headroom is a difference between maximum transmit power (or calculated or nominal maximum transmit power) that may be transmitted by the UE for each activated serving cell (PCell, SCell, PSCell, or SPCell) and power measured for UL data transmission (UL-SCH), and may be reported.
A type 2 power headroom is a difference between maximum transmit power (or calculated or nominal maximum transmit power) that may be transmitted by the UE and power measured for PUCCH transmission or UL data transmission (UL-SCH) in the SpCell (PCell or PSCell) of another MAC layer (e.g., when dual connectivity is configured, LTE MAC or E-UTRA MAC), and may be reported.
A type 3 power headroom is a difference between maximum transmit power (or calculated or nominal maximum transmit power) that may be transmitted by the UE for each activated serving cell (PCell, SCell, PSCell, or SpCell) and power measured for SRS transmission, and may be reported.

The UE may receive configuration information for power headroom reporting through an RRC message (e.g., RRCReconfiguration), and an RRC layer may adjust a power headroom reporting procedure by using the following parameters.
Timer value (phr-PeriodicTimer) for periodically reporting a power headroom; for example, when a periodic power headroom reporting timer expires, the power headroom reporting procedure may be triggered.
Timer value (phr-ProhibitTimer) for prohibiting power headroom reporting: For example, when a power headroom reporting prohibit timer is running, the power headroom reporting procedure may not be triggered.
Threshold value (phr-Tx-PowerFactorChange) for triggering power headroom reporting;
Indicator (phr-Type2OtherCell) indicating type 2 power headroom reporting considering another cell or MAC layer;
Indicator (phr-ModeOtherCG) indicating power headroom reporting considering another cell group;
Indicator (multiplePHR) indicating multiple power headroom reportings.

The parameters may be configured via the RRC message (e.g., RRCReconfiguration) as shown in FIG. 1F.

The power headroom reporting procedure may be triggered when one event occurs or one condition is satisfied from among the following conditions.
When the power headroom reporting prohibit timer (phr-ProhibitTimer) expires or has expired, and pathloss is changed by a threshold value (phr-Tx-PowerFactorChange) dB configured in the RRC message for at least one activated serving cell of a certain MAC layer, the power headroom reporting procedure may be triggered. The pathloss may be used as a pathloss reference value when a MAC layer has (or receives) a UL transport resource for new transmission after a power headroom last transmitted by the MAC layer.
When the periodic power headroom reporting timer expires, the power headroom reporting procedure may be triggered.
When a power headroom reporting function is configured or reconfigured by a higher layer (e.g., RRC layer), the power headroom reporting procedure may be triggered. The configuration or reconfiguration may not be used to deactivate the power headroom reporting function.
When a certain cell in which a UL of a certain MAC layer is configured is activated, the power headroom reporting procedure may be triggered.
When a PSCell is added or newly added or modified (or when dual connectivity is configured, and a PSCell of an SCG is newly added or modified), the power headroom reporting procedure may be triggered.
When the power headroom reporting prohibit timer (phr-ProhibitTimer) expires or has expired, and a MAC layer has (or receives) an UL transport resource for new transmission, if the following condition is true or satisfied for a certain activated serving cell in which a UL of a certain MAC layer is configured, the power headroom reporting procedure may be triggered.
   According to the condition, when there is a UL transport resource allocated for PUCCH transmission or transmission in the cell, and the MAC layer has a UL resource for PUCCH transmission or transmission in the cell, if power backoff required for power management (e.g., to reduce interference of another frequency or avoid harm to human body) for the cell after a last transmitted power headroom is changed by a threshold value (phr-Tx-PowerFactorChange) dB configured in the RRC message, the power headroom reporting procedure may be triggered.

In the disclosure, when one or more events occurs or one or more conditions are satisfied from among the conditions proposed above and thus the power headroom reporting procedure is triggered, a MAC layer may operate as below

When the MAC layer has or receives a UL allocated for new transmission, the MAC layer may operate as below.

1> When the UL transport resource after a last MAC reset procedure is a first UL transport resource allocated for new transmission.
2> the periodic power headroom reporting timer for periodically reporting a power headroom starts.

1> When it is decided (or determined) that a power headroom or a power headroom reporting procedure has been triggered and has not been cancelled, and

1> when the allocated UL transport resource may include MAC control information (MAC CE or MAC control element) or its subheader (e.g., MAC subheader) for power headroom reporting configured to be transmitted by the MAC layer or may be transmitted via the transport resource as a result of a logical channel prioritization (LCP) procedure (e.g., procedure of allocating a UL transport resource to data or MAC control information),
2> when an indicator (multiplePHR) indicating multiple power headroom reportings is configured as TRUE (or configured to report),
   3> for each activated serving cell connected to a certain MAC layer, or configured in a certain MAC layer and configured with a UL,
      4> a value of a type 1 power headroom or a type 3 power headroom for a UL carrier (or frequency) corresponding to the cell is obtained (or calculated).
      4> When the MAC layer has or receives a UL transport resource allocated for transmission for the serving cell,
      4> alternatively, when another MAC layer is configured, the other MAC layer has or receives a UL transport resource allocated for transmission for the serving cell, and an indicator (phr-ModeOtherCG) indicating power headroom reporting considering another cell group by a higher layer (RRC layer) is configured as Real (or configured to report as a real value),
         5> a maximum transmit power value (or power value required for power headroom calculation) corresponding to the serving cell is obtained from a physical (PHY) layer.
   3> When an indicator (phr-Type2OtherCell) indicating type 2 power headroom reporting considering another cell or MAC layer is configured as TRUE (or is configured to report);
      4> when another MAC layer is an E-UTRA MAC layer,
         5> a value for type 2 power headroom reporting for an SpCell of the other MAC layer is obtained (or calculated).
         5> When an indicator (phr-ModeOtherCG) indicating power headroom reporting considering another cell group by a higher layer (RRC layer) is configured as Real (or is configured to report as a real value),
         6> a maximum transmit power value (or power value required for power headroom calculation) for an SPCell of the other MAC layer (E-UTRA MAC layer) is obtained from a physical layer.
   3> A multiplexing and reassembly procedure (multiplexing and assembly procedure of the MAC layer) for generating and transmitting MAC control information reporting a plurality of power headrooms based on values reported from a physical layer is indicated.
2> When an indicator (multiplePHR) indicating multiple power headroom reportings is not configured as TRUE (or is not configured to report), or when one power headroom reporting is indicated, or if one power headroom reporting format is used,
   3> a type 1 power headroom value for a UL carrier (or frequency) of the serving cell (or PCell) is obtained (or calculated) from a physical layer.
   3> A maximum transmit power value (or power value required for power headroom calculation) for the serving cell (or PCell) is obtained from a physical layer.
   3> A multiplexing and reassembly procedure (multiplexing and assembly procedure of the MAC layer) for generating and transmitting MAC control information reporting one power headroom based on values reported from a physical layer is indicated.
2> The timer for periodically reporting a power headroom starts or restarts.
2> The timer for prohibiting power headroom reporting starts or restarts.
2> All triggered power headrooms or power headroom reporting procedures are cancelled.

According to the power headroom reporting procedure proposed in the disclosure, the UE reports a power headroom to the BS for each cell, such that the BS may adjust or manage UL transmit power of the UE. However, in a case of a cell (SCell) or a serving cell in which a dormant BWP according to the disclosure is configured, or a suspended (or deactivated) cell group or cell, when a current or activated BWP (or DL BWP) of an activated serving cell is a dormant BWP, or when it is activated to a BWP indicated by a dormant BWP indicator, or when a cell group is a suspended (or deactivated) cell (e.g., PSCell or SCell), even if a power headroom is reported, UL data transmission or PUCCH transmission is impossible in the dormant BWP or the suspended (or deactivated) cell group or cell, and thus unnecessary power headroom reporting may be performed.

Accordingly, in the disclosure, in order to reduce unnecessary processing load on the UE and prevent waste of a transport resource due to unnecessary power headroom reporting, the UE may first determine whether a cell is activated or deactivated, and may perform a procedure of determining, for an activated cell, whether an activated BWP (e.g., DL BWP) of the activated cell is a dormant BWP (or BWP having a dormant BWP identifier configured in the RRC message) or is not a dormant BWP (or not a BWP having a dormant BWP identifier configured in the RRC message), or whether a cell group or cell (e.g., PSCell) is suspended (or deactivated) or activated (or resumed). In another method, the UE may first determine whether a cell is activated or deactivated, and may perform a procedure of determining, for an activated cell when a dormant BWP is configured (e.g., when a dormant BWP identifier is configured for the cell in the RRC message), whether an activated BWP (e.g., DL BWP) of the activated cell is a dormant BWP (or BWP having a dormant BWP identifier configured in the RRC message) or is not a dormant BWP (or not a BWP having a dormant BWP identifier configured in the RRC message), and for a cell in which a dormant BWP is not configured, the procedure of identifying an activated BWP may be omitted (or may not be performed).

In a case of a cell (SCell) or a serving cell in which a dormant BWP is configured in the identifying procedure, when a current or activated BWP (or DL BWP) of an activated serving cell is a dormant BWP, or when it is activated to a BWP indicated by a dormant BWP identifier, or when a cell group or a cell (e.g., PSCell or SCell) is suspended (or deactivated), the power headroom reporting procedure may not be triggered, and even if the power headroom reporting procedure is triggered by another cell, a power headroom for the cell may not be reported. In another method, in a case of a cell (SCell) or a serving cell in which a dormant BWP is configured, only when a current or activated BWP (or DL BWP) of an activated serving cell is not a dormant BWP, or when it is not activated to a BWP indicated by a dormant BWP identifier, or when a cell group or a cell (e.g., PSCell or SCell) is not suspended (or is not deactivated, or is activated, or is resumed), the power headroom reporting procedure may be triggered, and alternatively, even if the power headroom reporting procedure is triggered by another cell, only when a current or activated BWP (or DL BWP) of an activated serving cell is not a dormant BWP, or when it is not activated to a BWP indicated by a dormant BWP identifier, or when a cell group or a cell (e.g., PSCell or SCell) is not suspended (or not deactivated, or is activated, or is resumed), a power headroom may be reported. Accordingly, the procedure proposed in the disclosure may reduce unnecessary processing load, and may prevent waste of a transport resource due to unnecessary power headroom reporting. A particular embodiment of the proposed procedure will now be described in Embodiment 2 of the disclosure in which a dormant BWP below is considered.

In Embodiment 2 of the disclosure in which the dormant BWP below is considered, a power headroom reporting procedure may be used to provide the following information to the BS (serving gNB) that serves the UE. A power headroom may indicate a difference between maximum transmit power (or calculated or nominal maximum transmit power) that may be transmitted by the UE in each activated serving cell (PCell, SCell, PSCell, or SPCell) and power measured for UL data transmission (UL-SCH) or SRS transmission, or may indicate a difference between maximum transmit power that may be transmitted by the UE and power measured for PUCCH transmission and UL data transmission in an SPCell (PCell or PSCell) of another MAC layer (e.g., LTE MAC or E-UTRA MAC). The power headroom may be reported to the BS by configuring a power headroom value in MAC control information by the power headroom reporting procedure and transmitting the MAC control information via a UL transport resource.
A type 1 power headroom is a difference between maximum transmit power (or calculated or nominal maximum transmit power) that may be transmitted by the UE for each activated serving cell (PCell, SCell, PSCell, or SpCell) and power measured for UL data transmission (UL-SCH), and may be reported.
A type 2 power headroom is a difference between maximum transmit power (or calculated or nominal maximum transmit power) that may be transmitted by the UE and power measured for PUCCH transmission or UL data transmission (UL-SCH) in the SpCell (PCell or PSCell) of another MAC layer (e.g., when dual connectivity is configured, LTE MAC or E-UTRA MAC), and may be reported.
A type 3 power headroom is a difference between maximum transmit power (or calculated or nominal maximum transmit power) that may be transmitted by the UE for each activated serving cell (PCell, SCell, PSCell, or SpCell) and power measured for SRS transmission, and may be reported.

Embodiment 2 of a procedure of reporting a power headroom considering a dormant BWP according to the disclosure is as below.

In Embodiment 2 of the disclosure, the UE may receive configuration information for power headroom reporting via an RRC message (e.g., RRCReconfiguration), and an RRC layer may adjust a power headroom reporting procedure by using the following parameters.
Timer value (phr-PeriodicTimer) for periodically reporting a power headroom; for example, when a periodic power headroom reporting timer expires, the power headroom reporting procedure may be triggered.
Timer value (phr-ProhibitTimer) for prohibiting power headroom reporting: For example, when a power headroom reporting prohibit timer is running, the power headroom reporting procedure is not triggered.
Threshold value (phr-Tx-PowerFactorChange) for triggering power headroom reporting;
Indicator (phr-Type2OtherCell) indicating type 2 power headroom reporting considering another cell or MAC layer;
Indicator (phr-ModeOtherCG) indicating power headroom reporting considering another cell group;
Indicator (multiplePHR) indicating multiple power headroom reportings.
A cell group state indicator (e.g., an indicator indicating whether a cell group state is activated or inactivated or suspended).
An indicator indicating whether to trigger a power headroom in a cell group.

The parameters may be configured through the RRC message (e.g., RRCReconfiguration) as shown in FIG. 1F of the disclosure.

In Embodiment 2 of a procedure of reporting a power headroom considering a dormant BWP according to the disclosure, the power headroom reporting procedure may be triggered when one event occurs or one condition is satisfied from among the following conditions.
When the power headroom reporting prohibit timer (phr-ProhibitTimer) expires or has expired, a BWP (or DL BWP) of an activated serving cell of a certain MAC layer is activated, and pathloss is changed by a threshold value (phr-Tx-PowerFactorChange) dB configured in the RRC message for at least one activated serving cell in which an activated BWP (or DL BWP) is not a dormant BWP or an activated BWP (or DL BWP) or a current BWP (or activated current DL BWP) of an activated serving cell is not a dormant BWP, the power headroom reporting procedure may be triggered. The pathloss may be used as a pathloss reference value when a MAC layer has (or receives) a UL transport resource for new transmission after a power headroom last transmitted by the MAC layer.
When the periodic power headroom reporting timer expires, the power headroom reporting procedure may be triggered.
When a power headroom reporting function is configured or reconfigured by a higher layer (e.g., RRC layer), the power headroom reporting procedure may be triggered. The configuration or reconfiguration may not be used to deactivate the power headroom reporting function.
When a certain cell in which a UL of a certain MAC layer is configured is activated and a first active DL BWP (or first active DL BWP identifier (firstActiveDownlinkBWP-Id)) configured in the cell is not configured as a dormant BWP, the power headroom reporting procedure may be triggered.
When a PSCell or a cell group or a cell is added or newly added or modified (or when dual connectivity is configured and a PSCell of an SCG is newly added or modified), or when the PSCell or the cell group or the cell is activated or resumed, the power headroom reporting procedure may be triggered.
In another method, when a PSCell or a cell group or a cell, which is in an active state, is added or newly added or modified (e.g., when, in an RRC message, a cell group state is configured as the active state or the cell group is not configured as an inactive state or an indicator (or an indicator (e.g., ReconfigurationWithSync) to trigger a random access) indicating to activate the cell group is included), the power headroom reporting procedure may be triggered. For example, when dual connectivity is configured and a PSCell of SCG, which is in an active state, is newly added or modified (e.g., when a cell group state is configured as an active state or the cell group is not configured as an inactive state or an indicator indicating to activate the cell group is included) or when the PSCell or the cell group or the cell is activated, the power headroom reporting procedure may be triggered. Therefore, when a PSCell or a cell group or a cell, which is in an inactive state, is added or newly added or modified (e.g., when, in an RRC message, a cell group state is configured as the inactive state or the cell group is not configured as an active state or an indicator indicating to activate the cell group is not included), the power headroom reporting procedure may be unnecessarily triggered.
In another method, when a PSCell or a cell group or a cell is activated (e.g., when, by DCI of a PDCCH or MAC control information or an RRC message from a BS, a cell group state is configured as an active state or the cell group is not configured as an inactive state or an indicator (or an indicator to trigger a random access) indicating to activate the cell group is included), the power headroom reporting procedure may be triggered.
In another method, when a PSCell or a cell group or a cell is activated from an inactive state (or a suspended state or a dormant state) (e.g., when a cell group state is configured as an active state or the cell group is not configured as an inactive state or an indicator (or an indicator to trigger a random access) indicating to activate the cell group is included), the power headroom reporting procedure may be triggered. For example, in a case where the PSCell or the cell group or the cell is in an inactive state or a suspended state and then is activated from the inactive state (or a suspended state or a dormant state) by receiving, by the UE from the BS, DCI of a PDCCH or MAC control information or an RRC message indicating to activate the PSCell or the cell group or the cell, the power headroom reporting procedure may be triggered. By doing so, it is possible to prevent an unnecessary power headroom reporting procedure from being triggered when the PSCell or the cell group or the cell in the active state is reactivated. That is, when the PSCell or the cell group or the cell is in the active state if the UE receives an indication indicating to activate the PSCell or the cell group or the cell from the BS via DCI of a PDCCH or MAC control information or an RRC message, the power headroom reporting procedure may be unnecessarily triggered.
In another method, when a PSCell is added or newly added or modified (or when dual connectivity is configured or a PSCell of an SCG is newly added or modified), or when the PSCell or the cell group or the cell is activated or resumed, if a first active DL BWP (or first active DL BWP identifier (firstActiveDownlinkBWP-Id)) configured in the cell is not configured as a dormant BWP, the power headroom reporting procedure may be triggered.
When the power headroom reporting prohibit timer (phr-ProhibitTimer) expires or has expired, and a MAC layer has (or receives) an UL transport resource for new transmission, if the following condition is true or satisfied for a certain activated serving cell in which a UL of a certain MAC layer is configured, the power headroom reporting procedure may be triggered.
   According to the condition, when there is a UL transport resource allocated for PUCCH transmission or transmission in the cell, and the MAC layer has a UL resource for PUCCH transmission or transmission in the cell, if power backoff required for power management (e.g., to reduce interference of another frequency or avoid harm to human body) for the cell after a last transmitted power headroom is changed by a threshold value (phr-Tx-PowerFactorChange) dB configured in the RRC message, the power headroom reporting procedure may be triggered.
When a UL BWP is activated (or when activated to a first active UL BWP), or when a DL BWP (or activated BWP or current BWP (or DL BWP)) of a certain activated SCell configured with a UL in a certain MAC layer is switched or activated from a dormant BWP to a normal BWP (or BWP other than the dormant BWP (non-dormant BWP)), or a non-dormant BWP first activated from dormancy configured in the RRC message (BWP indicated by firstActiveNonDormantDownlinkBWP-Id or BWP identifier other than the dormant BWP), the power headroom reporting procedure may be triggered.
When a DL BWP (or activated BWP or current BWP (or DL BWP)) of a certain activated SCell configured with a UL in a certain MAC layer is activated to a BWP indicated by a BWP identifier (firstOutsideActiveTimeBWP-Id or firstWithinActiveTimeBWP-Id) first activated from dormancy configured in the RRC message, the power headroom reporting procedure may be triggered. The activation of the BWP may be indicated by DCI of a PDCCH.
When a UL BWP is activated (or when is activated to a first active UL BWP), or when a DL BWP (or activated BWP or current BWP (or DL BWP)) of a certain activated SCell configured with the UL in a certain MAC layer is switched or activated from a dormant BWP to a normal BWP (or BWP other than the dormant BWP (non-dormant BWP)) or a non-dormant BWP first activated from dormancy configured in the RRC message (BWP indicated by firstActiveNonDormantDownlinkBWP-Id, firstOutsideActiveTimeBWP-Id, or firstWithinActiveTimeBWP-Id, or BWP identifier other than the dormant BWP), or when first SRS configuration information or second SRS configuration information is configured (or when an activated BWP (or DL BWP) of an activated serving cell or a current BWP (or activated current DL BWP) is the dormant BWP and the first SRS configuration information or the second SRS configuration information is configured), the power headroom reporting procedure may be triggered.
When the power headroom reporting prohibit timer (phr-ProhibitTimer) expires or has expired, a BWP (or DL BWP) of an activated serving cell of a certain MAC layer is activated, and an activated BWP (or DL BWP) is not a dormant BWP, or when an activated BWP (or DL BWP) or a current BPW (or activated current BWP) of an activated serving cell is not a dormant BWP, or when first SRS configuration information or second SRS configuration information is configured (or when an activated BWP (or DL BWP) or a current BWP (or activated current DL BWP) of an activated serving cell is a dormant BWP and first SRS configuration information or second SRS configuration information is configured), if pathloss is changed by a threshold value (phr-Tx-PowerFactorChange) dB configured in the RRC message for at least one activated serving cell, the power headroom reporting procedure may be triggered. The pathloss may be used as a pathloss reference value when a MAC layer has (or receives) a UL transport resource for new transmission after a last transmitted power headroom in the MAC layer.

In the disclosure, when one or more events occur or one or more conditions are satisfied from among the conditions and thus the power headroom reporting procedure is triggered, a MAC layer may operate as below.

When the MAC layer has or receives a UL allocated for new transmission, the MAC layer may operate as follows.

1> When the UL transport resource after a last MAC reset procedure is a first UL transport resource allocated for new transmission,
2> the periodic power headroom reporting timer for periodically reporting a power headroom starts.

1> When it is decided (or determined) that the power headroom reporting procedure has been triggered and has not been cancelled, and

1> when the allocated UL transport resource may include MAC control information (MAC CE or MAC control element) or its subheader (e.g., MAC subheader) for power headroom reporting configured to be transmitted by the MAC layer or may be transmitted via the transport resource as a result of an LCP procedure (e.g., procedure of allocating a UL transport resource to data or MAC control information);
2> when an indicator (multiplePHR) indicating multiple power headroom reportings is configured as TRUE (or configured to report);
   3> for each activated serving cell connected to a certain MAC layer, or configured in a certain MAC layer and configured with a UL,
   3> when a BWP (or DL BWP) of the activated serving cell is activated and an activated BWP (or DL BWP) is not a dormant BWP, or when an activated BWP (or DL BWP) or a current BWP (or activated current DL BWP) of the activated serving cell is not a dormant BWP, or when the cell group or cell (e.g., PSCell) is not suspended or is not deactivated.
   3> Alternatively, when a BWP (or DL BWP) of the activated serving cell is activated and an activated BWP (or DL BWP) is not a dormant BWP, or when an activated BWP (or DL BWP) or a current BWP (or activated current DL BWP) of the activated serving cell is not a dormant BWP, or when the cell group or cell (e.g., PSCell) is not suspended or is not deactivated, or when first SRS configuration information or second SRS configuration information is configured (or when an activated BWP (or DL BWP) or current BWP (or activated current DL BWP of the activated serving cell is a dormant BWP and first SRS configuration information or second SRS configuration information is configured),
      4> a value of a type 1 power headroom or a type 3 power headroom for a UL carrier (or frequency) corresponding to the cell is obtained (or calculated).
      4> When the MAC layer has or receives a UL transport resource allocated for transmission for the serving cell,
      4> alternatively, when another MAC layer is configured, the other MAC layer has or receives a UL transport resource allocated for transmission for the serving cell, and an indicator (phr-ModeOtherCG) indicating power headroom reporting considering another cell group by a higher layer (RRC layer) is configured as Real (or configured to report as a real value),
         5> a maximum transmit power value (or power value required for power headroom calculation) corresponding to the serving cell is obtained from a physical layer.
   3> When an indicator (phr-Type2OtherCell) indicating type 2 power headroom reporting considering another cell or MAC layer is configured as TRUE (or is configured to report);
      4> when another MAC layer is an E-UTRA MAC layer,
         5> a value for type 2 power headroom reporting for a SPCell of the other MAC layer is obtained (or calculated).
         5> When an indicator (phr-ModeOtherCG) indicating power headroom reporting considering another cell group by a higher layer (RRC layer) is configured as Real (or is configured to be reported as a real value),
         6> a maximum transmit power value (or power value required for power headroom calculation) for a SpCell of the other MAC layer (E-UTRA MAC layer) is obtained from a physical layer.
   3> A multiplexing and reassembly procedure (multiplexing and assembly procedure of the MAC layer) for generating and transmitting MAC control information reporting a plurality of power headrooms based on values reported from a physical layer is indicated.
2> When an indicator (multiplePHR) indicating multiple power headroom reportings is not configured as TRUE (or is not configured to report), or when one power headroom reporting is indicated, or when one power headroom reporting format is used,
   3> a type 1 power headroom value for a UL carrier (or frequency) of the serving cell (or Pcell) is obtained (or calculated) from a physical layer.
   3> A maximum transmit power value (or power value required for power headroom calculation) for the serving cell (or Pcell) is obtained from a physical layer.
   3> A multiplexing and reassembly procedure (multiplexing and assembly procedure of the MAC layer) for generating and transmitting MAC control information reporting one power headroom based on values reported from a physical layer is indicated.
2> The timer for periodically reporting a power headroom starts or restarts.
2> The timer for prohibiting power headroom reporting starts or restarts.
2> All triggered power headrooms or power headroom reporting procedures are cancelled.

In the disclosure, a serving cell or a cell may indicate a PCell or a PSCell or an SCell.

FIG. 1I illustrates a flowchart of a signaling procedure of configuring or releasing dual connectivity, or activating or resuming or suspending or deactivating an SCG configured with dual connectivity, in a next-generation mobile communication system of the disclosure.

In FIG. 1I, a first signaling procedure of configuring or releasing dual connectivity, or activating or resuming or suspending or deactivating an SCG configured with dual connectivity is as below.

Referring to FIG. 1I, a UE may configure an RRC connection with a network or a BS as shown in FIG. 1F of the disclosure, and may perform data transmission or reception with the BS (e.g., MCG, master node (MN), or cells (PCells or SCells) of MCG).

In the above case, the BS may configure dual connectivity for the UE for a certain reason (e.g., when a high data rate is required, at a request of the UE (1i-05), or when a high QoS requirement should be satisfied). For example, the UE may transmit, to the BS, a request to configure or release, or activate or deactivate, or resume or suspend dual connectivity, a cell group (e.g., SCG), or a cell, and a message of the request may include a frequency (or channel) measurement result report or a cell group identifier or cell identifiers or measurement results (1i-05). In another method, the BS may determine whether to configure or release or add or deactivate or activate or resume or modify or reconfigure or suspend dual connectivity, a cell group (e.g., SCG), or a cell, by considering the amount of DL (or UL) data or the amount of buffer.

In the above case, a master BS (MN or MCG) may receive a frequency or channel measurement report for a frequency or a channel received from the UE, and may determine a secondary BS (secondary node (SN) or SCG) for configuring dual connectivity, based on the measurement report. Alternatively, the master BS may determine whether to configure or release or add or deactivate or activate or resume or modify or reconfigure or suspend dual connectivity or a cell group (e.g., SCG) or a cell, by considering the amount of DL (or UL) data or the amount of buffer. In the above case, in order to configure or release or add or deactivate or activate or resume or modify or reconfigure or suspend dual connectivity or a cell group (e.g., SCG) or a cell to the determined secondary BS, the master BS may transmit, to the secondary BS, a request message for requesting to configure or add to the SCG of the UE through an Xn interface (e.g., interface between BSs) or an Sn interface (interface between a BS and an AMF or a UMF, or interface between BSs) (1i-10). In order to configure or release or add or deactivate or activate or resume or modify or reconfigure or suspend dual connectivity or a cell group (e.g., SCG) or a cell for the secondary BS, each separate new request message may be defined and used, and in another method, and a new indicator may be defined in an existing message (e.g., SN addition request message or SN modification request message or SN release request message) to indicate (or request) to configure or release or add or deactivate or activate or resume or modify or reconfigure or suspend a cell group (e.g., SCG) or a cell. The request message may include information such as cell group configuration information (e.g., MCG configuration information) currently configured in the UE or bearer configuration information or capability information of the UE or frequency (or channel) measurement result information of the UE, and by referring to the above information, the secondary BS may configure SCG configuration information or bearer configuration information to correspond to UE capability or not to exceed UE capability or to match bearer configuration information of the MCG when the SCG is configured for the UE.

In the above case, when the secondary BS having received the request message 1i-10 rejects the request message, the secondary BS may configure a rejection message and may transmit the rejection message to the master BS through the Xn interface (e.g., interface between BSs) or the Sn interface (interface between a BS and an AMF or a UMF, or interface between BSs) (1i-15). When the secondary BS accepts the request message, the secondary BS may transmit a request acceptance message including configuration information or an indicator for configuring or releasing or adding or deactivating or activating or resuming or modifying or reconfiguring or suspending dual connectivity or a cell group (e.g., SCG) or a cell through the Xn interface (e.g., interface between BSs) or the Sn interface (interface between a BS and an AMF or a UMF, or interface between BSs) to the master BS (1i-15). The request acceptance message may include at least some of the following information.
The same identifier as a message identifier included in the request message, or an indicator indicating that a request in the request message is accepted.
Configuration information or indicator (e.g., configuration information or indicator for the MCG) for configuring or releasing or adding or deactivating or activating or resuming or modifying or reconfiguring or suspending dual connectivity or a cell group (e.g., SCG) or a cell.
First RRC message (e.g., RRCReconfiguration message) including configuration information or an indicator for configuring or releasing or adding or deactivating or activating or resuming or modifying or reconfiguring or suspending dual connectivity a cell group (e.g., SCG) or a cell.
The first RRC message may include at least some of the following information.
   First RRC message identifier (e.g., rrc-Transaction identifier) for identifying the first RRC message. Because the UE and the BS (e.g., secondary BS) transmit or receive a plurality of RRC messages therebetween, an identifier for identifying each RRC message may be included in the RRC message. For example, the same first RRC identifier may be included in an RRC message (e.g., RRCReconfiguration) transmitted by a transmitting end, or an RRC message (e.g., RRCReconfigurationComplete) corresponding to the RRC message (e.g., RRCReconfiguration) transmitted by a receiving end, or an RRC message corresponding to the RRC message transmitted by the transmitting end.
   Configuration information or an indicator (e.g., configuration information or an indicator for the UE) for configuring or releasing or adding or deactivating or activating or resuming or modifying or reconfiguring or suspending dual connectivity or a cell group (e.g., SCG) or a cell.
   Indicator indicating a state of a cell group (e.g., active or inactive or suspended or resumed).
   Cell group identifier for identifying cell groups. The cell group identifier may be allocated by the master BS, or one identifier from among already preset identifiers may be allocated by the secondary BS.
   Cell group or cell configuration information.
   Bearer configuration information. For example, indicator information indicating an operation of a protocol layer (e.g., SDAP layer or PDCP layer or RLC layer or MAC layer) of each bearer (e.g., PDCP suspension indicator or PDCP reestablishment indicator or PDCP data recovery indicator or RLC reestablishment indicator or MAC partial reset indicator or MAC reset indicator or indicator triggering new operation).
   In the above case, when configuration information or an indicator for configuring or adding or activating or resuming or modifying or reconfiguring dual connectivity or a cell group (e.g., SCG) or a cell is included, a first indicator (e.g., mobilityControlInfor or ReconfigurationWithSync) may also be included. However, in the above case, when configuration information or an indicator for releasing or deactivating or reconfiguring or suspending dual connectivity or a cell group (e.g., SCG) or a cell is included, the first indicator (e.g., mobilityControlInfor or ReconfigurationWithSync) may not be included. In the above case, the first indicator may be an indicator to trigger a random access procedure in the cell group or the cell, or an indicator to perform signal synchronization with a new cell, or an indicator indicating to perform frequency shift of the UE, or an indicator indicating to modify the cell group (or cell).
   When configuration information or an indicator for configuring or adding or activating or resuming or modifying or reconfiguring dual connectivity or a cell group (e.g., SCG) or a cell is included, random access configuration information may also be included. However, in the above case, when configuration information or an indicator for releasing or deactivating or reconfiguring or suspending dual connectivity or a cell group (e.g., SCG) or a cell is included, the random access configuration information may not be included. The random access configuration information may include random access transport resource information (time or frequency transport resource) for preamble transmission or designated preamble information for the cell group or cell.
   Time information indicating when to activate or resume or deactivate or suspend dual connectivity, a cell group (e.g., SCG) or a cell (PSCell or SCG SCell) (e.g., information indicating a timing (e.g., X), a time unit, a subframe, a time slot, or a symbol unit, for example, when the message is received in an n^{th} time unit, time information indicating whether to activate or resume or deactivate or suspend a cell in an n+X^{th} time unit).

In the above case, when the master BS receives the request acceptance message 1i-15, the master BS may identify the request acceptance message, and may transmit, to the UE, a second RRC message 1i-20 (e.g., RRCReconfiguration) including information included in the request acceptance message (e.g., first RRC message included in the request acceptance message 1i-15). The second RRC message may include at least some of the following information.
Second RRC message identifier (e.g., rrc-Transaction identifier) for identifying the second RRC message. Because the UE and the BS (e.g., master BS) transmit or receive a plurality of RRC messages therebetween, the RRC message may include an identifier for identifying each RRC message. For example, the same second RRC identifier may be included in an RRC message (e.g., RRCReconfiguration) transmitted by a transmitting end, or an RRC message (e.g., RRCReconfigurationComplete) corresponding to the RRC message (e.g., RRCReconfiguration) transmitted by a receiving end, or an RRC message corresponding to the RRC message transmitted by the transmitting end.
First RRC message included in the request acceptance message 1i-15.
Configuration information or an indicator (e.g., configuration information or an indicator for the UE) for configuring or releasing or adding or deactivating or activating or resuming or modifying or reconfiguring or suspending dual connectivity or a cell group (e.g., SCG) or a cell.
Indicator indicating a state of a cell group (e.g., active or inactive or suspended or resumed).
Cell group identifier for identifying cell groups. The cell group identifier may be allocated by the master BS, or one identifier from among already promised identifiers may be allocated by the secondary BS.
Cell group or cell configuration information.
Bearer configuration information. For example, indicator information indicating an operation of a protocol layer (e.g., SDAP layer or PDCP layer or RLC layer or MAC layer) of each bearer (e.g., PDCP suspension indicator or PDCP reestablishment indicator or PDCP data recovery indicator or RLC reestablishment indicator or MAC partial reset indicator or MAC reset indicator or indicator to trigger new operation).
When configuration information or an indicator for configuring or adding or activating or resuming or modifying or reconfiguring dual connectivity or a cell group (e.g., SCG) or a cell is included, a first indicator (e.g., mobilityControlInfor or ReconfigurationWithSync) may also be included. When configuration information or an indicator for releasing or deactivating or reconfiguring or suspending dual connectivity or a cell group (e.g., SCG) or a cell is included, the first indicator (e.g., mobilityControlInfor or ReconfigurationWithSync) may not be included. In the above case, the first indicator may be an indicator to trigger a random access procedure in the cell group or the cell or an indicator to perform signal synchronization with a new cell or an indicator indicating to perform frequency shift of the UE or an indicator indicating to modify the cell group (or cell). In another method, the UE may perform PDCCH monitoring in the indicated or configured cell group or cell, and may trigger and perform a random access procedure according to an indication indicated in the PDCCH. For example, a higher layer (e.g., RRC layer) may transmit an indicator to trigger a random access procedure to a lower layer (e.g., MAC layer).
When configuration information or an indicator for configuring or adding or activating or resuming or modifying or reconfiguring dual connectivity or a cell group (e.g., SCG) or a cell is included, random access configuration information may also be included. When configuration information or an indicator for releasing, deactivating, reconfiguring, or suspending dual connectivity, a cell group (e.g., SCG), or a cell is included, the random access configuration information may not be included. The random access configuration information may include random access transport resource information (time or frequency transport resource) for preamble transmission or designated preamble information for the cell group or cell.
Time information indicating when to activate or resume or deactivate or suspend dual connectivity or a cell group (e.g., SCG) or a cell (PSCell or SCG SCell) (e.g., information indicating a timing (e.g., X), a time unit, a subframe, a time slot, or a symbol unit, for example, when the message is received in an n^{th} time unit, time information indicating whether to activate or resume or deactivate or suspend a cell in an n+X^{th} time unit).

In the above case, when the UE receives the second RRC message 1i-20, the UE may read and identify the second RRC message, or may read information included in the second RRC message (e.g., first RRC message included in the second RRC message) and may configure or add or modify or resume or suspend or deactivate dual connectivity or a cell group (e.g., SCG). Also, when a first indicator to trigger a random access procedure is included in the second RRC message or the first RRC message, or when a state indicator of the cell group indicates activation or resumption, the bearer configuration information or each configuration information of protocol layers configured above may be applied or set, or a random access procedure for the configured or indicated cell group or cell may be triggered. When a random access procedure is performed, if there is random access information in the RRC message or if there is stored random access information, the UE may perform a random access procedure (e.g., CFRA procedure (e.g., 4-step random access or 2-step random access)), based on the stored random access information or the random access information received in the RRC message or system information. When there is no random access information in the RRC message, the UE may perform a random access procedure (e.g., CBRA procedure (e.g., 4-step random access or 2-step random access)). In another method, the UE may perform PDCCH monitoring in the indicated or configured cell group or cell, and may trigger and perform a random access procedure according to an indication indicated in the PDCCH. For example, a higher layer (e.g., RRC layer) may transmit an indicator triggering a random access procedure to a lower layer (e.g., MAC layer). Also, when the second RRC message or the first RRC message does not include a first indicator to trigger a random access procedure, or when the cell group state indicates suspension or inactivation or release, the UE may store cell group configuration information corresponding to the cell group identifier or the RRC message.

The UE may receive the second RRC message 1i-20 or apply received configuration information, and may generate a third RRC message or a fourth RRC message and may transmit the third RRC message or the fourth RRC message to the BS (1i-25). The third RRC message may include at least some of the following information.
Second RRC message identifier having the same value as a second RRC message identifier included in the second RRC message.
Indicator or an identifier indicating that the second RRC message is successfully received.
Fourth RRC message including a response indicating the first RRC message generated and transmitted by the secondary BS is successfully received. The fourth RRC message may include at least some of the following information.
   First RRC message identifier having the same value as a first RRC message identifier included in the first RRC message.
   Indicator or an identifier indicating that the first RRC message is successfully received.
   Response indicator indicating that the first RRC message is successfully applied.

When the BS (e.g., master BS) receives the third RRC message, the BS may determine whether the third RRC message is a response message to the second RRC message via a second identifier. The BS may identify the fourth RRC message included in the third RRC message, may include the fourth RRC message in a configuration complete message indicating that a configuration is completed to an SCG BS, and may transmit the same to the secondary BS through the Xn interface (e.g., interface between BSs) or the Sn interface (interface between a BS and an AMF or a UMF, or interface between BSs) (1i-30). The configuration complete message may include at least some of the following information.
Fourth RRC message included in the third RRC message.
Indicator or an identifier indicating that a configuration (cell group addition or modification or release) or an indication (e.g., cell group activation or deactivation or suspension or resumption) indicated in the request acceptance message or the first RRC message is completed.

When the BS (e.g., secondary BS) receives the configuration complete message, the BS may read or identify the fourth RRC message included in the configuration complete message, and may determine whether the fourth RRC message is a response message to the first RRC message through a first identifier. It may be determined whether a configuration or an indication indicated by the BS is successfully completed. In the above case, when the secondary BS receives the configuration complete message or the fourth RRC message, the secondary BS may transmit, to the master BS, a response message indicating that the configuration complete message or the fourth RRC message is successfully received as a response.

FIG. 1J illustrates a flowchart of a second signaling procedure of configuring or releasing dual connectivity, or configuring or releasing or activating or resuming or suspending or deactivating an SCG configured with dual connectivity.

In FIG. 1J, a UE may configure an RRC connection with a network or a BS as shown in FIG. 1F of the disclosure, and may perform data transmission or reception with the BS (e.g., MCG, MN, or cells (PCells or SCells) of MCG).

In the above case, the BS may configure dual connectivity in the UE for a certain reason (e.g., when a high data rate is required, at a request of the UE (1j-05), or when a high QoS requirement should be satisfied). For example, the UE may transmit, to the BS, a request to configure, release, activate, deactivate, resume, or suspend dual connectivity, a cell group (e.g., SCG), or a cell, and a request message of the UE may include a frequency (or channel) measurement result report, or a cell group identifier, or cell identifiers, or measurement results (1j-05). In another method, the BS may determine whether to configure or release or add or deactivate or activate or resume or modify or reconfigure dual connectivity or a cell group (e.g., SCG) or a cell, by considering the amount of DL (or UL) data or the amount of buffer.

In the above case, a master BS (MN or MCG) may receive a frequency or channel measurement report for a frequency or a channel received from the UE, and may determine a secondary BS (SN or SCG) for configuring dual connectivity based on the measurement report. Alternatively, the master BS may determine whether to configure or release or add or deactivate or activate or resume or modify or reconfigure or suspend dual connectivity or a cell group (e.g., SCG) or a cell, by considering the amount of DL (or UL) data or the amount of buffer. In the above case, with respect to the determined secondary BS, in order to configure or release or add or deactivate or activate or resume or modify or reconfigure or suspend dual connectivity or a cell group (e.g., SCG) or a cell, the master BS may transmit a first RRC message to the UE (1j-10). In order to indicate to the UE to configure or release or add or deactivate or activate or resume or modify or reconfigure or suspend dual connectivity or a cell group (e.g., SCG) or a cell, each separate new request message may be defined and indicated in the first RRC message, and in another method, a new indicator may be defined in an existing message (e.g., RRCReconfiguration message or RRCResume message) to indicate (or request) to configure or release or add or deactivate or activate or resume or modify or reconfigure or suspend a cell group (e.g., SCG) or a cell. The first RRC message may include at least some of the following information.
First RRC message identifier (e.g., rrc-Transaction identifier) for identifying the first RRC message. Because the UE and the BS (e.g., master BS) transmit or receive a plurality of RRC messages therebetween, an identifier for identifying each RRC message may be included in the RRC message. For example, the same first RRC message identifier may be included in an RRC message (e.g., RRCReconfiguration) transmitted by a transmitting end, or an RRC message (e.g., RRCReconfigurationComplete) corresponding to the RRC message (e.g., RRCReconfiguration) transmitted by a receiving end, or an RRC message corresponding to the RRC message transmitted by the transmitting end.
Configuration information or an indicator (e.g., configuration information or an indicator for the UE) for configuring or releasing or adding or deactivating or activating or resuming or modifying or reconfiguring or suspending dual connectivity or a cell group (e.g., SCG) or a cell.
Indicator indicating a state of a cell group (e.g., active or inactive or suspended or resumed).
Cell group identifier for identifying cell groups. The cell group identifier may be allocated by the master BS, or one identifier from among already promised identifiers may be allocated by the secondary BS).
Cell group or cell configuration information.
Bearer configuration information. For example, indicator information indicating an operation of a protocol layer (e.g., SDAP layer or PDCP layer or RLC layer or MAC layer) of each bearer (e.g., PDCP suspension indicator or PDCP reestablishment indicator or PDCP data recovery indicator or RLC reestablishment indicator or MAC partial reset indicator or MAC reset indicator or indicator to trigger new operation).
When configuration information or an indicator for configuring or adding or activating or resuming or modifying or reconfiguring dual connectivity or a cell group (e.g., SCG) or a cell is included, a first indicator (e.g., mobilityControlInfor or ReconfigurationWithSync) may also be included. However, in the above case, when configuration information or an indicator for releasing or deactivating or reconfiguring or suspending dual connectivity or a cell group (e.g., SCG) or a cell is included, the first indicator (e.g., mobilityControlInfor or ReconfigurationWithSync) may not be included. In the above case, the first indicator may be an indicator to trigger a random access procedure in the cell group or the cell, or an indicator to perform signal synchronization with a new cell, or an indicator indicating to perform frequency shift of the UE, or an indicator indicating to modify the cell group (or cell). In another method, the UE may perform PDCCH monitoring in the indicated or configured cell group or cell, and may trigger and perform a random access procedure according to an indication indicated in the PDCCH. For example, a higher layer (e.g., RRC layer) may transmit an indicator to trigger a random access procedure to a lower layer (e.g., MAC layer).
When configuration information or an indicator for configuring or adding or activating or resuming or modifying or reconfiguring dual connectivity or a cell group (e.g., SCG) or a cell is included, random access configuration information may also be included. When configuration information or an indicator for releasing or deactivating or reconfiguring or suspending dual connectivity or a cell group (e.g., SCG) or a cell is included, the random access configuration information may not be included. The random access configuration information may include random access transport resource information (time or frequency transport resource) for preamble transmission or designated preamble information for the cell group or cell.
Time information indicating when to activate or resume or deactivate or suspend dual connectivity or a cell group (e.g., SCG) or a cell (PSCell or SCG SCell) (e.g., information indicating a timing (e.g., X), a time unit, a subframe, a time slot, or a symbol unit, for example, when the message is received in an n^{th} time unit, time information indicating whether to activate or resume or deactivate or suspend a cell in an n+X^{th} time unit).

In the above case, when the UE receives the first RRC message 1j-15, the UE may read and identify the first RRC message, and may configure or add or modify or resume or suspend or deactivate dual connectivity or a cell group (e.g., SCG). Also, when a first indicator to trigger a random access procedure is included in the first RRC message, or when a state indicator of the cell group indicates activation or resumption, the bearer configuration information or each configuration information of protocol layers configured above may be applied or set, or a random access procedure for the configured or indicated cell group or cell may be triggered. When the random access procedure is performed, if there is random access information in the RRC message or if there is stored random access information, the UE may perform a random access procedure (e.g., CFRA procedure (e.g., 4-step random access or 2-step random access)), based on the stored random access information, or the random access information received in the RRC message, or system information. When there is no random access information in the RRC message, the UE may perform a random access procedure (e.g., CBRA procedure (e.g., 4-step random access or 2-step random access)). In another method, the UE may perform PDCCH monitoring in the indicated or configured cell group or cell, and may trigger and perform a random access procedure according to an indication indicated in the PDCCH. For example, a higher layer (e.g., RRC layer) may transmit an indicator to trigger a random access procedure to a lower layer (e.g., MAC layer). Also, when the second RRC message or the first RRC message does not include a first indicator to trigger a random access procedure, or when the cell group state indicates suspension or inactivation or release, the UE may store cell group configuration information corresponding to the cell group identifier or the RRC message.

The UE may receive the first RRC message 1j-10 or apply received configuration information, and may generate a second RRC message and may transmit the second RRC message to the BS (1j-15). The second RRC message may include at least some of the following information.
First RRC message identifier having the same value as a first RRC message identifier included in the first RRC message.
Indicator or an identifier indicating that the first RRC message is successfully received.

In the above case, when the BS (e.g., master BS) receives the second RRC message, the BS may determine whether the second RRC message is a response message to the first RRC message via a first identifier. The BS may identify the first RRC message and may transmit, to the secondary BS, an indication message including an indication that a cell group has been configured or added or released or activated or resumed or suspended or deactivated to an SCG BS through an Xn interface (e.g., interface between BSs) or an Sn interface (interface between a BS and an AMF or a UMF, or interface between BSs) (1j-20). The indication message may include at least some of the following information.
Identifier for identifying the indication message.
Configuration information or an indicator (e.g., configuration information or an indicator for the SCG) indicating that dual connectivity or a cell group or a cell has been configured or released or added or deactivated or activated or resumed or modified or reconfigured or suspended.

In the above case, when the BS (e.g., secondary BS) receives the indication message, the BS may read or identify configuration information or a message included in the indication message, may generate an indication acknowledgement message as a response message to the indication message, and may transmit the indication acknowledgement message to the master BS (1j-25).
Identifier having the same value as an identifier included in the indication message.
Indicator or an identifier indicating that the indication message is successfully received.
Response indicator indicating that the indication message is successfully applied.

FIG. 1K illustrates a flowchart of a third signaling procedure of configuring or releasing dual connectivity, or configuring or releasing or activating or resuming or suspending or deactivating an SCG configured with dual connectivity.

In FIG. 1K, a UE may configure an RRC connection with a network or a BS as shown in FIG. 1F of the disclosure, and may perform data transmission or reception with the BS (e.g., MCG, MN, or cells (PCells or SCells) of MCG).

In FIG. 1K, according to a configuration procedure of 1F, the BS may configure, for the UE, an SRB (e.g., SRB3) for directly transmitting or receiving a control message or an RRC message between the UE and a secondary BS.

In the above case, the BS (e.g., secondary BS or master BS) may configure dual connectivity in the UE for a certain reason (e.g., when a high data rate is required, at a request of the UE (1k-05), or when a high QoS requirement should be satisfied). For example, the UE may transmit, to the BS, a request to configure, release, activate, deactivate, resume, or suspend dual connectivity, a cell group (e.g., SCG), or a cell, or may transmit a request to the secondary BS through the SRB3, and a message of the request may include a frequency (or channel) measurement result report, or a cell group identifier, or cell identifiers, or measurement results (1k-05). In another method, the secondary BS may determine whether to configure or release or add or deactivate or activate or resume or modify or reconfigure dual connectivity or a cell group (e.g., SCG) or a cell, by considering the amount of DL (or UL) data or the amount of buffer.

In the above case, the secondary BS (MN or MCG) may receive a frequency or channel measurement report for a frequency or a channel received from the UE, and may determine whether to configure or release or add or deactivate or activate or resume or modify or reconfigure or suspend dual connectivity or a cell group (e.g., SCG) or a cell based on the measurement result. Alternatively, the secondary BS may determine whether to configure or release or add or deactivate or activate or resume or modify or reconfigure or suspend dual connectivity or a cell group (e.g., SCG) or a cell, by considering the amount of DL (or UL) data or the amount of buffer.

In the above case, in order to configure or release or add or deactivate or activate or resume or modify or reconfigure or suspend dual connectivity or a cell group (e.g., SCG) or a cell, the secondary BS may transmit a first RRC message to the UE via the SRB3 (1k-10). In order to indicate to the UE to configure or release or add or deactivate or activate or resume or modify or reconfigure or suspend dual connectivity or a cell group (e.g., SCG) or a cell, each separate new request message may be defined and indicated in the first RRC message, and in another method, a new indicator may be defined in an existing message (e.g., RRCReconfiguration message or RRCResume message) to indicate (or request) to configure or release or add or deactivate or activate or resume or modify or reconfigure or suspend a cell group (e.g., SCG) or a cell. The first RRC message may include at least some of the following information.
First RRC message identifier (e.g., rrc-Transaction identifier) for identifying the first RRC message. Because the UE and the BS (e.g., secondary BS) transmit or receive a plurality of RRC messages therebetween, an identifier for identifying each RRC message may be included in the RRC message. For example, the same first RRC message identifier may be included in an RRC message (e.g., RRCReconfiguration) transmitted by a transmitting end, or an RRC message (e.g., RRCReconfigurationComplete) corresponding to the RRC message (e.g., RRCReconfiguration) transmitted by a receiving end, or an RRC message corresponding to the RRC message transmitted by the transmitting end.
Configuration information or an indicator (e.g., configuration information or an indicator for the UE) for configuring or releasing or adding or deactivating or activating or resuming or modifying or reconfiguring or suspending dual connectivity or a cell group (e.g., SCG). or a cell
Indicator indicating a state of a cell group (e.g., active or inactive or suspended or resumed).
Cell group identifier for identifying cell groups. The cell group identifier may be allocated by the master BS, or one identifier from among already promised identifiers may be allocated by the secondary BS).
Cell group or cell configuration information.
Bearer configuration information. For example, indicator information indicating an operation of a protocol layer (e.g., SDAP layer or PDCP layer or RLC layer or MAC layer) of each bearer (e.g., PDCP suspension indicator or PDCP reestablishment indicator or PDCP data recovery indicator or RLC reestablishment indicator or MAC partial reset indicator or MAC reset indicator or indicator to trigger new operation).
In the above case, when configuration information or indicator for configuring or adding or activating or resuming or modifying or reconfiguring dual connectivity or a cell group (e.g., SCG) or a cell is included, a first indicator (e.g., mobilityControlInfor or ReconfigurationWithSync) may also be included. However, in the above case, when configuration information or an indicator for releasing or deactivating or reconfiguring or suspending dual connectivity or a cell group (e.g., SCG) or a cell is included, the first indicator (e.g., mobilityControlInfor or ReconfigurationWithSync) may not be included. In the above case, the first indicator may be an indicator to trigger a random access procedure in the cell group or the cell, or an indicator to perform signal synchronization with a new cell, or an indicator indicating to perform frequency shift of the UE, or an indicator indicating to modify the cell group (or cell). In another method, the UE may perform PDCCH monitoring in the indicated or configured cell group or cell, and may trigger and perform a random access procedure according to an indication indicated in the PDCCH. For example, a higher layer (e.g., RRC layer) may transmit an indicator triggering a random access procedure to a lower layer (e.g., MAC layer).
In the above case, when configuration information or an indicator for configuring or adding or activating or resuming or modifying or reconfiguring dual connectivity or a cell group (e.g., SCG) or a cell is included, random access configuration information may also be included. However, in the above case, when configuration information or an indicator for releasing or deactivating or reconfiguring or suspending dual connectivity or a cell group (e.g., SCG) or a cell is included, the random access configuration information may not be included. The random access configuration information may include random access transport resource information (time or frequency transport resource) for preamble transmission or designated preamble information for the cell group or cell.
Time information indicating when to activate or resume or deactivate or suspend dual connectivity or a cell group (e.g., SCG) or a cell (PSCell or SCG SCell) (e.g., information indicating a timing (e.g., X), a time unit, a subframe, a time slot, or a symbol unit, for example, when the message is received in an n^{th} time unit, time information indicating whether to activate or resume or deactivate or suspend a cell in an n+X^{th} time unit).

When the UE receives the first RRC message 1k-10 via the SRB3, the UE may read and identify the first RRC message, and may configure or add or modify or resume or suspend or deactivate dual connectivity or a cell group (e.g., SCG). Also, when a first indicator to trigger a random access procedure is included in the first RRC message, or when a state indicator of the cell group indicates activation or resumption, the bearer configuration information or each configuration information of protocol layers configured above may be applied or set, or a random access procedure for the configured or indicated cell group or cell may be triggered. In the above case, when the random access procedure is performed, if there is random access information in the RRC message or if there is stored random access information, the UE may perform a random access procedure (e.g., CFRA procedure (e.g., 4-step random access or 2-step random access)), based on the stored random access information, or the random access information received in the RRC message, or system information. When there is no random access information in the RRC message, the UE may perform a random access procedure (e.g., CBRA procedure (e.g., 4-step random access or 2-step random access)). In another method, the UE may perform PDCCH monitoring in the indicated or configured cell group or cell, and may trigger and perform a random access procedure according to an indication indicated in the PDCCH. For example, a higher layer (e.g., RRC layer) may transmit an indicator to trigger a random access procedure to a lower layer (e.g., MAC layer).

Also, when the second RRC message or the first RRC message does not include a first indicator to trigger a random access procedure, or when the cell group state indicates suspension or inactivation or release, the UE may store cell group configuration information corresponding to the cell group identifier or the RRC message.

The UE may receive the first RRC message 1q-10 or apply received configuration information, and may generate a second RRC message and may transmit the second RRC message to the secondary BS through the SRB3 (1q-15). The second RRC message may include at least some of the following information.
First RRC message identifier having the same value as a first RRC message identifier included in the first RRC message.
Indicator or an identifier indicating that the first RRC message is successfully received.

In the above case, when the BS (e.g., secondary BS) receives the second RRC message, the BS may determine whether the second RRC message is a response message to the first RRC message via a first identifier. When the BS identifies the first RRC message, the BS may transmit, to the master BS or an MCG BS, an indication message including an indication indicating that a cell group has been configured or added or released or activated or resumed or suspended or deactivated through an Xn interface (e.g., interface between BSs) or an Sn interface (interface between a BS and an AMF or a UMF, or interface between BSs) (1k-20). The indication message may include at least some of the following information.
Identifier for identifying the indication message.
Configuration information or an indicator (e.g., configuration information or an indicator for the SCG) indicating that dual connectivity or a cell group or a cell has been configured or released or added or deactivated or activated or resumed or modified or reconfigured or suspended.

In the above case, when the BS (e.g., master BS) receives the indication message, the BS may read or identify configuration information or a message included in the indication message, may generate an indication acknowledgement message as a response message to the indication message, and may transmit the indication acknowledgement message to the secondary BS (1k-25).
Identifier having the same value as an identifier included in the indication message.
Indicator or an identifier indicating that the indication message is successfully received.
Response indicator indicating that the indication message is successfully applied.

In another method, in FIG. 1K, the UE may activate or suspend or resume or deactivate or release a cell group, based on a signaling procedure below.

In the above case, the BS may configure dual connectivity in the UE for a certain reason (e.g., when a high data rate is required, at a request of the UE (1k-30), or when a high QoS requirement should be satisfied). For example, the UE may transmit, to the BS, a request to configure, release, activate, deactivate, resume, or suspend dual connectivity, a cell group (e.g., SCG), or a cell, and a request message of the UE may include a frequency (or channel) measurement result report, or a cell group identifier, or cell identifiers, or measurement results (1k-30). In another method, the BS may determine whether to configure or release or add or deactivate or activate or resume or modify or reconfigure dual connectivity or a cell group (e.g., SCG) or a cell, by considering the amount of DL (or UL) data or the amount of buffer.

In the above case, a secondary BS (SN or SCG) may receive a frequency or channel measurement report for a frequency or a channel received from the UE, and may perform determination with respect to activation or suspension or deactivation or resumption of the secondary BS (secondary node (SN) or SCG) configured with dual connectivity, based on the measurement report. Alternatively, the secondary BS may determine whether to configure or release or add or deactivate or activate or resume or modify or reconfigure or suspend dual connectivity or a cell group (e.g., SCG) or a cell, by considering the amount of DL (or UL) data or the amount of buffer which is configured for the secondary BS. In the above case, the secondary BS may transmit, to a MCG of the UE (e.g., the master BS), a request message to configure or release or add or deactivate or activate or resume or modify or reconfigure or suspend dual connectivity or a cell group (e.g., SCG) or a cell through an Xn interface (e.g., interface between BSs) or a Sn interface (interface between a BS and an AMF or a UMF or interface between BSs) (1k-35). Each separate new request message may be defined and used in the request message for the master BS so as to configure or release or add or deactivate or activate or resume or modify or reconfigure or suspend dual connectivity or a cell group (e.g., SCG) or a cell, and in another method, and a new indicator may be defined in an existing message (e.g., SN addition request message or SN modification request message or SN release request message) to indicate (or request) to configure or release or add or deactivate or activate or resume or modify or reconfigure or suspend a cell group (e.g., SCG) or a cell. The request message may include information such as cell group configuration information (e.g., MCG configuration information) currently configured in the UE or bearer configuration information or capability information of the UE or frequency (or channel) measurement result information of the UE, and by referring to the above information, the master BS may configure SCG configuration information or bearer configuration information to correspond to UE capability or not to exceed UE capability or to match bearer configuration information of the MCG when the SCG is configured for the UE. In another method, the request message may include an RRC message including configuration information of the UE, and the master BS may forward the RRC message to the UE so as to indicate to the UE to configure or release or add or deactivate or activate or resume or modify or reconfigure or suspend the cell group (e.g., SCG) or a cell.

In the above case, when the master BS having received the request message 1k-35 rejects the request message, the master BS may configure a rejection message and may transmit the rejection message to the secondary BS through the Xn interface (e.g., interface between BSs) or the Sn interface (interface between a BS and an AMF or a UMF, or interface between BSs) (1k-40). When the master BS accepts the request message, the master BS may transmit a request acceptance message including configuration information or an indicator for configuring or releasing or adding or deactivating or activating or resuming or modifying or reconfiguring or suspending dual connectivity or a cell group (e.g., SCG) or a cell through the Xn interface (e.g., interface between BSs) or the Sn interface (interface between a BS and an AMF or a UMF, or interface between BSs) to the secondary BS (1k-40). The request message 1k-35 or the request acceptance message 1k-40 may include at least some of the following information.
The same identifier as a message identifier included in the request message, or an indicator indicating that a request in the request message is accepted, or an identifier for identifying the request message.
Configuration information or indicator (e.g., configuration information or indicator for the MCG) for configuring or releasing or adding or deactivating or activating or resuming or modifying or reconfiguring or suspending dual connectivity or a cell group (e.g., SCG) or a cell.
First RRC message (e.g., RRCReconfiguration message) including configuration information or an indicator for configuring or releasing or adding or deactivating or activating or resuming or modifying or reconfiguring or suspending dual connectivity a cell group (e.g., SCG) or a cell.
The first RRC message may include at least some of the following information.
   First RRC message identifier (e.g., rrc-Transaction identifier) for identifying the first RRC message. Because the UE and the BS (e.g., secondary BS) transmit or receive a plurality of RRC messages therebetween, an identifier for identifying each RRC message may be included in the RRC message. For example, the same first RRC identifier may be included in an RRC message (e.g., RRCReconfiguration) transmitted by a transmitting end, or an RRC message (e.g., RRCReconfigurationComplete) corresponding to the RRC message (e.g., RRCReconfiguration) transmitted by a receiving end, or an RRC message corresponding to the RRC message transmitted by the transmitting end.
   Configuration information or an indicator (e.g., configuration information or an indicator for the UE) for configuring or releasing or adding or deactivating or activating or resuming or modifying or reconfiguring or suspending dual connectivity or a cell group (e.g., SCG) or a cell.
   Indicator indicating a state of a cell group (e.g., active or inactive or suspended or resumed).
   Cell group identifier for identifying cell groups. The cell group identifier may be allocated by the master BS, or one identifier from among already preset identifiers may be allocated by the secondary BS.
   Cell group or cell configuration information.
   Bearer configuration information. For example, indicator information indicating an operation of a protocol layer (e.g., SDAP layer or PDCP layer or RLC layer or MAC layer) of each bearer (e.g., PDCP suspension indicator or PDCP reestablishment indicator or PDCP data recovery indicator or RLC reestablishment indicator or MAC partial reset indicator or MAC reset indicator or indicator triggering new operation).
   In the above case, when configuration information or an indicator for configuring or adding or activating or resuming or modifying or reconfiguring dual connectivity or a cell group (e.g., SCG) or a cell is included, a first indicator (e.g., mobilityControlInfor or ReconfigurationWithSync) may also be included. However, in the above case, when configuration information or an indicator for releasing or deactivating or reconfiguring or suspending dual connectivity or a cell group (e.g., SCG) or a cell is included, the first indicator (e.g., mobilityControlInfor or ReconfigurationWithSync) may not be included. In the above case, the first indicator may be an indicator to trigger a random access procedure in the cell group or the cell, or an indicator to perform signal synchronization with a new cell, or an indicator indicating to perform frequency shift of the UE, or an indicator indicating to modify the cell group (or cell).
   When configuration information or an indicator for configuring or adding or activating or resuming or modifying or reconfiguring dual connectivity or a cell group (e.g., SCG) or a cell is included, random access configuration information may also be included. However, in the above case, when configuration information or an indicator for releasing or deactivating or reconfiguring or suspending dual connectivity or a cell group (e.g., SCG) or a cell is included, the random access configuration information may not be included. The random access configuration information may include random access transport resource information (time or frequency transport resource) for preamble transmission or designated preamble information for the cell group or cell.
   Time information indicating when to activate or resume or deactivate or suspend dual connectivity, a cell group (e.g., SCG) or a cell (PSCell or SCG SCell) (e.g., information indicating a timing (e.g., X), a time unit, a subframe, a time slot, or a symbol unit, for example, when the message is received in an n^{th} time unit, time information indicating whether to activate or resume or deactivate or suspend a cell in an n+X^{th} time unit).

In the above case, when the master BS receives the request message 1k-35, the master BS may identify the request message, and may transmit, to the UE, a second RRC message 1k-45 (e.g., RRCReconfiguration) including information included in the request message (e.g., first RRC message included in the request message 1k-35). The second RRC message may include at least some of the following information.
Second RRC message identifier (e.g., rrc-Transaction identifier) for identifying the second RRC message. Because the UE and the BS (e.g., master BS) transmit or receive a plurality of RRC messages therebetween, the RRC message may include an identifier for identifying each RRC message. For example, the same second RRC identifier may be included in an RRC message (e.g., RRCReconfiguration) transmitted by a transmitting end, or an RRC message (e.g., RRCReconfigurationComplete) corresponding to the RRC message (e.g., RRCReconfiguration) transmitted by a receiving end, or an RRC message corresponding to the RRC message transmitted by the transmitting end.
First RRC message included in the request message 1k-35 or the request acceptance message 1k-40.
Configuration information or an indicator (e.g., configuration information or an indicator for the UE) for configuring or releasing or adding or deactivating or activating or resuming or modifying or reconfiguring or suspending dual connectivity or a cell group (e.g., SCG) or a cell.
Indicator indicating a state of a cell group (e.g., active or inactive or suspended or resumed).
Cell group identifier for identifying cell groups. The cell group identifier may be allocated by the master BS, or one identifier from among already promised identifiers may be allocated by the secondary BS.
Cell group or cell configuration information.
Bearer configuration information. For example, indicator information indicating an operation of a protocol layer (e.g., SDAP layer or PDCP layer or RLC layer or MAC layer) of each bearer (e.g., PDCP suspension indicator or PDCP reestablishment indicator or PDCP data recovery indicator or RLC reestablishment indicator or MAC partial reset indicator or MAC reset indicator or indicator to trigger new operation).
When configuration information or an indicator for configuring or adding or activating or resuming or modifying or reconfiguring dual connectivity or a cell group (e.g., SCG) or a cell is included, a first indicator (e.g., mobilityControlInfor or ReconfigurationWithSync) may also be included. When configuration information or an indicator for releasing or deactivating or reconfiguring or suspending dual connectivity or a cell group (e.g., SCG) or a cell is included, the first indicator (e.g., mobilityControlInfor or ReconfigurationWithSync) may not be included. In the above case, the first indicator may be an indicator to trigger a random access procedure in the cell group or the cell or an indicator to perform signal synchronization with a new cell or an indicator indicating to perform frequency shift of the UE or an indicator indicating to modify the cell group (or cell). In another method, the UE may perform PDCCH monitoring in the indicated or configured cell group or cell, and may trigger and perform a random access procedure according to an indication indicated in the PDCCH. For example, a higher layer (e.g., RRC layer) may transmit an indicator to trigger a random access procedure to a lower layer (e.g., MAC layer).
When configuration information or an indicator for configuring or adding or activating or resuming or modifying or reconfiguring dual connectivity or a cell group (e.g., SCG) or a cell is included, random access configuration information may also be included. When configuration information or an indicator for releasing, deactivating, reconfiguring, or suspending dual connectivity, a cell group (e.g., SCG), or a cell is included, the random access configuration information may not be included. The random access configuration information may include random access transport resource information (time or frequency transport resource) for preamble transmission or designated preamble information for the cell group or cell.
Time information indicating when to activate or resume or deactivate or suspend dual connectivity or a cell group (e.g., SCG) or a cell (PSCell or SCG SCell) (e.g., information indicating a timing (e.g., X), a time unit, a subframe, a time slot, or a symbol unit, for example, when the message is received in an n^{th} time unit, time information indicating whether to activate or resume or deactivate or suspend a cell in an n+X^{th} time unit).

In the above case, when the UE receives the second RRC message 1k-45, the UE may read and identify the second RRC message, or may read information included in the second RRC message (e.g., first RRC message included in the second RRC message) and may configure or add or modify or resume or suspend or deactivate dual connectivity or a cell group (e.g., SCG). Also, when a first indicator to trigger a random access procedure is included in the second RRC message or the first RRC message, or when a state indicator of the cell group indicates activation or resumption, the bearer configuration information or each configuration information of protocol layers configured above may be applied or set, or a random access procedure for the configured or indicated cell group or cell may be triggered. When a random access procedure is performed, if there is random access information in the RRC message or if there is stored random access information, the UE may perform a random access procedure (e.g., CFRA procedure (e.g., 4-step random access or 2-step random access)), based on the stored random access information or the random access information received in the RRC message or system information. When there is no random access information in the RRC message, the UE may perform a random access procedure (e.g., CBRA procedure (e.g., 4-step random access or 2-step random access)). In another method, the UE may perform PDCCH monitoring in the indicated or configured cell group or cell, and may trigger and perform a random access procedure according to an indication indicated in the PDCCH. For example, a higher layer (e.g., RRC layer) may transmit an indicator triggering a random access procedure to a lower layer (e.g., MAC layer). Also, when the second RRC message or the first RRC message does not include a first indicator to trigger a random access procedure, or when the cell group state indicates suspension or inactivation or release, the UE may store cell group configuration information corresponding to the cell group identifier or the RRC message.

The UE may receive the second RRC message 1k-45 or apply received configuration information, and may generate a third RRC message or a fourth RRC message and may transmit the third RRC message or the fourth RRC message to the BS (1k-50). The third RRC message may include at least some of the following information.
Second RRC message identifier having the same value as a second RRC message identifier included in the second RRC message.
Indicator or an identifier indicating that the second RRC message is successfully received.
Fourth RRC message including a response indicating the first RRC message generated and transmitted by the secondary BS is successfully received. The fourth RRC message may include at least some of the following information.
   First RRC message identifier having the same value as a first RRC message identifier included in the first RRC message.
   Indicator or an identifier indicating that the first RRC message is successfully received.
   Response indicator indicating that the first RRC message is successfully applied.

When the BS (e.g., master BS) receives the third RRC message, the BS may determine whether the third RRC message is a response message to the second RRC message via a second identifier. The BS may identify the fourth RRC message included in the third RRC message, may include the fourth RRC message in a configuration complete message indicating that a configuration is completed to an SCG BS, and may transmit the same to the secondary BS through the Xn interface (e.g., interface between BSs) or the Sn interface (interface between a BS and an AMF or a UMF, or interface between BSs) (1k-55). The configuration complete message may include at least some of the following information.
Fourth RRC message included in the third RRC message.
Indicator or an identifier indicating that a configuration (cell group addition or modification or release) or an indication (e.g., cell group activation or deactivation or suspension or resumption) indicated in the request message or the request acceptance message or the first RRC message is completed.

When the BS (e.g., secondary BS) receives the configuration complete message, the BS may read or identify the fourth RRC message included in the configuration complete message, and may determine whether the fourth RRC message is a response message to the first RRC message through a first identifier. It may be determined whether a configuration or an indication indicated by the BS is successfully completed. In the above case, when the secondary BS receives the configuration complete message or the fourth RRC message, the secondary BS may transmit, to the master BS, a response message indicating that the configuration complete message or the fourth RRC message is successfully received as a response.

In the disclosure, when a message is transmitted to the UE so as to configure or indicate cell group or cell configuration information for the UE, for example, when configuration information or an indicator for configuring or adding or activating or resuming or modifying or reconfiguring dual connectivity or a cell group (e.g., SCG) or a cell is included in the message, the UE may include, in the message, or reconfigure SDAP configuration information, or may include in the message or configure or reconfigure mapping configuration information between a QoS flow and a bearer of an SDAP layer. However, when configuration information or an indicator for releasing or deactivating or reconfiguring or suspending dual connectivity or a cell group (e.g., SCG) or a cell is included in the message, the UE may not include, in the message, or may not reconfigure the SDAP configuration information, or may not include, may not configure, may not reconfigure, or may suspend the mapping configuration information between the QoS flow and the bearer of the SDAP layer.

The signaling procedures according to the disclosure may be combined and modified, and thus may be extended to new signaling procedures.

The signaling procedures according to the disclosure may be extended to multiple access technology. For example, configuration information of a plurality of cell groups may be configured in a UE through an RRC message, and one or more cell groups (or cells) from among the configured cell groups may be activated or resumed via an indicator of a PDCCH, or MAC control information or an RRC message or one or more cell groups may be suspended or deactivated.

In the disclosure, when dual connectivity or a cell group (e.g., SCG) or a cell (PSCell or SCG SCell) is activated or resumed or added or deactivated or released or suspended, UE operations for each cell (PSCell or SCG SCell) or UE operations for each protocol layer (e.g., SDAP layer or PDCP layer or RLC layer or MAC layer or PHY layer) will now be described.

1> When a UE receives configuration information or an indicator (e.g., via DCI of a PDCCH or MAC control information or an RRC message) for configuring or adding or activating or resuming or modifying or reconfiguring dual connectivity or a cell group (e.g., SCG) or a cell, the UE may perform at least some of the following procedures.
2> A higher layer (e.g., RRC layer) may indicate the configuration information or the indicator to a lower layer (e.g., PDCP layer or RLC layer or MAC layer or PHY layer).
2> UE operation for PSCell: When the UE receives the configuration information or the indicator, the UE may maintain a PSCell in an active state, may activate a DL BWP of the PSCell to a normal BWP (e.g., first active BWP or BWP other than a dormant BWP) or a last activated BWP configured in the RRC message, and may perform a UE operation in the activated BWP. In another method, when the UE receives the configuration information or the indicator, the UE may maintain a PSCell in an active state, may reconfigure or switch a PDCCH monitoring period or a DRX configuration period of the PSCell to a short period based on first DRX configuration information, and may perform PDCCH monitoring and perform a UE operation of the active cell. By using the method, the UE may perform a UE operation for the PSCell, thereby rapidly receiving a scheduling indication from a cell group or a cell and starting data transmission or reception. Also, in the above case, in order to further rapidly receive a scheduling indication from a cell group or a cell and start data transmission or reception, the UE may measure many or frequent channel signals based on first channel measurement configuration information configured in the RRC message and may rapidly report a channel measurement result to a BS. In the above case, when a certain condition is satisfied, the UE may measure a channel signal again based on second channel measurement configuration information and may report a measurement result to the BS.
2> UE operation for SCell of SCG: When the UE receives the configuration information or the indicator, the UE may activate an SCell of an SCG, may activate a DL BWP or a UL BWP to a BWP (e.g., first active BWP) configured in the RRC message, and may perform a UE operation of the activated SCell or BWP. In another method, when the UE receives the configuration information or the indicator, if a dormant BWP is configured for the SCell of the SCG, the UE may maintain the SCell in an active state, may activate a DL BWP of the SCell to a BWP (e.g., first active BWP) configured in the RRC message, and may perform a UE operation in the activated BWP, and alternatively, when a dormant BWP is not configured for the SCell of the SCG, the UE may switch the SCell to an active state, may activate a DL BWP or a UL BWP to a BWP (e.g., first active BWP) configured in the RRC message, and may perform a UE operation of the activated SCell or BWP. In another method, when the UE receives the configuration information or the indicator, the UE may determine switching or activation or deactivation of a BWP or a state of the SCell according to SCell configuration information or an indicator configured in a message including the configuration information or the indicator and may perform a UE operation.
2> UE operation of MAC layer for SCG: When the UE receives the configuration information or the indicator, the UE may perform a MAC reset procedure on a MAC layer (e.g., may initialize or release configuration information configured in the MAC layer, and may stop or initialize configured timers or may stop or initialize an HARQ procedure). For example, a timing advance timer (TAT) indicating the validity of signal synchronization between the UE and the BS may be considered as stopped or expired. In another method, when the UE receives the configuration information or the indicator, the UE may perform a MAC partial reset procedure (or when an indicator indicating a MAC partial reset procedure is included in a message including the configuration information or the indicator, the UE may perform a MAC partial reset procedure). For example, the TAT indicating the validity of signal synchronization between the UE and the BS may be continuously maintained, or HARQ retransmission in retransmission may be continuously performed. In another method, the UE may not perform any procedure on the MAC layer and may maintain a current configuration. Also, in the above case, when an indication to trigger a random access procedure is indicated from a higher layer (e.g., RRC layer), or the TAT is stopped or expired, the UE may trigger a random access procedure. In another method, when the TAT is not stopped or expired, the UE may not trigger nor perform a random access procedure. This is because, when the TAT is running, signal synchronization with the SCG is matched or maintained, and thus, the UE does not need to perform an unnecessary random access procedure.
2> Operation for data radio bearer (DRB): The UE may resume RLC bearers or RLC layers which belong to the cell group for which activation or resumption is indicated.
2> Operation for data radio bearer (DRB): When the UE receives the configuration information or the indicator, the UE may resume DRBs (or SCG (SN) terminated DRBs or DRBs with a PDCP layer configured for the SCG) included in the SCG. For example, for a split bearer with a PDCP layer configured for an MCG (bearer for which one RLC layer is configured for the MCG and another RLC layer is configured for the SCG), an indicator (reestablishRLC) to trigger a procedure of reestablishing the RLC layer configured for the SCG may also be included in the RRC message including the configuration information or the indicator, and alternatively, the UE may perform a reestablishment procedure on the RLC layer configured for the SCG (or, the UE may resume the RLC layer or the RLC bearer). For example, for a split bearer with a PDCP layer configured for the SCG (bearer for which one RLC layer is configured for the MCG and another RLC layer is configured for the SCG), an indicator (reestablishRLC) to trigger a procedure of reestablishing the RLC layer configured for the MCG may also be included (or, the UE may resume the RLC layer or the RLC bearer), or an indicator to trigger a PDCP reestablishment procedure (reestablishPDCP) or a PDCP resume procedure (PDCP resume) in the PDCP layer configured for the SCG may also be included, in the RRC message including the configuration information or the indicator, and alternatively, the UE may perform a reestablishment procedure on the RLC layer configured for the MCG (or, the UE may resume the RLC layer or the RLC bearer), or may perform a PDCP reestablishment procedure or a PDCP resume procedure in the PDCP layer configured for the SCG. For example, for a bearer configured for the SCG, the UE may resume bearers, or may indicate an RRC layer to trigger a PDCP reestablishment procedure or a PDCP resume procedure in a PDCP layer, or may perform the PDCP reestablishment procedure or the PDCP resume procedure in the PDCP layer. In the above case, the UE may trigger a first PDCP resume procedure for bearers configured for the SCG, or may perform the first PDCP resume procedure in a PDCP layer. In another method, in order to solve a security issue problem (e.g., a security problem which may occur when security configuration information or a security key is not changed (or updated or reconfigured) when it is configured to activate or resume the cell group) which occurs when different data are transmitted with the same security key when the SCG is activated or resumed, the UE may trigger a second PDCP resume procedure for bearers configured in the SCG, or a second PDCP resume procedure may be performed in a PDCP layer. In another method, when a PDCP layer resume procedure is triggered in a higher layer, a first PDCP resume procedure may be triggered and performed, and when a PDCP layer resume procedure is triggered in a higher layer or an indicator to activate or resume a cell group (or cell) is indicated, a second PDCP resume procedure may be triggered and performed. In another method, in the above case, in order to solve a security issue problem occurring when different data are transmitted with the same security key, when the BS indicates an indicator to activate or resume a cell group (or cell), the BS may configure a new security key including security key configuration information (e.g., sk-counter) in an RRC message including an indicator to activate or resume a cell group (or cell) and may modify or update the security key, or may include a PDCP reestablishment procedure indicator in the RRC message to modify or update a security key of bearers configured for the SCG, or the UE may perform a PDCP reestablishment procedure on the bearers. In another method, when the RRC message includes security key configuration information and thus a security key is changed, or includes an indication of a PDCP layer reestablishment procedure, the PDCP layer reestablishment procedure is performed, or when the RRC message does not include the security key configuration information or indicates, by using an indicator, an operation of a PDCP layer, the UE may trigger and perform the first PDCP resume procedure or the second PDCP resume procedure. Also, when the suspended bearer or PDCP layer or RLC layer is resumed, in order to prevent stored old data from being transmitted, the UE may perform a procedure of discarding a plurality of pieces of stored data (e.g., PDCP PDU or PDCP SDU or RLC PDU or RLC SDU). For example, the UE may perform a data discard procedure (SDU discard) in the PDCP layer or may perform an RLC layer reestablishment procedure. In the above case, the data discard procedure (SDU discard) in the PDCP layer, in which a plurality of pieces of stored data are discarded, or the RLC layer reestablishment procedure may be performed when suspension or inactivation or release of a cell group is indicated via an RRC message or MAC control information or DCI of a PDCCH.
2> Operation for SRB configured for SCG: When the UE receives the configuration information or the indicator and activates a PSCell, or when an activated DL BWP of the PSCell is a normal BWP other than a dormant BWP or an activated PSCell monitors the PDCCH with a long period based on first DRX configuration information, SRBs (or SN (SCG) terminated SRBs or SRBs or SRB3s with a PDCP layer configured for the SCG) included in the SCG may be continuously maintained (e.g., the UE may continuously transmit or receive a control message to or from a secondary BS). Alternatively, in order to discard a plurality of pieces of old data (PDCP SDU or PDCP PDU) stored in the SRBs configured for the SCG, the UE may perform a data discard procedure (e.g., a discard indication to a PDCP layer) or an RLC layer reestablishment procedure. In another method, when the UE receives the configuration information or the indicator, the UE may resume SRBs (or SN (SCG) terminated SRBs or SRBs or SRB3s with a PDCP layer configured in the SCG) included in the SCG. Alternatively, in order to discard a plurality of pieces of old data (PDCP SDU or PDCP PDU) stored in the SRBs configured for the SCG, the UE may perform a data discard procedure (e.g., a discard indication to a PDCP layer) or an RLC layer reestablishment procedure. For example, for a split bearer (bearer via which one RLC layer is configured for the MCG and another RLC layer is configured for the SCG) with a PDCP layer configured for the MCG, an indicator (reestablishRLC) to trigger a procedure of reestablishing the RLC layer configured for the SCG may also be included in the RRC message including the configuration information or the indicator, or alternatively, the UE may perform a reestablishment procedure on the RLC layer configured for the SCG. For example, for a split bearer (bearer via which one RLC layer is configured for an MCG and another RLC layer is configured for an SCG) with a PDCP layer configured for the SCG, an indicator (reestablishRLC) to trigger a procedure of reestablishing the RLC layer configured for an MCG may also be included, or an indicator to trigger a PDCP reestablishment procedure (reestablishPDCP) or a PDCP resume procedure (PDCP resume) in the PDCP layer configured for the SCG may also be included in the RRC message including the configuration information or the indicator, or alternatively, the UE may perform a reestablishment procedure on the RLC layer configured for the MCG, or may perform a PDCP reestablishment procedure or a PDCP resume procedure in the PDCP layer configured for the SCG. For example, for a bearer configured for the SCG, the UE may resume bearers, or may indicate an RRC layer to trigger a PDCP reestablishment procedure or a PDCP resume procedure in a PDCP layer, or may perform the PDCP reestablishment procedure or the PDCP resume procedure in the PDCP layer. In the above case, the UE may trigger a first PDCP resume procedure for bearers configured for the SCG, or may perform a first PDCP resume procedure in a PDCP layer. In another method, in order to solve a security issue problem occurring when different data are transmitted with the same security key when the SCG is activated or resumed, the UE may trigger a second PDCP resume procedure for bearers configured for the SCG, or may perform a second PDCP resume procedure in a PDCP layer. In another method, when a PDCP layer resume procedure is triggered in a higher layer, a first PDCP resume procedure may be triggered and performed, and when a PDCP layer resume procedure is triggered in a higher layer or an indicator to activate or resume a cell group (or cell) is indicated, a second PDCP resume procedure may be triggered and performed. In another method, in order to solve a security issue problem occurring when different data are transmitted with the same security key, when the BS indicates an indicator to activate or resume a cell group (or cell), the BS may configure a new security key including security key configuration information (e.g., sk-counter) in an RRC message including an indicator to activate or resume a cell group (or cell) and may change or update the security key, or may include a PDCP reestablishment procedure indicator in the RRC message to modify or update a security key of bearers configured for the SCG, or the UE may perform a PDCP reestablishment procedure on the bearers. In another method, when the RRC message includes security key configuration information and thus a security key is changed, or includes an indication of a PDCP layer reestablishment procedure, the PDCP layer reestablishment procedure is performed, or when the RRC message does not include the security key configuration information or indicates, by using an indicator, an operation of a PDCP layer, the UE may trigger and perform the first PDCP resume procedure or the second PDCP resume procedure. Also, when the suspended bearer or PDCP layer or RLC layer is resumed, in order to prevent stored old data from being transmitted, the UE may perform a procedure of discarding a plurality of pieces of stored data (e.g., PDCP PDU or PDCP SDU or RLC PDU or RLC SDU). For example, the UE may perform a data discard procedure (SDU discard) in the PDCP layer or may perform an RLC layer reestablishment procedure. In the above case, the data discard procedure (SDU discard) in the PDCP layer, in which a plurality of pieces of stored data are discarded, or the RLC layer reestablishment procedure may be performed when suspension or inactivation or release of a cell group is indicated via an RRC message or MAC control information or DCI of a PDCCH.
2> UE operation for PUCCH SCell of SCG: When the UE receives the configuration information or the indicator, the UE may activate a PUCCH SCell of an SCG, may activate a DL BWP or a UL BWP to a BWP (e.g., first active BWP) configured in the RRC message, and may perform a UE operation of the activated SCell or BWP. In another method, when the UE receives the configuration information or the indicator, if a dormant BWP is configured for the PUCCH SCell of the SCG, the UE may maintain the SCell in an active state, may activate a DL BWP of the SCell to a BWP (e.g., first active BWP) configured in the RRC message, and may perform a UE operation in the activated BWP, and alternatively, when a dormant BWP is not configured for the SCell of the SCG, the UE may switch the SCell to an active state, may activate a DL BWP or a UL BWP to a BWP (e.g., first active BWP) configured in the RRC message, and may perform a UE operation of the activated SCell or BWP. In another method, when the UE receives the configuration information or the indicator, the UE may determine switching or activation or deactivation of a BWP or a state of the SCell according to SCell configuration information or an indicator configured in a message including the configuration information or the indicator and may perform a UE operation. In another method, when the UE receives the configuration information or the indicator, the UE may apply, to the PUCCH SCell, first DRX configuration information (e.g., second DRX configuration information is suspended and the first DRX configuration information is reconfigured) configured in an RRC message, and may perform a UE operation in an activated SCell when PDCCH monitoring is possible.

1> When the UE receives configuration information or an indicator (e.g., via DCI of a PDCCH or MAC control information or an RRC message) for releasing or deactivating or reconfiguring or suspending dual connectivity or a cell group (e.g., SCG) or a cell, the UE may perform at least some of the following procedures.
2> A higher layer (e.g., RRC layer) may indicate the configuration information or the indicator to a lower layer (e.g., PDCP layer or RLC layer or MAC layer or PHY layer).
2> UE operation for PSCell: When the UE receives the configuration information or the indicator, the UE may maintain a PSCell in an active state, may activate a DL BWP of the PSCell to a dormant BWP configured in the RRC message, and may perform a UE operation in the dormant BWP. In another method, when the UE receives the configuration information or the indicator, the UE may maintain a PSCell in an active state, may reconfigure or switch a PDCCH monitoring period or a DRX configuration period of the PSCell to a very long period based on second DRX configuration information, and may perform PDCCH monitoring and perform a UE operation of the active cell. In another method, when the UE receives the configuration information or the indicator, the UE may deactivate the PSCell and may perform a UE operation of an inactive cell. By using the above method, the UE may perform a UE operation for the PSCell, thereby reducing power consumption of the UE.
2> UE operation for SCell of SCG: When the UE receives the configuration information or the indicator, the UE may deactivate an SCell of an SCG, and may perform a UE operation of the deactivated SCell. In another method, when the UE receives the configuration information or the indicator, if a dormant BWP is configured for the SCell of the SCG, the UE may maintain the SCell in an active state, may activate a DL BWP of the SCell to the dormant BWP, and may perform a UE operation in the dormant BWP, or alternatively, when a dormant BWP is not configured for the SCell of the SCG, the UE may switch the SCell to an inactive state, and may perform a UE operation in the deactivated cell or BWP. In another method, when the UE receives the configuration information or the indicator, the UE may determine switching or activation or deactivation of a BWP or a state of the SCell according to SCell configuration information or an indicator configured in a message including the configuration information or the indicator.
2> UE operation of MAC layer for SCG: When the UE receives the configuration information or the indicator, the UE may perform a MAC reset procedure on a MAC layer (e.g., may initialize or release a plurality of pieces of configuration information configured in the MAC layer, and may stop or initialize configured timers or may stop or initialize an HARQ procedure). For example, a TAT indicating the validity of signal synchronization between the UE and the BS may be considered as stopped or expired. In another method, in order to prevent data loss due to the reset procedure of the MAC layer, when the UE receives the configuration information or the indicator, the UE may perform a MAC partial reset procedure (or when an indicator indicating a MAC partial reset procedure is included in a message including the configuration information or the indicator, the UE may perform the MAC partial reset procedure). For example, a TAT indicating the validity of signal synchronization between the UE and the BS may be continuously maintained, or HARQ retransmission in retransmission may be continuously performed. In another method, the UE may not perform any procedure on the MAC layer and may maintain a current configuration.
2> Operation for DRB: The UE may suspend RLC bearers or RLC layers which belong to the cell group for which deactivation or suspension is indicated.
2> Operation for DRB: When the UE receives the configuration information or the indicator, the UE may suspend DRBs (or SCG (SN) terminated DRBs or DRBs with a PDCP layer configured for the SCG) included in the SCG. For example, for a split bearer (bearer via which one RLC layer is configured for the MCG and another RLC layer is configured for the SCG) with a PDCP layer configured for the MCG, an indicator (reestablishRLC) to trigger a procedure of reestablishing the RLC layer configured for the SCG may also be included in the RRC message including the configuration information or the indicator (or, the RLC layer may be suspended, or, an indicator may be configured to trigger an RLC establishment procedure when the cell group is activated or resumed at a later time), or, alternatively, an indicator to trigger a PDCP data recovery procedure in the PDCP layer configured for the MCG may also be included, or the UE may perform a reestablishment procedure on the RLC layer configured for the SCG, or may perform a PDCP data recovery procedure in the PDCP layer configured in the MCG (i.e., when an RLC layer corresponding to the deactivated or suspended SCG is in an AM mode, the PDCP layer may perform a retransmission procedure, to an RLC layer corresponding to the MCG, with respect to a plurality of pieces of data for which successful delivery is not acknowledged). For example, for a split bearer (bearer via which one RLC layer is configured for the MCG and another RLC layer is configured for the SCG) with a PDCP layer configured for the SCG, an indicator (reestablishRLC) to trigger a procedure of reestablishing the RLC layer configured for the MCG may also be included in the RRC message including the configuration information or the indicator (or, the RLC layer may be suspended, or, an indicator may be configured to trigger an RLC establishment procedure when the cell group is activated or resumed at a later time), or, alternatively, an indicator to trigger a PDCP reestablishment procedure (reestablishPDCP) or a PDCP suspend procedure (PDCP suspend) in the PDCP layer configured for the SCG may also be included, or the UE may perform a reestablishment procedure on the RLC layer configured for the SCG (or, the RLC layer may be suspended, or, an indicator may be configured to trigger an RLC establishment procedure when the cell group is activated or resumed at a later time), or may perform a PDCP reestablishment procedure or a PDCP suspend procedure (PDCP suspend) in the PDCP layer configured for the SCG. For example, for a bearer configured for the SCG, the UE may suspend bearers, or may indicate an RRC layer to trigger a PDCP reestablishment procedure or a PDCP suspend procedure in a PDCP layer, or may perform the PDCP reestablishment procedure or the PDCP suspend procedure in the PDCP layer. In the above case, the UE may trigger a first PDCP suspend procedure for bearers configured for the SCG, or may perform the first PDCP suspend procedure in a PDCP layer. In another method, in order to solve a security issue problem (e.g., a security problem which may occur when security configuration information or a security key is not changed (or updated or reconfigured) when it is configured to activate or resume the cell group) which occurs when different data are transmitted with the same security key when the SCG is activated or resumed, the UE may trigger a second PDCP suspend procedure for bearers configured in the SCG, or a second PDCP suspend procedure may be performed in a PDCP layer. In another method, when a PDCP layer suspend procedure is triggered in a higher layer, a first PDCP suspend procedure may be triggered and performed, and when a PDCP layer suspend procedure is triggered in a higher layer or an indicator to activate or resume a cell group (or cell) is indicated, a second PDCP suspend procedure may be triggered and performed. In another method, when the RRC message includes security key configuration information and thus a security key is changed, or includes an indication of a PDCP layer reestablishment procedure, the PDCP layer reestablishment procedure is performed, or when the RRC message does not include the security key configuration information or indicates, by using an indicator, an operation of a PDCP layer, the UE may trigger and perform the first PDCP resume procedure or the second PDCP resume procedure. Also, when the suspended bearer or PDCP layer or RLC layer is resumed, in order to prevent stored old data from being transmitted, the UE may perform a procedure of discarding a plurality of pieces of stored data (e.g., PDCP PDU or PDCP SDU or RLC PDU or RLC SDU). For example, the UE may perform a data discard procedure (SDU discard) in the PDCP layer or may perform an RLC layer reestablishment procedure. In the above case, the data discard procedure (SDU discard) in the PDCP layer, in which a plurality of pieces of stored data are discarded, or the RLC layer reestablishment procedure may be performed when suspension or inactivation or release of a cell group is indicated via an RRC message or MAC control information or DCI of a PDCCH.
2> Operation for SRB configured for SCG: When the UE receives the configuration information or the indicator and activates a PSCell, or when an activated DL BWP of the PSCell is a normal BWP other than a dormant BWP or an activated PSCell monitors the PDCCH with a long period based on second DRX configuration information, SRBs (or SN (SCG) terminated SRBs or SRBs or SRB3s with a PDCP layer configured for the SCG) included in the SCG may not be suspended but may be continuously maintained (e.g., the UE may continuously transmit or receive a control message to or from a secondary BS). Alternatively, in order to discard a plurality of pieces of old data (PDCP SDU or PDCP PDU) stored in the SRBs (or SN (SCG) terminated SRBs or SRBs or SRB3s with a PDCP layer configured for the SCG) configured for the SCG, the UE may perform a data discard procedure (e.g., a discard indication to a PDCP layer) or an RLC layer reestablishment procedure. In another method, when the UE receives the configuration information or the indicator, the UE may resume SRBs (or SN (SCG) terminated SRBs or SRBs or SRB3s with a PDCP layer configured in the SCG) included in the SCG. Alternatively, in order to discard a plurality of pieces of old data (PDCP SDU or PDCP PDU) stored in the SRBs configured for the SCG, the UE may perform a data discard procedure (e.g., a discard indication to a PDCP layer) or an RLC layer reestablishment procedure. For example, for a split SRB bearer (bearer via which one RLC layer is configured for the MCG and another RLC layer is configured for the SCG) with a PDCP layer configured for the MCG, an indicator (reestablishRLC) to trigger a procedure of reestablishing the RLC layer configured for the SCG may also be included, or an indicator to trigger a PDCP data recovery procedure in the PDCP layer configured for the MCG may also be included, in the RRC message including the configuration information or the indicator, or the UE may perform a reestablishment procedure on the RLC layer configured for the SCG, or may perform a PDCP data recovery procedure in the PDCP layer configured for the MCG. For example, for a split bearer (bearer via which one RLC layer is configured for the MCG and another RLC layer is configured for the SCG) with a PDCP layer configured for the SCG, an indicator (reestablishRLC) to trigger a procedure of reestablishing the RLC layer configured for the MCG may also be included, or an indicator to trigger a PDCP reestablishment procedure (reestablishPDCP) or a PDCP suspend procedure (PDCP suspend) in the PDCP layer configured for the SCG may also be included, in the RRC message including the configuration information or the indicator, or the UE may perform a reestablishment procedure on the RLC layer configured for the MCG, or may perform a PDCP reestablishment procedure or a PDCP suspend procedure (PDCP suspend) in the PDCP layer configured for the SCG. For example, for a bearer configured for the SCG, the UE may suspend bearers, or may indicate an RRC layer to trigger a PDCP reestablishment procedure or a PDCP suspend procedure in a PDCP layer, or may perform the PDCP reestablishment procedure or the PDCP suspend procedure in the PDCP layer. In the above case, the UE may trigger a first DPCP suspend procedure for bearers configured in an SCG, or may perform a first PDCP suspend procedure in the PDCP layer. In another method, in order to solve a security issue problem occurring when different data are transmitted with the same security key when the SCG is activated or resumed, the UE may trigger a second PDCP suspend procedure for bearers configured for the SCG, or may perform a second PDCP suspend procedure in the PDCP layer. In another method, when a PDCP layer suspend procedure is triggered in a higher layer, a first PDCP suspend procedure may be triggered and performed, and when a PDCP layer suspend procedure is triggered in a higher layer or an indicator to deactivate or suspend a cell group (or cell) is indicated, a second PDCP suspend procedure may be triggered and performed. In another method, when the RRC message includes security key configuration information and thus a security key is changed, or includes an indication of a PDCP layer reestablishment procedure, the PDCP layer reestablishment procedure is performed, or when the RRC message does not include the security key configuration information or indicates, by using an indicator, an operation of a PDCP layer, the UE may trigger and perform the first PDCP resume procedure or the second PDCP resume procedure. Also, when the suspended bearer or PDCP layer or RLC layer is resumed, in order to prevent stored old data from being transmitted, the UE may perform a procedure of discarding a plurality of pieces of stored data (e.g., PDCP PDU or PDCP SDU or RLC PDU or RLC SDU). For example, the UE may perform a data discard procedure (SDU discard) in the PDCP layer or may perform an RLC layer reestablishment procedure. In the above case, the data discard procedure (SDU discard) in the PDCP layer, in which a plurality of pieces of stored data are discarded, or the RLC layer reestablishment procedure may be performed when suspension or inactivation or release of a cell group is indicated via an RRC message or MAC control information or DCI of a PDCCH.
2> UE operation for PUCCH SCell of SCG: When the UE receives the configuration information or the indicator, the UE may deactivate a PUCCH SCell of an SCG, and may perform a UE operation of the deactivated SCell. In another method, when the UE receives the configuration information or the indicator, if a dormant BWP is configured for the PUCCH SCell of the SCG, the UE may maintain the SCell in an active state, may activate a DL BWP of the SCell to the dormant BWP, and may perform a UE operation in the dormant BWP, or alternatively, when a dormant BWP is not configured for the PUCCH SCell of the SCG, the UE may switch the SCell to an inactive state, and may perform a UE operation in the deactivated cell or BWP. In another method, when the UE receives the configuration information or the indicator, the UE may determine switching or activation or deactivation of a BWP or a state of the SCell according to SCell configuration information or an indicator configured in a message including the configuration information or the indicator and may perform a UE operation. In another method, when the UE receives the configuration information or the indicator, the UE may apply, to the PUCCH SCell, second DRX configuration information configured in an RRC message, and may perform a UE operation in an activated SCell when it is possible to perform PDCCH monitoring based on a long period.

Partial reset of a MAC layer according to the disclosure may include one or more UE operations from among the following procedures.
A UE may perform an operation of flushing the remaining HARQ processes (i.e., general HARQ process or HARQ process for system information) except for an HARQ process for multicast and broadcast service (MBS) from among HARQ processes configured in a serving cell, and after handover completion or after RRC state mode transition (to an RRC inactive mode or an RRC idle mode), the HARQ process for MBS may be emptied (flushed) or released (flushed) or initialized (flushed), or flushing may be omitted.
In the case of flushing operation, after handover completion or after state mode transmission (to an RRC inactive mode or an RRC idle mode), when MBS reception in a target BS is possible or when G-RNTI monitoring starts, data of the HARQ process related to an MBS may be flushed. Alternatively, until handover is completed or until RRC state mode transition (to an RRC inactive mode or an RRC idle mode) is completed, data reception through a G-RNTI may be continuously performed. In the case of handover, the UE may perform an operation of monitoring a C-RNTI from a target cell allocated by the target BS via the RRC message.

In another method, even before random access is completed from the target BS, the UE may continuously perform data reception through the G-RNTI.
A random access procedure that is being performed, if any, may be stopped.
A specifically configured or indicated preamble identifier, or preamble configuration information, or random access configuration related information (PRACH) configuration information, if any, may be discarded.
A temporary cell identifier (temporary C-RNTI), if any, may be released.
A buffer for message 3 transmission may be flushed.
All new data indicators for an HARQ process for a UL may be configured as 0.
When a UL DRX retransmission timer running for the UL is running, the UL DRX retransmission timer may be stopped.
When all UL HARQ related timers are running, the UL HARQ related timers may be stopped.

In the above case, when a reset procedure of a MAC layer is performed, or when a partial reset procedure indicator of the MAC layer is not included, not indicated, or not performed, the UE may perform the entire reset procedure of the MAC layer, and thus the UE may flush all of the configured general HARQ process, HARQ process for MBS, and HARQ process for system information.

A first PDCP suspension (resume) procedure provided in the disclosure may include one or more UE operations from among the following procedures.
A transmission PDCP layer of the UE may initialize a transmission window variable or may configure the transmission window variable as an initial value, or may discard stored data (e.g., PDCP PDU or PDCP SDU). In another method, in order to prevent data loss, the transmission PDCP layer of the UE may discard only the PDCP PDU. This is a procedure for preventing old data from being transmitted or retransmitted when an SCG is activated or resumed at a later time.
When a reordering timer (t-reordering) (timer for arranging data in an ascending order based on PDCP sequence numbers or count values) is running, a reception PDCP layer of the UE may stop or initialize the reordering timer. Alternatively, the reception PDCP layer of the UE may perform a header decompression procedure on stored data (e.g., PDCP SDU), and may transmit the data to a higher layer in an ascending order of count values. The reception PDCP layer of the UE may initialize a reception window variable or may configure the reception window variable as an initial value.

A second PDCP suspension (or resume) procedure provided in the disclosure may include one or more UE operations from among the following procedures.
A transmission PDCP layer of a UE may maintain a variable value without initializing a transmission window variable, or without configuring the transmission window variable as an initial value. The reason why the variable value (e.g., count value) is maintained is to solve a security issue problem occurring when different data are transmitted with the same security key (e.g., count value) when an SCG is activated or resumed. In the above case, the transmission PDCP layer of the UE may discard stored data (e.g., PDCP PDU or PDCP SDU). In another method, in order to prevent data loss, the transmission PDCP layer of the UE may discard only the PDCP PDU. This is a procedure for preventing old data from being transmitted or retransmitted when the SCG is activated or resumed at a later time.
When a reordering timer (t-reordering) (timer for arranging data in an ascending order based on PDCP sequence numbers or count values) is running, a reception PDCP layer of the UE may stop or initialize the reordering timer. Alternatively, the reception PDCP layer of the UE may perform a header decompression procedure on stored data (e.g., PDCP SDU), and may transmit the data to a higher layer in an ascending order of count values. The reception PDCP layer of the UE may maintain a variable value without initializing a reception window variable or without configure the reception window variable as an initial value. The reason why the variable value (e.g., count value) is maintained is to solve a security issue problem occurring when different data are transmitted with the same security key (e.g., count value) when the SCG is activated or resumed. In another method, in order not to directly trigger the reordering timer even without a count value or a PDCP sequence number gap when the SCG is activated or resumed or data is received, the UE may configure or update an RX_NEXT window variable (variable indicating a count value of data expected to be received next) to a value of an RX_DELIV window variable (variable indicating a count value corresponding to next data of data transmitted to a higher layer) or to a count value of data first received by the UE. In another method, when a reordering timer value is configured in the message or when an indicator is received from a higher layer, the UE may configure or update an RX_REORD window variable (variable indicating a count value of next data of data triggering the reordering timer) to a variable value of an RX_NEXT window variable value, or may stop or restart the reordering timer.

In the above case, when the UE receives configuration information or an indicator for releasing or deactivating or reconfiguring or suspending dual connectivity or a cell group (e.g., SCG) or a cell (e.g., via DCI of a PDCCH or MAC control information or an RRC message) and the UE performs the above UE operations, if data to be transmitted via a UL occurs or is generated, the UE may transmit a scheduling request (SR) or MAC control information (or indicator or the amount of buffer or a buffer state report) in a transport resource of the PUCCH configured in the RRC message to a master BS or a secondary BS to request a UL transport resource or to request to configure or add or activate or resume or modify or reconfigure dual connectivity or a cell group (e.g., SCG) or a cell. In another method, when the UE receives configuration information or an indicator for releasing or deactivating or reconfiguring or suspending dual connectivity or a cell group (e.g., SCG) or a cell (e.g., via DCI of a PDCCH or MAC control information or an RRC message) and the UE performs the above UE operations, if data to be transmitted via a UL occurs or is generated, the UE may generate an RRC message and may transmit the RRC message to a master BS or a secondary BS to request a UL transport resource or to request to configure or add or activate or resume or modify or reconfigure dual connectivity or a cell group (e.g., SCG) or a cell.

Procedures proposed in the disclosure may be extended to a multiple access technology. For example, configuration information of a plurality of cell groups may be configured in a UE via an RRC message, and one or more cell groups (or cells) from among the configured plurality of cell groups may be activated or resumed via an indicator of a PDCCH or MAC control information or an RRC message, or one or more cell groups may be suspended or deactivated.

In the disclosure, when a SCG or a PSCell of the SCG is deactivated or suspended due to a deactivation or suspend procedure of a cell group or a cell, which is proposed in the disclosure, UE operations of the UE to activate or resume the cell group or the cell, in response to generation or occurrence of UL data with respect to the SCG (or bearers that belong to the SCG), will now be described.

As proposed in the disclosure, when the SCG or the cell is deactivated or suspended, the UE cannot transmit or receive data, and thus, if UL data of the UE is generated with respect to the SCG (or bearers that belong to the SCG), it is required to activate or resume the SCG or the cell again. In the above case, a procedure, by the UE, of requesting a BS (a master BS or a secondary BS) to activate or resume the SCG or the cell again will be performed by one method or a method extended from a combination or application of methods below.
First method: The UE configures a message (e.g., an RRC message) of requesting to activate or resume the SCG or the cell again and transmits the message to the master BS. In the above case, upon reception of the message, the master BS may request the secondary BS for a resume procedure as the first signaling procedure of FIG. 1I proposed in the disclosure, may receive a response, and may configure and transmit, to the UE, a message (e.g., an RRC message) of indicating activation or resumption of the SCG again. In another method, as in the second signaling procedure of FIG. 1J, the master BS may configure and transmit, to the UE, a message (e.g., an RRC message) of indicating activation or resumption of the SCG again, and the UE may indicate the secondary BS with activation or resumption. In another method, as in the third signaling procedure of FIG. 1K, the UE may configure and transmit, to the secondary BS via SRB3, a message (e.g., an RRC message) of requesting to activate or resume the SCG or the cell again, and the secondary BS may configure and transmit, to the UE, a message (e.g., an RRC message) of indicating activation or resumption of the SCG again, and then may indicate the master BS with activation or resumption.
Second method: The UE configures a message (e.g., MAC control information) of requesting to activate or resume the SCG or the cell again and transmits the message to the master BS. In the above case, upon reception of the message, the master BS may request the secondary BS for a resume procedure as the first signaling procedure of FIG. 1I proposed in the disclosure, may receive a response, and may configure and transmit, to the UE, a message (e.g., an RRC message or MAC control information) of indicating activation or resumption of the SCG again. In another method, as in the second signaling procedure of FIG. 1J, the master BS may configure and transmit, to the UE, a message (e.g., an RRC message or MAC control information) of indicating activation or resumption of the SCG again, and the UE may indicate the secondary BS with activation or resumption. In another method, as in the third signaling procedure of FIG. 1K, the UE may configure and transmit, to the secondary BS via SRB3, a message (e.g., MAC control information) of requesting to activate or resume the SCG or the cell again, and the secondary BS may configure and transmit, to the UE, a message (e.g., an RRC message or MAC control information) of indicating activation or resumption of the SCG again, and then may indicate the master BS with activation or resumption. In the above case, when activation or resumption of the SCG is requested or indicated via MAC control information, the MAC control information may be newly defined and designed, and in another method, a new field (or indicator) may be defined or a new value (or field value or identifier value) may be defined in legacy MAC control information to indicate the new field or the new value.
Third method: The UE configures a message (e.g., a physical signal of a PHY layer) of requesting to activate or resume the SCG or the cell again and transmits the message to the master BS. In the above case, upon reception of the message, the master BS may request the secondary BS for a resume procedure as the first signaling procedure of FIG. 1I proposed in the disclosure, may receive a response, and may configure and transmit, to the UE, a message (e.g., an RRC message or a physical signal of a PHY layer) of indicating activation or resumption of the SCG again. In another method, as in the second signaling procedure of FIG. 1J, the master BS may configure and transmit, to the UE, a message (e.g., an RRC message or a physical signal of a PHY layer) of indicating activation or resumption of the SCG again, and the UE may indicate the secondary BS with activation or resumption. In another method, as in the third signaling procedure of FIG. 1K, the UE may configure and transmit, to the secondary BS via SRB3, a message (e.g., a physical signal of a PHY layer) of requesting to activate or resume the SCG or the cell again, and the secondary BS may configure and transmit, to the UE, a message (e.g., an RRC message or a physical signal of a PHY layer) of indicating activation or resumption of the SCG again, and then may indicate the master BS with activation or resumption. In the above case, when activation or resumption of the SCG is requested or indicated via a physical signal of a PHY layer, the physical signal of the PHY layer may be newly defined and designed as a new transmit resource (e.g., a new SR transport resource (e.g., a PUCCH transport resource of a PCell or PSCell) or a new field of DCI of a PDCCH (a PDCCH transport resource transmitted from a PSCell or transmitted from a PCell) which is for the SCG), and in another method, a new field (or indicator) may be defined or a new value (or field value or identifier value) may be defined in a legacy physical signal of a PHY layer (e.g., a SR transport resource (e.g., a PUCCH transport resource of a PCell or PSCell) or a field of DCI of a PDCCH (a PDCCH transport resource transmitted from a PSCell or transmitted from a PCell)) to indicate the new field or the new value. In another method, when the UE performs PDCCH monitoring with respect to a PSCell of the SCG with a long period by applying second DRX configuration information or when the SCG of the UE is in an inactive state or a suspended state, if the PSCell triggers a random access procedure to the UE via DCI of PDCCH, the UE may interpret an indication of the triggering as activation or resumption of the SCG.

As proposed in the disclosure, when the UE activates or resumes the cell group (e.g., the SCG) or the cell (e.g., a PSCell), in response to an indicator of a PDCCH or MAC control information or an RRC message, the UE may complete activation or resumption of the cell group or the cell at a first point of time. The first point of time may be configured via an RRC message, as proposed above in the disclosure. For example, the RRC message may include time information (e.g., information (e.g., X) to indicate timing, a time unit, a subframe or a time slot or a symbol unit) to indicate when to activate or resume or deactivate or suspend dual connectivity or a cell group (or a SCG) or a cell (a PSCell or a SCG SCell). For example, in the above case, when the UE has received PDCCH or MAC control information or an RRC message to indicate to activate or resume or deactivate or suspend the cell group (e.g., the SCG) or the cell (e.g., the PSCell) at an n^{th} time unit, time information to complete activation or resumption or deactivation or suspension of the cell group or the cell may be configured at an n+X^{th} time unit. In another method, in the above case, the time information (e.g., X) may not be configured by a BS but may be used as a value that is preset and defined and thus fixed. As another example, in the above case, when a random access is started (a preamble is transmitted) or a random access is successfully completed after the PDCCH or the MAC control information or the RRC message to indicate to activate or resume or deactivate or suspend the cell group (e.g., the SCG) or the cell (e.g., the PSCell) is received, time information to complete activation or resumption or deactivation or suspension of the cell group or the cell may be configured at an n+X^{th} time unit. In another method, in the above case, the time information (e.g., X) may not be configured by a BS but may be used as a value that is preset and defined and thus fixed. In the above case, when activation or suspension or deactivation or resumption of the cell group or the cell is completed, the UE may perform UE operations according to a state (e.g., activation or hibernation or deactivation) of each cell or BWP, which is proposed in the disclosure. Also, in the above case, when activation or resumption of the cell group or the cell is completed, a DRX operation of the UE may be started or restarted, or in the above case, when deactivation or suspension of the cell group or the cell is completed, the DRX operation of the UE may be suspended or deactivated.

Also, as proposed above in the disclosure, when the UE activates a cell (e.g., PSCell or SCell) of a cell group (e.g., MCG or SCG), in response to an indication of MAC control information, activation of the cell may be completed at a second point of time. The second point of time may be configured via an RRC message, as proposed above in the disclosure. For example, the RRC message may include time information (e.g., information (e.g., X) to indicate timing, a time unit, a subframe or a time slot or a symbol unit) to indicate when to activate or deactivate carrier aggregation or dual connectivity or a cell group (or MCG or SCG) or a cell (a MCG SCell or a SCG SCell). For example, in the above case, when the UE has received MAC control information to indicate to activate or deactivate a cell (e.g., SCell) at an n^{th} time unit, time information to complete activation or deactivation of the cell may be configured at an n+X^{th} time unit. In another method, in the above case, the time information (e.g., X) may not be configured by a BS but may be used as a value that is preset and defined and thus fixed. As another example, in the above case, when a random access is started (a preamble is transmitted) or a random access is successfully completed after the MAC control information to indicate to activate or deactivate the cell (e.g., the SCell or the PSCell) is received, time information to complete activation or deactivation of the cell may be configured at an n+X^{th} time unit. In another method, in the above case, the time information (e.g., X) may not be configured by a BS but may be used as a value that is preset and defined and thus fixed. In the above case, when activation or suspension or deactivation or resumption of the cell group or the cell is completed, the UE may perform UE operations according to a state (e.g., activation or hibernation or deactivation) of each cell or BWP, which is proposed in the disclosure. Also, in the above case, when activation or resumption of the cell group or the cell is completed, a DRX operation of the UE may be started or restarted, or in the above case, when deactivation or suspension of the cell group or the cell is completed, the DRX operation of the UE may be suspended or deactivated.

Also, as proposed above in the disclosure, when the UE activates a cell (e.g., PSCell or SCell) of a cell group (e.g., MCG or SCG), in response to an indication of an RRC message, activation of the cell may be completed at a third point of time. The third point of time may be configured via an RRC message, as proposed above in the disclosure. For example, the RRC message may include time information (e.g., information (e.g., X) to indicate timing, a time unit, a subframe or a time slot or a symbol unit) to indicate when to activate or deactivate carrier aggregation or dual connectivity or a cell group (or MCG or SCG) or a cell (a MCG SCell or a SCG SCell or a PSCell). For example, in the above case, when the UE has received an RRC message to indicate to activate or deactivate a cell (e.g., SCell) at an n^{th} time unit, time information to complete activation or deactivation of the cell may be configured at an n+X^{th} time unit. In another method, in the above case, the time information (e.g., X) may not be configured by a BS but may be used as a value that is preset and defined and thus fixed. As another example, in the above case, when a random access is started (a preamble is transmitted) or a random access is successfully completed after the RRC message to indicate to activate or deactivate the cell (e.g., the SCell or the PSCell) is received, time information to complete activation or deactivation of the cell may be configured at an n+X^{th} time unit. In another method, in the above case, the time information (e.g., X) may not be configured by a BS but may be used as a value that is preset and defined and thus fixed. In the above, X may be configured or preset, based on a slot number, or may be configured or preset, based on a shortest slot length from among preset PCells or PSCells or SCells. In the above case, when activation or suspension or deactivation or resumption of the cell group or the cell is completed, the UE may perform UE operations according to a state (e.g., activation or hibernation or deactivation) of each cell or BWP, which is proposed in the disclosure. Also, in the above case, when activation or resumption of the cell group or the cell is completed, a DRX operation of the UE may be started or restarted, or in the above case, when deactivation or suspension of the cell group or the cell is completed, the DRX operation of the UE may be suspended or deactivated.

A concept of a cell group which is proposed in the disclosure may be extended to a subcell group. For example, in the disclosure, in order to configure dual connectivity for a UE, a first cell group and a second cell group are configured and applied as a MCG and a SCG, such that the dual connectivity may be configured and thus the UE can perform data transmission or reception to or from two BSs. However, if the concept of the cell group is extended to a subcell group, a plurality of subcell groups of the cell group may be configured for a UE connected with one BS, or subcell group identifiers may be respectively configured for the subcell groups. Then, the UE performs data transmission or reception with respect to one BS, but, the UE may extend and apply an activation or suspension or resumption or deactivation procedure to different frequencies or cells for each of subcell groups, in response to PDCCH or MAC control information or an RRC message, which is proposed in the disclosure. For example, when the UE performs communication with one BS and a plurality of frequencies or cells, the BS may configure the UE with a plurality of subcell groups with respect to a plurality of frequencies or cells of the BS, which correspond to the cell group (MCG), so as to allow the UE to apply carrier aggregation, and may define fields to indicate activation or deactivation or suspension or resumption of each subcell group, the fields respectively indicating the subcell groups in PDCCH or MAC control information or an RRC message. Then, the UE may apply an activation or suspension or resumption or deactivation procedure to different frequencies or cells for each of the subcell groups, in response to PDCCH or MAC control information or an RRC message, which is proposed in the disclosure. In another method, a subcell group proposed above may be implemented by introducing DL or UL logical channel restriction with respect to each cell. For example, an RRC message may include configuration information to restrict logical channels, which belong to one cell group, to transmit or receive data only for a particular frequency or cell and may be transmitted to the UE. As described above, logical channels (e.g., logical channel identifiers) may be configured by mapping them to each cell or frequency, and thus may be grouped to be regarded as a subcell group proposed above, and fields to respectively indicate the cells may be defined in PDCCH or MAC control information or an RRC message, such that the fields may indicate activation or deactivation or suspension or resumption of the respective cells.

In the disclosure, when the UE for which dual connectivity is configured performs data transmission or reception to or from a MCG or a SCG or when the SCG is suspended or deactivated, if the MCG detects a radio link failure, the UE may report the radio link failure to the SCG or to the MCG via the SCG. For example, the UE may configure an RRC message for reporting the radio link failure and may report the radio link failure by transmitting the RRC message via split SRB1 or SRB3. In the above case, in a case where split SRB1 is configured, the UE may report the radio link failure always via split SRB1. In another method, when the UE for which dual connectivity is configured performs data transmission or reception to or from a MCG or a SCG or when the SCG is suspended or deactivated, if the MCG detects a radio link failure, the UE may declare the radio link failure and may perform an RRC connection re-establishment procedure.

In the disclosure, when the UE for which dual connectivity is configured performs data transmission or reception to or from a MCG or a SCG or when the SCG is suspended or deactivated, if the SCG detects a radio link failure, the UE may report the radio link failure to the MCG or to the SCG via the MCG. For example, the UE may configure an RRC message for reporting the radio link failure and may report the radio link failure by transmitting the RRC message via SRB1 or split SRB1 or SRB3. In the above case, in a case where SRB1 or split SRB1 is configured, the UE may report the radio link failure always via split SRB1.

In the disclosure, it is not the case that, when the UE receives an RRC message including SCG configuration information, the UE stores cell group configuration information, configures the SCG based on the cell group configuration information, always configures dual connectivity, and then transmits or receives data. In the disclosure, when the UE receives the RRC message, the UE may only store the cell group configuration information based on indication information, e.g., a cell group identifier or cell group state information or an indicator, which is configured in the RRC message proposed in the disclosure, or may store or recover, apply and establish the cell group configuration information, or may store or recover, apply and establish the cell group configuration information and may perform data transmission or reception based on dual connectivity. A BS, by extending the disclosure, may configure one UE with a plurality of pieces of cell group configuration information via an RRC message and allow the UE to store them, and may indicate, by indicating one cell group configuration information among the stored plurality of pieces of cell group configuration information, the UE to configure dual connectivity by applying and establishing configuration and then to transmit or receive data, or to activate or deactivate or suspend or resume or release the cell group, when required. Also, the BS may configure a MCG or a SCG by using one cell group configuration information among the stored plurality of pieces of cell group configuration information. In the above case, when dual connectivity is configured based on one cell group configuration information, the UE may attempt an access to the cell group via a CBRA procedure. If the cell group configuration information includes configuration information related to a contention-free random access, the UE may perform, on the cell group, a CFRA procedure based on the configuration information, and thus may perform an access to the cell group.

Hereinafter, in the disclosure, various methods by which a BS configures a cell group via an RRC message (e.g., an RRCReconfiguration message or a newly-defined RRC message) and UE operations in response thereto will now be proposed.

1> When the BS newly adds a cell group (SCG) (or configures a cell group state to an active state while adding the cell group) by transmitting an RRC message (e.g., an RRCReconfiguration message or a newly-defined RRC message) to a UE for which dual connectivity is not configured, or when the BS changes a configured cell group (SCG) to a different cell group (or a new cell group) (or configures a cell group state to an active state while changing the cell group) by transmitting an RRC message to the UE for which dual connectivity is configured, or when the BS configures (or changes) an inactive state of a configured cell group (SCG) to an active state by transmitting an RRC message to the UE for which dual connectivity is configured,
2> the BS may include, in the RRC message, a ReconfigurationWithSync indicator, and bearer configuration information about the cell group or cell group configuration information or cell configuration information or protocol layer configuration information (e.g., SDAP layer or PDCP layer or RLC layer or MAC layer or PHY layer configuration information), and may transmit the RRC message to the UE. In another method, the BS may include state configuration information of the cell group in the RRC message, and may configure and indicate activation of the cell group.
2> When the UE receives the RRC message, the UE may configure a cell group based on the cell group configuration information, and may configure or establish each protocol layer, and when the ReconfigurationWithSync indicator is included, the UE may perform or trigger a random access procedure to the cell group (or a cell or a frequency or a PSCell). In the above case, the UE may transmit, to the BS, a response RRC message (e.g., an RRC Reconfiguration Complete message or a newly-defined response message) in response to the RRC message. In another method, when the ReconfigurationWithSync indicator is included in the RRC message or when a cell group state is configured as an active state or when a TAT configured in an MAC layer has been expired (or is not running), the UE may indicate the cell group (or a cell or a frequency or a PSCell) to perform or trigger a random access procedure, such that it is possible to prevent the random access procedure from being unnecessarily triggered. In another method, when the ReconfigurationWithSync indicator is included in the RRC message or when a cell group state is configured as an active state and a TAT configured in an MAC layer has been expired (or is not running), the UE may indicate the cell group (or a cell or a frequency or a PSCell) to perform or trigger a random access procedure, such that it is possible to prevent the random access procedure from being unnecessarily triggered.

1> When the BS changes a configuration of a configured cell group (SCG) by transmitting an RRC message to the UE for which dual connectivity is configured, or when the BS reconfigures configuration information while maintaining a configured active state of a cell group (SCG) as an active state by transmitting an RRC message to the UE for which dual connectivity is configured,
2> the BS may not include a ReconfigurationWithSync indicator in the RRC message, and may include bearer configuration information about the cell group or cell group configuration information or cell configuration information or protocol layer configuration information (e.g., SDAP layer or PDCP layer or RLC layer or MAC layer or PHY layer configuration information), and may transmit the RRC message to the UE. In another method, the BS may include state configuration information of the cell group in the RRC message, and may configure and indicate activation of the cell group.
2> When the UE receives the RRC message, the UE may configure a cell group based on the cell group configuration information, and may configure or establish or reconfigure or reestablish each protocol layer, and in the above case, the UE may transmit, to the BS, a response RRC message (e.g., an RRC Reconfiguration Complete message or a newly-defined response message) in response to the RRC message. Then, the UE may indicate the cell group (or a cell or a frequency or a PSCell) not to perform or trigger a random access procedure, such that it is possible to prevent the random access procedure from being unnecessarily triggered to a deactivated cell group.

1> When the BS configures an inactive state (or a suspended state) as a state of a configured cell group (SCG) by transmitting an RRC message (e.g., an RRCReconfiguration message or a newly-defined RRC message) to a UE for which dual connectivity is configured, or when the BS newly adds a cell group (SCG) by transmitting an RRC message (e.g., an RRCReconfiguration message or a newly-defined RRC message) to the UE for which dual connectivity is not configured, and configures a state of the newly-added cell group as an inactive state (or a suspended state), or when the BS reconfigures configuration information while maintaining a configured inactive state (or a suspended state) of a cell group (SCG) as an inactive state (or a suspended state) by transmitting an RRC message (e.g., an RRCReconfiguration message or a newly-defined RRC message) to the UE for which dual connectivity is configured,
2> the BS may not include a ReconfigurationWithSync indicator in the RRC message and, when a configuration is required, the BS may include bearer configuration information about the cell group or cell group configuration information or cell configuration information or protocol layer configuration information (e.g., SDAP layer or PDCP layer or RLC layer or MAC layer or PHY layer configuration information), and may transmit the RRC message to the UE. The BS may include state configuration information of the cell group in the RRC message, and may configure and indicate deactivation of the cell group.
2> When the UE receives the RRC message and the cell group configuration information is included therein, the UE may reconfigure a cell group based on the cell group configuration information, and may configure or reconfigure or establish or reestablish each protocol layer. In the above case, the UE may transmit, to the BS, a response RRC message (e.g., an RRC Reconfiguration Complete message or a newly-defined response message) in response to the RRC message. Then, the UE may perform UE operations proposed in the disclosure. In the above case, the UE may transmit, to the BS, a response RRC message (e.g., an RRC Reconfiguration Complete message or a newly-defined response message) in response to the RRC message. Then, the UE may indicate the cell group (or a cell or a frequency or a PSCell) not to perform or trigger a random access procedure, such that it is possible to prevent the random access procedure from being unnecessarily triggered to a deactivated cell group.

1> When the BS configures (or changes) an inactive state (or a suspended state) of a configured cell group (SCG) to an active state by transmitting an RRC message to the UE for which dual connectivity is configured,
2> the BS may not include a ReconfigurationWithSync indicator in the RRC message and, when a reconfiguration is required, the BS may include bearer configuration information about the cell group or cell group configuration information or cell configuration information or protocol layer configuration information (e.g., SDAP layer or PDCP layer or RLC layer or MAC layer or PHY layer configuration information), and may transmit the RRC message to the UE. The BS may include state configuration information of the cell group in the RRC message, and may configure and indicate activation of the cell group.
2> When the UE receives the RRC message and the cell group configuration information is included therein, the UE may reconfigure a cell group based on the cell group configuration information, and may configure or reconfigure or establish or reestablish each protocol layer. In the above case, the UE may transmit, to the BS, a response RRC message (e.g., an RRC Reconfiguration Complete message or a newly-defined response message) in response to the RRC message. Then, the UE may perform UE operations proposed in the disclosure. In another method, when a cell group state is configured as an active state or when a TAT configured in an MAC layer has been expired (or is not running), the UE may indicate the cell group (or a cell or a frequency or a PSCell) to perform or trigger a random access procedure, such that it is possible to prevent the random access procedure from being unnecessarily triggered.

In the disclosure, when the BS configures cell group configuration information in the RRC message, the BS may always include (e.g., may define as a mandatory field) cell group state information in the RRC message, and thus may allow the UE to perform a procedure, based on a cell group state.

In the disclosure, when the BS configures the cell group configuration information in the RRC message, if the cell group state information is configured as an inactive state, the BS may restrict a ReconfigurationWithSync indicator from being co-included (or configured), thereby preventing the UE from unnecessarily triggering a random access procedure.

Hereinafter, the disclosure provides methods for solving a problem that may occur when a BS deactivates or suspends one cell group in a case where split bearer is configured for a UE for which dual connectivity is configured.

When split bearer is configured for a UE for which dual connectivity with respect to a first cell group (MCG) and a second cell group (SCG) is configured, if the second cell group is deactivated or suspended, when UL data with respect to the second cell group occurs in the UE, the UE cannot transmit the UL data. In the above case, the split bearer may be a split bearer for which a PDCP layer is configured for the first cell group, and in this regard, one RLC layer may be configured for the first cell group and the other RLC layer may indicate a bearer configured for the second cell group, or alternatively, in the above case, the split bearer may be a split bearer for which a PDCP layer is configured for the second cell group, and in this regard, one RLC layer may be configured for the first cell group and the other RLC layer may indicate a bearer configured for the second cell group.

A first method for solving a problem in which, even when UL data with respect to a cell group in a deactivated state (or suspended state) occurs in the UE, the UE cannot transmit the data via the split bearer is that, when the BS configures a state of a cell group for the UE to an inactive state via an RRC message, the BS may change configuration information of the split bearer so as to prevent the UL data from being generated with respect to the deactivated cell group or may release or modify the split bearer so as to prevent the UL data from being generated with respect to the deactivated cell group. The first method may be performed as one method or a combination of a plurality of methods below.
First-1 method: When split bearer is configured for the UE, and the BS attempts to configure a second cell group of the UE to an inactive state (or suspended state) by transmitting the RRC message, the BS may release the split bearer and may configure a normal bearer (e.g., a bearer for which a PDCP layer, an RLC layer, and an MAC layer are configured only for a first cell group or a bearer for which the PDCP layer, the RLC layer, and the MAC layer are configured only for the second cell group) or may modify and configure the split bearer to a normal bearer (e.g., a bearer for which a PDCP layer, an RLC layer, and an MAC layer are configured only for a first cell group or a bearer for which the PDCP layer, the RLC layer, and the MAC layer are configured only for the second cell group).
First-2 method: When split bearer is configured for the UE, and the BS attempts to configure a second cell group of the UE to an inactive state (or suspended state) by transmitting the RRC message, the BS may reconfigure configuration information of the split bearer, and thus, may configure a ul-DataSplitThreshold value of the split bearer to an infinite value or may configure a primary path to a first cell group or an RLC layer belonging to the first cell group or a logical channel identifier corresponding thereto or may configure a duplicate state to an inactive state.
First-3 method: In a case where split bearer is configured for the UE, and the BS attempts to configure a second cell group of the UE to an inactive state (or suspended state) by transmitting the RRC message, when the UE receives the RRC message, the UE may reconfigure configuration information of the split bearer, and thus, may configure a ul-DataSplitThreshold value of the split bearer to an infinite value or may configure a primary path to a first cell group or an RLC layer belonging to the first cell group or a logical channel identifier corresponding thereto or may configure a duplicate state to an inactive state.

A second method for solving a problem in which, even when UL data with respect to a cell group in a deactivated state (or suspended state) occurs in the UE, the UE cannot transmit the data via the split bearer is that, when the BS configures a cell group of the UE to an inactive state via the RRC message and then UL data via the split bearer occurs with respect to the deactivated cell group, the UE may activate the deactivated cell group or trigger a procedure for activating the cell group so as to transmit the UL data. The second method may be performed as one method or a combination of a plurality of methods below. The methods below may be performed by an MAC layer or an RRC layer of the UE.
Second-1 method: When split bearer is configured for the UE, and the BS attempts to configure a second cell group of the UE to an inactive state (or suspended state) by transmitting the RRC message, the UE may perform a random access procedure on the second cell group when UL data with respect to the second cell group occurs. The UE may perform the random access procedure, may configure connection to the second cell group or perform synchronization with respect to the second cell group, and may transmit an RRC message requesting activation of the second cell group or may transmit the UL data. In another method, when the UE maintains synchronization with the second cell group or a TAT is not expired (or is running), the UE may transmit the UL data via an SR transmit resource configured for the UE or a transmit resource allocated via a random access procedure.
Second-2 method: When split bearer is configured for the UE, and the BS attempts to configure a second cell group of the UE to an inactive state (or suspended state) by transmitting the RRC message, if UL data with respect to the second cell group occurs, the UE may request activation of the second cell group by transmitting, to the first cell group, an RRC message or MAC control information (e.g., MAC control information indicating cell group activation or indicating a buffer status report for a second cell group, as new MAC control information (e.g., via an MAC layer for the first cell group)), such that a BS corresponding to the first cell group can perform a procedure for activating the second cell group and the UE can transmit the UL data.

Operations of a PDCP layer for supporting the second-2 method or the second-2 method while performing the second method of the disclosure are supported as below.

When transmitting data (PDCP PDU) to a lower layer, a transmit PDCP layer may perform a procedure below.

1> If the transmit PDCP layer is connected with one RLC layer,

2> the transmit PDCP layer transmits the data (PDCP PDU) to the connected RLC layer.

1> Otherwise, if the transmit PDCP layer is connected with at least two RLC layers,

2> if a PDCP duplicate function (a packet duplicate technology or PDCP packet duplication) is activated,
3> if data (PDCP PDU) to be transmitted to a lower layer is PDCP user data (PDCP Data PDU),
   4> the transmit PDCP layer performs duplicate processing on the data (PDCP Data PDU) and transmits the data (PDCP Data PDU) to a connected RLC layer.
3> Otherwise (i.e., data (PDCP PDU) to be transmitted to the lower layer is PDCP control data (PDCP Control PDU)),
   4> the transmit PDCP layer transmits the data (PDCP Control PDU) to a connected primary RLC layer. In the above case, the primary RLC layer or a secondary RLC layer may be configured in an RRC message received from a BS as in FIG. 1E, and the primary RLC layer may not be deactivated, and when the packet duplicate technology is configured, the transmit PDCP layer may not duplicate process the PDCP control data (PDCP Control PDU) and may always transfer the PDCP control data (PDCP Control PDU) to the primary RLC layer and then transmit it.

2> Otherwise (i.e., if a PDCP duplicate function (a packet duplicate technology or PDCP packet duplication) is not activated or is deactivated),
3> if a secondary RLC layer (split secondary RLC layer (which may be configured via an RRC message of FIG. 1F and may indicate an RLC layer with respect to a second cell group for split bearer)) is configured,
3> and (or), when an amount of all data of a size of a volume of PDCP data queuing for initial transmission and a size of a volume of RLC data in RLC layers (e.g., a primary RLC layer (which may be configured via an RRC message of FIG. 1F and may indicate an identifier of a logical channel configured as a primary path or an RLC layer corresponding thereto) connected to a PDCP layer or a secondary RLC layer (split secondary RLC layer) is equal to or greater than a threshold value for UL data transmission,
   4> if the secondary RLC layer (split secondary RLC layer) is suspended or a state of a cell group corresponding to the secondary RLC layer (split secondary RLC layer) is deactivated (or suspended),
      5> the transmit PDCP layer may perform the second-1 method or the second-2 method proposed in the disclosure. Alternatively, the transmit PDCP layer may transmit an indicator (or a request) to a lower layer (an MAC layer connected with a primary RLC layer or a secondary RLC layer) or to a higher layer (an RRC layer) so as to perform the second-1 method or the second-2 method.
   4> The transmit PDCP layer may transmit the data (PDCP PDU or PDCP data PDU or PDCP Control PDU) to the primary RLC layer or the secondary RLC layer. In the above case, the primary RLC layer or the secondary RLC layer may be configured via an RRC message received from a BS as in FIG. 1F. In another method, the transmit PDCP layer may transmit the data (PDCP PDU or PDCP data PDU or PDCP Control PDU) to a primary RLC layer or a secondary RLC layer, which is of a cell group that is not suspended or is not in an inactive state (or in an active state). In the above case, a primary RLC layer or a secondary RLC layer may be configured via an RRC message received from the BS as in FIG. 1F. In another method, the transmit PDCP layer may transmit the data (PDCP PDU or PDCP data PDU or PDCP Control PDU) to a primary RLC layer, or a secondary RLC layer of a cell group that is not suspended or is not in an inactive state (or in an active state). In the above case, a primary RLC layer or a secondary RLC layer may be configured via an RRC message received from the BS as in FIG. 1F. In another method, if the secondary RLC layer (split secondary RLC layer) is suspended or a state of a cell group corresponding to the secondary RLC layer (split secondary RLC layer) is deactivated (or is suspended), the transmit PDCP layer may transmit the data (PDCP PDU or PDCP data PDU or PDCP Control PDU) only to the primary RLC layer.
3> Otherwise, if the transmit PDCP layer is connected with a bearer for which dual active protocol stack (DAPS) handover is configured (or DAPS handover is configured),
   4> if the transmit PDCP layer did not receive, from a higher layer or a lower layer, an indicator (or a request) to switch UL data transmission,
      5> the transmit PDCP layer may transfer the data (PDCP PDU or PDCP data PDU or PDCP Control PDU) to a source BS or an RLC layer for the source BS and thus transmit it.
   4> Otherwise (i.e., if the transmit PDCP layer received, from a higher layer or a lower layer, the indicator (or the request) to switch UL data transmission),
      5> if the data is PDCP user data (PDCP data PDU),
         6> the transmit PDCP layer may transfer the PDCP user data to a target BS or an RLC layer for the target BS and thus transmit it.
      5> Otherwise (i.e., if the data is PDCP control data (PDCP control PDU)),
         6> if the PDCP control data is data for a source BS or is related to the source BS,
         7> the transmit PDCP layer may transfer the PDCP control data to the source BS or an RLC layer for the source BS and thus transmit it.
         6> Otherwise (i.e., if the PDCP control data is data for a target BS or is related to the target BS),
         7> the transmit PDCP layer may transfer the PDCP control data to the target BS or an RLC layer for the target BS and thus transmit it.
3> Otherwise (i.e., if an amount of all data of a size of a volume of PDCP data queuing for initial transmission and a size of a volume of RLC data in RLC layers connected to a PDCP layer is not greater than the threshold value for UL data transmission, or if the transmit PDCP layer is not connected with a bearer for which DAPS handover is configured (or DAPS handover is not configured),
   4> the transmit PDCP layer may transfer the data (PDCP PDU or PDCP data PDU or PDCP Control PDU) to a primary RLC layer and thus transmit it.

If the transmit PDCP layer is connected with a plurality of RLC layers (or two RLC layers), and indicates a PDCP data size to an MAC layer for a source BS or a target BS so as to trigger a buffer state report or a buffer size, the transmit PDCP layer may perform a procedure below.

1> If a PDCP duplicate function (a packet duplicate technology or PDCP packet duplication) is activated,
2> the transmit PDCP layer may indicate a size of PDCP data (PDCP data PDU or PDCP control PDU) to an MAC layer connected with a primary RLC layer.
2> The transmit PDCP layer may indicate a size of PDCP data (PDCP data PDU) excluding a size of PDCP control data (PDCP control PDU) to an MAC layer connected with a secondary RLC layer.
2> The transmit PDCP layer may indicate a PDCP data volume as 0, with respect to an MAC layer connected with an RLC layer for which PDCP duplication is deactivated.

1> Otherwise (i.e., if the PDCP duplicate function (the packet duplicate technology or PDCP packet duplication) is not activated or is deactivated),
2> if a secondary RLC layer (split secondary RLC layer (which may be configured via an RRC message of FIG. 1F and may indicate an RLC layer with respect to a second cell group for split bearer)) is configured,
2> and (or), when an amount of all data of a size of a volume of PDCP data queuing for initial transmission and a size of a volume of RLC data in RLC layers (e.g., a primary RLC layer (which may be configured via an RRC message of FIG. 1F and may indicate an identifier of a logical channel configured as a primary path or an RLC layer corresponding thereto) connected to a PDCP layer or a secondary RLC layer (split secondary RLC layer) is equal to or greater than a threshold value for UL data transmission,
   3> if the secondary RLC layer (split secondary RLC layer) is suspended or a state of a cell group corresponding to the secondary RLC layer (split secondary RLC layer) is deactivated (or suspended),
      4> the primary RLC layer or the MAC layer may perform the second-1 method or the second-2 method proposed in the disclosure. Alternatively, the transmit PDCP layer may transmit an indicator (or a request) to a lower layer (an MAC layer connected with a primary RLC layer or a secondary RLC layer) or to a higher layer (an RRC layer) to perform the second-1 method or the second-2 method.
   3> The transmit PDCP layer may indicate a size of PDCP data to the MAC layer connected with the primary RLC layer and the MAC layer connected with the secondary RLC layer. The indicated size of the PDCP data may function as an indicator (or a request) to be sent to a lower layer (a MAC layer connected with the primary RLC layer or the secondary RLC layer) to perform the second-1 method or the second-2 method proposed in the disclosure.
   3> The transmit PDCP layer may indicate a size of PDCP data as 0 to an MAC layer connected with an RLC layer excluding the primary RLC layer and the secondary RLC layer.
2> Otherwise, if the transmit PDCP layer is connected with a bearer for which DAPS handover is configured (or DAPS handover is configured),
   3> if the transmit PDCP layer did not receive, from a higher layer or a lower layer, an indicator (or a request) to switch UL data transmission,
      4> the transmit PDCP layer may indicate the size of the PDCP data to a source BS or an MAC layer for the source BS.
   3> Otherwise (i.e., if the transmit PDCP layer received, from a higher layer or a lower layer, the indicator (or the request) to switch UL data transmission),
      4> the transmit PDCP layer may indicate, to a target BS or an MAC layer for the target BS, a size of PDCP data which excludes PDCP control data (an interspersed ROHC feedback or a PDCP status report) or a size of the PDCP control data for the target BS or related to the target BS.
      4> The transmit PDCP layer may indicate, to a source BS or an MAC layer for the source BS, PDCP control data (an interspersed ROHC feedback or a PDCP status report) or a size of the PDCP control data for the source BS or related to the source BS.
2> Otherwise (i.e., an amount of all data of the size of the PDCP data and a size of RLC data queuing for initial transmission in RLC layers connected with the PDCP layer is not greater than a threshold value for UL data transmission, or if the transmit PDCP layer is not connected with a bearer for which DAPS handover is configured (or DAPS handover is not configured),
   3> the transmit PDCP layer may indicate a size of PDCP data (PDCP PDU or PDCP data PDU or PDCP control PDU) to an MAC layer connected with a primary RLC layer.
   3> The transmit PDCP layer may indicate, to an MAC layer connected with an RLC layer excluding the primary RLC layer, that the size of the PDCP data (PDCP PDU or PDCP data PDU or PDCP control PDU) is 0.

FIG. 1L illustrates a diagram of an operation of a UE according to an embodiment of the disclosure.

Referring to FIG. 1L, a UE 1l-01 may receive a message (e.g., DCI of a PDCCH or MAC control information or an RRC message) from a BS (1l-05). When cell group configuration information or a cell group state or a cell group indicator is included in the message, the UE may determine whether a cell group is indicated to be configured or added or activated or resumed or whether the cell group is indicated to be released or deactivated or suspended in the message (1l-10). When the cell group is indicated to be configured or added or activated or resumed in the message, a cell group configuration or addition or activation or resume procedure, which is proposed in the disclosure, may be performed (1l-20), and when the cell group is indicated to be released or deactivated or suspended in the message, a cell group release or deactivation or suspend procedure, which is proposed in the disclosure, may be performed (1l-30).

FIG. 1M illustrates a block diagram of a configuration of a UE to which an embodiment of the disclosure is applicable.

Referring to FIG. 1M, the UE includes a RF processor 1m-10, a baseband processor 1m-20, a storage 1m-30, a multi-connection processor 1m-42, and a controller 1m-40.

The RF processor 1m-10 performs functions of transmitting and receiving signals via radio channels, such as band conversion and amplification of the signals. That is, the RF processor 1m-10 up-converts a baseband signal provided from the baseband processor 1m-20, into an RF band signal and then transmits the RF band signal via an antenna, and down-converts an RF band signal received via the antenna, into a baseband signal. For example, the RF processor 1m-10 includes a transmission filter, a reception filter, an amplifier, a mixer, an oscillator, a digital-to-analog convertor (DAC), an analog-to-digital convertor (ADC), or the like. Although only one antenna is illustrated in FIG. 1M, the UE may include a plurality of antennas. Also, the RF processor 1m-10 may include a plurality of RF chains. In addition, the RF processor 1m-10 may perform beamforming. For beamforming, the RF processor 1m-10 may respectively adjust phases and intensities of signals to be transmitted or received via a plurality of antennas or antenna elements. Also, the RF processor 1m-10 may perform a MIMO operation and may receive a plurality of layers in the MIMO operation. In response to the control by the controller 1m-40, the RF processor 1m-10 may perform received beam sweeping by appropriately configuring a plurality of antennas or antenna elements, or may adjust a direction and a beam width of a received beam to coordinate with a transmit beam.

The baseband processor 1m-20 converts between a baseband signal and a bitstream based on physical entity specifications of a system. For example, for data transmission, the baseband processor 1m-20 generates complex symbols by encoding and modulating a transmission bitstream. For data reception, the baseband processor 1m-20 reconstructs a received bitstream by demodulating and decoding a baseband signal provided from the RF processor 1m-10. For example, according to an OFDM scheme, for data transmission, the baseband processor 1m-20 generates complex symbols by encoding and modulating a transmit bitstream, maps the complex symbols to subcarriers, and then configures OFDM symbols by performing inverse fast Fourier transform (IFFT) and cyclic prefix (CP) insertion. For data reception, the baseband processor 1m-20 segments a baseband signal provided from the RF processor 1m-10, into OFDM symbol units, reconstructs signals mapped to subcarriers by performing fast Fourier transform (FFT), and then reconstructs a received bitstream by demodulating and decoding the signals.

The baseband processor 1m-20 and the RF processor 1m-10 transmits and receives signals as described above. Accordingly, the baseband processor 1m-20 and the RF processor 1m-10 may also be called a transmitter, a receiver, a transceiver, or a communicator. In addition, at least one of the baseband processor 1m-20 or the RF processor 1m-10 may include a plurality of communication modules to support a plurality of different radio access technologies. Also, at least one of the baseband processor 1m-20 or the RF processor 1m-10 may include different communication modules to process signals of different frequency bands. For example, the different radio access technologies may include an LTE network, an NR network, or the like. Also, the different frequency bands may include a super-high frequency (SHF) (e.g., 2.5 GHz, 5 GHz) band and a millimeter wave (mmWave) (e.g., 60 GHz) band.

The storage 1m-30 stores basic programs, application programs, and data, e.g., configuration information, for operations of the UE. The storage 1m-30 provides the stored data upon request by the controller 1m-40.

The controller 1m-40 controls overall operations of the UE. For example, the controller 1m-40 transmits and receives signals through the baseband processor 1m-20 and the RF processor 1m-10. Also, the controller 1m-40 records and reads data on or from the storage 1m-30. To this end, the controller 1m-40 may include at least one processor. For example, the controller 1m-40 may include a communication processor (CP) for controlling communications and an application processor (AP) for controlling an upper layer such as an application program.

FIG. 1N illustrates a block diagram of a BS in a wireless communication system to which an embodiment of the disclosure is applicable.

As illustrated in FIG. 1N, the BS may include a RF processor 1n-10, a baseband processor 1n-20, a communicator 1n-30, a storage 1n-40, a multi-connection processor 1n-52, and a controller 1n-50.

The RF processor 1n-10 performs functions of transmitting and receiving signals via radio channels, e.g., band conversion and amplification of the signals. That is, the RF processor 1n-10 up-converts a baseband signal provided from the baseband processor 1n-20, into an RF band signal and then transmits the RF band signal via an antenna, and down-converts an RF band signal received via an antenna, into a baseband signal. For example, the RF processor 1n-10 may include a transmission filter, a reception filter, an amplifier, a mixer, an oscillator, a DAC, an ADC, or the like. Although only one antenna is illustrated in FIG. 1N, the BS may include a plurality of antennas. Also, the RF processor 1n-10 may include a plurality of RF chains. In addition, the RF processor 1n-10 may perform beamforming. For beamforming, the RF processor 1n-10 may respectively adjust phases and intensities of signals to be transmitted or received via a plurality of antennas or antenna elements. The RF processor 1n-10 may perform a DL MIMO operation by transmitting one or more layers.

The baseband processor 1n-20 converts between a baseband signal and a bitstream based on physical entity specifications of a radio access technology. For example, for data transmission, the baseband processor 1n-20 generates complex symbols by encoding and modulating a transmission bitstream. For data reception, the baseband processor 1n-20 reconstructs a received bitstream by demodulating and decoding a baseband signal provided from the RF processor 1n-10. For example, according to an OFDM scheme, for data transmission, the baseband processor 1n-20 generates complex symbols by encoding and modulating a transmission bitstream, maps the complex symbols to subcarriers, and then configures OFDM symbols by performing IFFT and CP insertion. For data reception, the baseband processor 1n-20 segments a baseband signal provided from the RF processor 1n-10, into OFDM symbol units, reconstructs signals mapped to subcarriers by performing FFT, and then reconstructs a received bitstream by demodulating and decoding the signals. The baseband processor 1n-20 and the RF processor 1n-10 transmits and receives signals as described above. As such, the baseband processor 1n-20 and the RF processor 1n-10 may also be called a transmitter, a receiver, a transceiver, a communicator, or a wireless communicator.

The communicator 1n-30 including a backhaul communicator provides an interface for communicating with other nodes in a network.

The storage 1n-40 stores basic programs, application programs, and data, e.g., configuration information, for operations of a primary BS. In particular, the storage 1n-40 may store, for example, information about bearers assigned for a connected UE and measurement results reported from the connected UE. Also, the storage 1n-40 may store criteria information used to determine whether to provide or release dual connectivity to or from the UE. The storage 1n-40 may provide the stored data upon request by the controller 1n-50.

The controller 1n-50 may control overall operations of the primary BS. For example, the controller 1n-50 transmits and receives signals through the baseband processor 1n-20 and the RF processor 1n-10, or the communicator 1n-30. Also, the controller 1n-50 records and reads data on or from the storage 1n-40. To this end, the controller 1n-50 may include at least one processor.

The disclosure provides a new dormant mode or suspension mode or inactive mode in which an RRC_connected UE connected to a network can rapidly activate or deactivate carrier aggregation or dual connectivity in a wireless communication system. The disclosure provides a method of operating a new dormant (hibernation or dormancy or suspension) mode in units of BWP-levels, in units of cells, or in units of cell groups (e.g., SCGs), to rapidly activate carrier aggregation or dual connectivity and reduce power consumption of a UE.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE), the method comprising:
receiving a radio resource control (RRC) message including configuration information of a secondary cell group (SCG) for the UE configured with a master cell group (MCG) and the SCG;
identifying an indication for SCG deactivation from the configuration information of the SCG; and
in case that the SCG is deactivated based on the identified indication, triggering a packet data convergence protocol (PDCP) entity associated with a signaling radio bearer 3 (SRB 3) to discard a service data unit (SDU).

2. The method of claim 1, further comprising:
in case that the SCG is deactivated based on the identified indication, re-establishing a radio link control (RLC) entity associated with the SRB 3.

3. The method of claim 1, wherein, in case that the SCG is deactivated based on the identified indication, configuration for the SCG is maintained and transmission to the SCG is suspended.

4. The method of claim 1, further comprising:
based on the identified indication for the SCG deactivation, setting a value of ul-data split threshold for a split bearer to an infinite value and a primary path to a radio link control (RLC) entity of the MCG.

5. A method performed by a master node (MN), the method comprising:
determining secondary cell group (SCG) deactivation of a user equipment (UE) configured with a master cell group (MCG) and the SCG; and
based on the determination of the SCG deactivation, transmitting a radio resource control (RRC) message including configuration information of the SCG to the UE,
wherein the configuration information of the SCG includes an indication for the SCG deactivation, and
in case that the SCG is deactivated based on the indication, a packet data convergence protocol (PDCP) entity associated with a signaling radio bearer 3 (SRB 3) of the UE is triggered to discard a service data unit (SDU).

6. The method of claim 5, wherein, in case that the SCG is deactivated based on the indication, a radio link control (RLC) entity associated with the SRB 3 is re-established.

7. The method of claim 5, wherein, in case that the SCG is deactivated based on the indication, configuration for the SCG is maintained and transmission to the SCG is suspended.

8. The method of claim 5, wherein, based on the indication for the SCG deactivation, a value of ul-data split threshold for a split bearer of the UE is set to an infinite value and a primary path is set to a radio link control (RLC) entity of the MCG.

9. A user equipment (UE) comprising:
a transceiver; and
a processor coupled with the transceiver and configured to:
receive a radio resource control (RRC) message including configuration information of a secondary cell group (SCG) for the UE configured with a master cell group (MCG) and the SCG,
identify an indication for SCG deactivation from the configuration information of the SCG, and
in case that the SCG is deactivated based on the identified indication, trigger a packet data convergence protocol (PDCP) entity associated with a signaling radio bearer 3 (SRB 3) to discard a service data unit (SDU).

10. The UE of claim 9, wherein the processor is further configured to:
in case that the SCG is deactivated based on the identified indication, re-establish a radio link control (RLC) entity associated with the SRB 3.

11. The UE of claim 9, wherein in case that the SCG is deactivated based on the identified indication, configuration for the SCG is maintained and transmission to the SCG is suspended.

12. The UE of claim 9, wherein the processor is further configured to:
based on the identified indication for the SCG deactivation, set a value of ul-data split threshold for a split bearer to an infinite value and a primary path to a radio link control (RLC) entity of the MCG.

13. A master node (MN) comprising:
a transceiver; and
a processor coupled with the transceiver and configured to:
determine secondary cell group (SCG) deactivation of a user equipment (UE) configured with a master cell group (MCG) and the SCG, and
based on the determination of the SCG deactivation, transmit a radio resource control (RRC) message including configuration information of the SCG, to the UE,
wherein the configuration information of the SCG includes an indication for the SCG deactivation, and
in case that the SCG is deactivated based on the indication, a packet data convergence protocol (PDCP) entity related with a signaling radio bearer 3 (SRB 3) of the UE is triggered to discard a service data unit (SDU).

14. The MN of claim 13, wherein, in case that the SCG is deactivated based on the indication, a radio link control (RLC) entity related with the SRB 3 is re-established.

15. The MN of claim 13, wherein, in case that the SCG is deactivated based on the indication, configuration for the SCG is maintained and transmission to the SCG is suspended.

16. The MN of claim 13, wherein, based on the indication for the SCG deactivation, a value of ul-data split threshold for a split bearer of the UE is set to an infinite value and a primary path is set to a radio link control (RLC) entity of the MCG.
